(19) United States
(12) Patent Application Publication
(10) Pub. No.: US 2023/0276415 A1
(43) Pub. Date: Aug. 31, 2023

(54) METHOD AND WIRELESS COMMUNICATION TERMINAL FOR TRANSMITTING AND RECEIVING DATA IN WIRELESS COMMUNICATION SYSTEM

(71) Applicant: WILUS INSTITUTE OF STANDARDS AND TECHNOLOGY INC., Gyeonggi-do (KR)

(72) Inventors: Geonjung KO, Gyeonggi-do (KR); Juhyung SON, Gyeonggi-do (KR); Sanghyun KIM, Seoul (KR); Jinsam KWAK, Gyeonggi-do (KR)

(21) Appl. No.: 18/015,960

(22) PCT Filed: Jul. 13, 2021
(86) PCT No.: PCT/KR2021/009004

§ 371 Date: Jan. 13, 2023

(30) Foreign Application Priority Data
Jul. 13, 2020 (KR) 10-2020-0086474
Jul. 31, 2020 (KR) 10-2020-0096440
Mar. 9, 2021 (KR) 10-2021-0031086
Apr. 30, 2021 (KR) 10-2021-0056883

(51) Int. Cl. H04W 72/0453; H04W 72/23

(52) U.S. Cl. CPC H04W 72/0453; H04W 72/23

(57) ABSTRACT

Disclosed is a method for transmitting and receiving a PPDU in a wireless communication system. A terminal receives, from an access point (AP), a frame indicating transmission of a PPDU to one or more terminals and transmits the PPDU on the basis of an AID12 subfield included in the frame. In this case, if the PPDU indicated to be transmitted by the frame is an extremely high throughput (EHT) PPDU, a value of the AID12 subfield is configured to one of multiple values excluding at least one specific value, and the at least one specific value is used to allocate a resource for an uplink orthogonal frequency division multiple access (OFDMA)-based random access (UORA) of at least one terminal supporting high efficiency (HE).

### TECHNICAL FIELD

The present disclosure relates to a wireless communication system and, more particularly, to a wireless communication method and a wireless communication terminal for efficiently signaling of uplink (UL) multi user information in a wireless communication system.

### BACKGROUND ART

In recent years, with supply expansion of mobile apparatuses, a wireless LAN technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHz, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

### DISCLOSURE OF INVENTION

### Technical Problem

The present disclosure is to provide a super-high speed wireless LAN service for new multimedia applications, as described above.

In addition, the present disclosure is to provide a method and a device of determining a PPDU format, based on a frame indicating transmission of a physical layer protocol data unit (PPDU).

In addition, the present disclosure is to provide a method and a device of configuring a value of a length field included in a PPDU to have different values according to a format of the PPDU indicated by an access point (AP).

In addition, the purpose of the disclosure is to provide a method and an apparatus for allocating a resource for PPDU transmission to a legacy terminal and a next-generation terminal by using the same trigger frame.

Technical tasks to be achieved in the specification are not limited to the technical tasks mentioned above, and other technical tasks that are not mentioned may be clearly understood by those skilled in the art on the basis of the following descriptions.

### Solution to Problem

A terminal for transmitting a trigger based physical layer protocol data unit (TB PPDU) corresponding to a response frame on the basis of a trigger frame in a wireless communication system may include: a communication module; and a processor configured to control the communication module. The processor is configured to: receive, from an access point (AP), a frame indicating transmission of a PPDU to one or more terminals, wherein the frame includes a common information field and a user information field for each of the one or more terminals, and the user information field includes an AID12 subfield indicating usage of the user information field; and transmit the PPDU on the basis of the AID12 subfield, wherein if the PPDU indicated to be transmitted by the frame is an extremely high throughput (EHT) PPDU, a value of the AID12 subfield is configured as one of multiple values remaining after excluding at least one specific value, and the at least one specific value is used to allocate a resource for uplink orthogonal frequency division multiple access (OFDMA)-based random access (UORA) of at least one terminal supporting high efficiency (HE).

In addition, the multiple values are used to identify a user information field for each of terminals supporting extremely high throughput (EHT).

In addition, in the disclosure, a first specific value among the at least one specific value is used resource allocation for a UORA operation of terminals unassociated with the AP.

In addition, in the disclosure, the first specific value is “2045”.

In addition, in the disclosure, a second specific value is used to resource allocation for a UORA operation of terminals associated with the AP, and the second specific value is included in the at least one specific value when a specific condition fails to be satisfied, and is included in the multiple values when the specific condition is satisfied.

In addition, in the disclosure, the specific condition corresponds to a case where all of the terminals associated with the AP are not terminals which cannot perform transmission of the EHT PPDU and can perform transmission of a PPDU of the HE.

In addition, in the disclosure, the second specific value is “0”.

In addition, in the disclosure, the specific condition corresponds to a case where the frame is included in the EHT PPDU and transmitted.

In addition, in the disclosure, the specific condition corresponds to a case where among the multiple terminals associated with the AP, all terminals which cannot perform transmission of the EHT PPDU and can perform transmission of a PPDU of the HE do not support the UORA operation.

In addition, in the disclosure, a method is provided, method including: receiving, from an access point (AP), a frame indicating transmission of a PPDU to one or more terminals, wherein the frame includes a common information field and a user information field for each of the one or more terminals, and the user information field includes an AID12 subfield indicating usage of the user information field; and transmitting the PPDU on the basis of the AID12 subfield, wherein if the PPDU indicated to be transmitted by the frame is an extremely high throughput (EHT) PPDU, a value of the AID12 subfield is configured as one of multiple values remaining after excluding at least one specific value, and the at least one specific value is used to allocate a resource for uplink orthogonal frequency division multiple access (OFDMA)-based random access (UORA) of at least one terminal supporting high efficiency (HE).

### Advantageous Effects of Invention

According to an embodiment of the present disclosure, there is an effect of efficiently signaling multi-link information.

In addition, according to an embodiment of the present disclosure, there is an effect of indicating transmission of a PPDU of each different format through one frame.

In addition, according to an embodiment of the present disclosure, there is an effect of indicating transmission of a legacy PPDU for backwards compatibility through one frame.

In addition, according to an embodiment of the present disclosure, in a competition-based channel access system, an entire resource utilization rate can be increased and a performance of a wireless LAN system can be improved.

In addition, according to an embodiment of the disclosure, resources can be allocated to terminals in different generations by using the same frame, and thus signaling overhead can be reduced and resources can be efficiently allocated.

The effects obtainable in the present invention are not limited to the above-mentioned effects, and other effects that are not mentioned may be clearly understood by those skilled in the art to which the present invention belongs, from descriptions below.

### BRIEF DESCRIPTION OF DRAWINGS

FIG. 1 illustrates a wireless LAN system according to an embodiment of the present invention.

FIG. 2 illustrates a wireless LAN system according to another embodiment of the present invention.

FIG. 3 illustrates a configuration of a station according to an embodiment of the present invention.

FIG. 4 illustrates a configuration of an access point according to an embodiment of the present invention.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates an example of a format of a PLCP Protocol data unit (PPDU) for each of various standard generations;

FIG. 8 illustrates an example of various extremely high throughput (EHT) physical protocol data unit (PPDU) formats and a method for indicating the same according to an embodiment of the present invention;

FIG. 9 is a view illustrating a multi-link device according to an embodiment of the present disclosure.

FIG. 10 illustrates a wireless LAN function according to an embodiment of the present disclosure.

FIG. 11 illustrates an uplink (UL) multi user (MU) operation according to an embodiment of the present disclosure.

FIG. 12 illustrates a trigger frame format according to an embodiment of the present disclosure.

FIG. 13 illustrates an UL MU operation according to another embodiment of the present disclosure.

FIG. 14 illustrates an UL MU operation according to another embodiment of the present disclosure.

FIG. 15 illustrates a method for indicating a trigger-based PPDU format according to an embodiment of the present disclosure.

FIG. 16 illustrates a trigger frame format for indicating a trigger-based PPDU format according to an embodiment of the present disclosure.

FIG. 17 illustrates a trigger frame format for indicating a trigger-based PPDU format according to another embodiment of the present disclosure.

FIG. 18 illustrates a determination method of a trigger frame format according to an embodiment of the present disclosure.

FIG. 19 illustrates a configuration method of a length field according to an embodiment of the present disclosure.

FIG. 20 illustrates an UL MU operation according to another embodiment of the present disclosure.

FIG. 21 illustrates an UL MU operation according to another embodiment of the present disclosure.

FIG. 22 illustrates an UL orthogonal frequency division multiple access (OFDMA)-based random access (UORA) operation according to an embodiment of the present disclosure.

FIG. 23 illustrates an UL MU operation according to another embodiment of the present disclosure.

FIG. 24 illustrates a method for indicating a TB PPDU format according to an embodiment of the disclosure.

FIG. 25 illustrates another example of a trigger frame format according to an embodiment of the disclosure.

FIG. 26 illustrates a method for indicating a trigger frame and an RA-RU according to an embodiment of the disclosure.

FIG. 27 illustrates another example of indicating a trigger frame format and an RA-RU according to an embodiment of the disclosure.

FIG. 28 illustrates another example of a method for indicating a TB PPDU format according to an embodiment of the disclosure.

FIG. 29 illustrates an example of an uplink orthogonal frequency division multiple access (OFDMA)-based random access (UORA) operation and a method for indicating a TB PPDU format according to an embodiment of the disclosure.

FIG. 30 illustrates another example of an uplink orthogonal frequency division multiple access (OFDMA)-based random access (UORA) operation and a method for indicating a TB PPDU format according to an embodiment of the disclosure.

FIG. 31 illustrates a trigger frame configuration according to an embodiment of the disclosure.

FIG. 32 illustrates a trigger frame configuration and a UORA operation according to an embodiment of the disclosure.

FIG. 33 illustrates a UL MU operation using a TRS according to an embodiment of the disclosure.

FIG. 34 is a flow chart illustrating an example of a PPDU transmission method according to an embodiment of the disclosure.

FIG. 35 is a flow chart illustrating an example of a frame transmission method for indicating PPDU transmission according to an embodiment of the disclosure.

### BEST MODE FOR CARRYING OUT THE INVENTION

Terms used in the specification adopt general terms which are currently widely used by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively. Hereinafter, in the present invention, a field and a subfield may be interchangeably used.

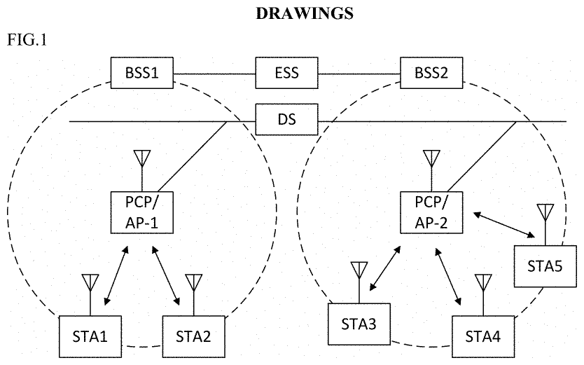

FIG. 1 illustrates a wireless LAN system according to an embodiment of the present invention.

FIG. 1 is a diagram illustrating a wireless LAN system according to an embodiment of the present invention. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present invention, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present invention, the AP is used as a concept including a personal BSS coordination point (PCP) and may include concepts including a centralized controller, a base station (BS), a node-B, a base transceiver system (BTS), and a site controller in a broad sense. In the present invention, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

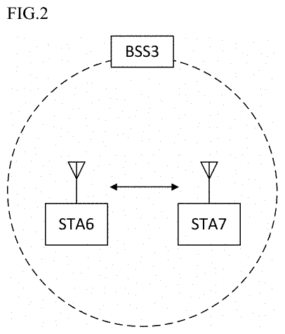

FIG. 2 illustrates an independent BSS which is a wireless LAN system according to another embodiment of the present invention. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

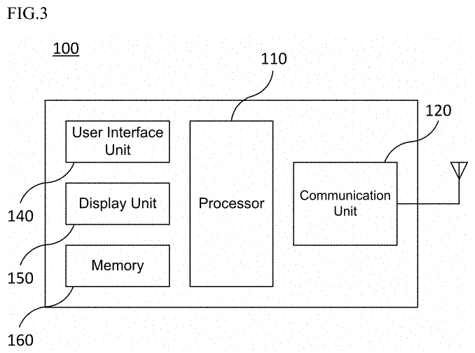

FIG. 3 is a block diagram illustrating a configuration of a station 100 according to an embodiment of the present invention. As illustrated in FIG. 3, the station 100 according to the embodiment of the present invention may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHz, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present invention may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present invention may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 3 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

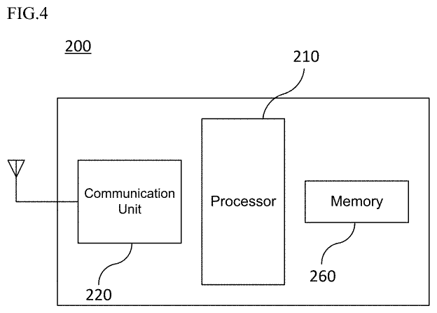

FIG. 4 is a block diagram illustrating a configuration of an AP 200 according to an embodiment of the present invention. As illustrated in FIG. 4, the AP 200 according to the embodiment of the present invention may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present invention includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present invention may include two or more communication modules among different frequency bands, for example, 2.4 GHz, 5 GHz, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present invention, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present invention, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present invention. A detailed embodiment thereof will be described below.

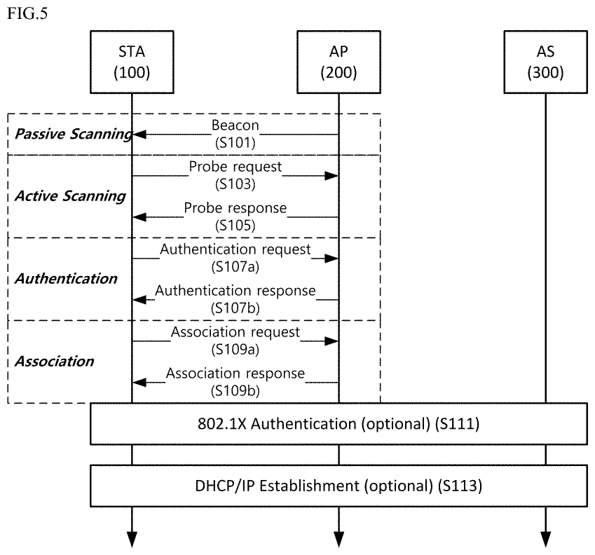

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present invention is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

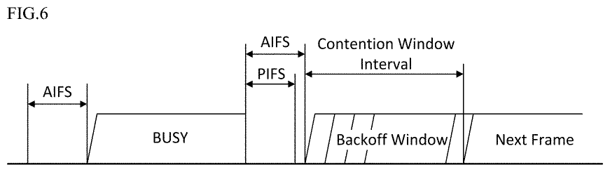

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

Hereinafter, a terminal of the present disclosure is referred to as a non-AP STA, an AP STA, an AP, a STA, a receiving device or a transmitting device, but the present disclosure is not limited thereto. In addition, the AP STA of the present disclosure may be referred to as the AP.

<Examples of Various PPDU Formats>

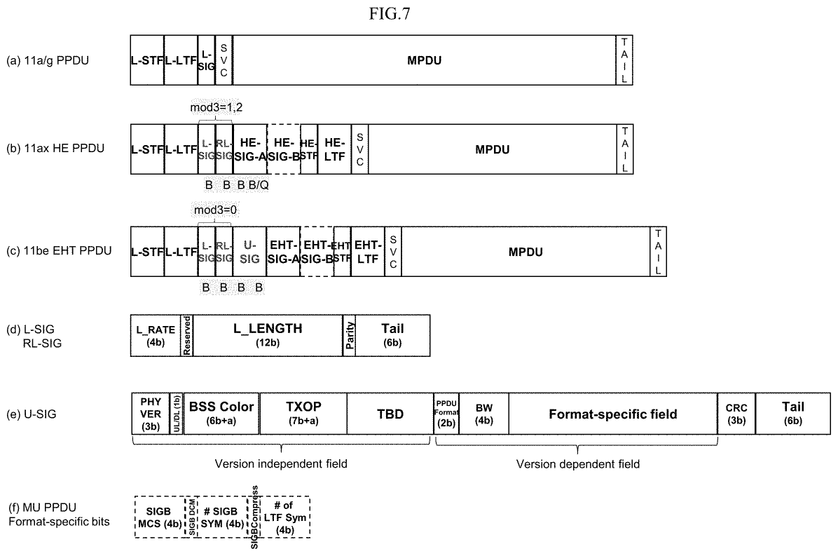

FIG. 7 illustrates an example of a format of a PLCP Protocol data unit (PPDU) for each of various standard generations. More specifically, FIG. 7(a) illustrates an embodiment of a legacy PPDU format based on 802.11a/g, FIG. 7(b) illustrates an embodiment of an HE PPDU format based on 802.11ax, and FIG. 7(c) illustrates an embodiment of a non-legacy PPDU (i.e., EHT PPDU) format based on 802.11be. FIG. 7(d) illustrates detailed field configurations of RL-SIG and L-SIG commonly used in the PPDU formats.

Referring to FIG. 7(a), a preamble of the legacy PPDU includes a legacy short training field (L-STF), a legacy long training field (L-LTF), and a legacy signal field (L-SIG). In an embodiment of the present invention, the L-STF, the L-LTF, and the L-SIG may be referred to as a legacy preamble.

Referring to FIG. 7(b), a preamble of the HE PPDU additionally includes, in the legacy preamble, a repeated legacy short training field (RL-SIG), a high efficiency signal A field (HE-SIG-A), a high efficiency signal B field (HE-SIG-B), a high efficiency short training field (HE-STF), and a high efficiency long training field (HE-LTF). In an embodiment of the present invention, the RL-SIG, HE-SIG-A, the HE-SIG-B, the HE-STF and the HE-LTF may be referred to as an HE preamble. A specific configuration of the HE preamble may be modified according to an HE PPDU format. For example, HE-SIG-B may be used only in an HE MU PPDU format.

Referring to FIG. 7(c), a preamble of the EHT PPDU additionally includes, in the legacy preamble, a repeated legacy short training field (RL-SIG), a universal signal field (U-SIG), and an extremely high throughput signal A field (EHT-SIG-A), an extremely high throughput signal B field (EHT-SIG-B), an extremely high throughput short training field (EHT-STF), and an extremely high throughput long training field (EHT-LTF). In an embodiment of the present invention, the RL-SIG, EHT-SIG-A, the EHT-SIG-B, the EHT-STF and the EHT-LTF may be referred to as an EHT preamble. A specific configuration of a non-legacy preamble may be modified according to an EHT PPDU format. For example, EHT-SIG-A and EHT-SIG-B may be used only in a part of the EHT PPDU format.

64-FFT OFDM is applied in an L-SIG field included in the preamble of the PPDU, and the L-SIG field includes a total of 64 subcarriers. Among 64 subcarriers, 48 subcarriers excluding a guard subcarrier, a DC subcarrier, and a pilot subcarrier are used for transmission of L-SIG data. BPSK and a modulation and coding scheme (MCS) of rate=1/2 are applied in L-SIG, and therefore the L-SIG may include a total of 24 bits of information. FIG. 7(d) illustrates a 24-bit information configuration of L-SIG.

Referring to FIG. 7(d), the L-SIG includes an L_RATE field and an L_LENGTH field. The L_RATE field includes 4 bits and indicates an MCS used for data transmission. Specifically, the L_RATE field indicates one value among transmission rates of 6/9/12/18/24/36/48/54 Mbps obtained by combining a modulation scheme of BPSK/QPSK/16-QAM/64-QAM, etc. and an inefficiency of ½, ⅔, ¾, etc. A total length of a corresponding PPDU may be indicated by combining information of the L_RATE field and information of the L_LENGTH field. In a non-legacy PPDU format, the L_RATE field is configured to a minimum rate of 6 Mbps.

A unit of the L_LENGTH field is a byte and a total of 12 bits are allocated to signal up to 4095, and a length of the PPDU may be indicated in combination with the L_RATE field. A legacy terminal and a non-legacy terminal may interpret the L_LENGTH field in different ways.

Firstly, a method of interpreting the length of the PPDU by the legacy terminal and the non-legacy terminal by using the L_LENGTH field is described below. When a value of the L_RATE field is configured to indicate 6 Mbps, 3 bytes during 4 us which is one symbol duration of 64 FET (i.e., 24 bits) may be transmitted. Therefore, the 64 FET standard symbol number after an L-SIG is acquired by adding 3 bytes corresponding to a SVC field and a Tail field to the L_LENGTH field value and then dividing the same by 3 bytes which is a transmission amount of one symbol. When multiplying the acquired symbol number by 4 us which is one symbol duration and then adding 20 us which is consumed to transmit the L-STF, the L-LTF, and the L-SIG, the length of a corresponding PPDU, i.e., a receipt time (RXTIME) is acquired, which is expressed by Equation 1 below.

$$RXTIME ( us ) = ( ⌈ \frac{L\_LENGTH + 3}{3} ⌉ ) \times 4 + 20 \qquad [ Equation 1 ]$$

In this case, ┌x┐ denotes the smallest natural number greater than or equal to x. Since the maximum value of the L_LENGTH field is 4095, the length of the PPDU can be set up to 5.464 ms. The non-legacy terminal transmitting the PPDU should set the L_LENGTH field as shown in Equation 2 below.

$$L\_LENGTH ( byte ) = ( ⌈ \frac{TXTIME - 20}{4} ⌉ ) \times 3 - 3 \qquad [ Equation 2 ]$$

Herein, TXTIME is the total transmission time constituting the corresponding PPDU, and is expressed by Equation 3 below. In this case, TX represents the transmission time of X.

$$TXTIME ( us ) = {T}_{L - STF} + {T}_{L - L T F} + {T}_{L - SIG} + {T}_{R L - SIG} + {T}_{U - SIG} + ( {T}_{EHT - SIG - A} ) + ( {T}_{E H T - SIG - B} ) + {T}_{E H T - STF} + {N}_{E H T - L T F} \cdot {T}_{E H T - LTF} + {T}_{D A T A} \qquad [ Equation 3 ]$$

Referring to the above equations, the length of the PPDU is calculated based on a rounded up value of L_LENGTH/3. Therefore, for a random value of k, three different values of L_LENGTH=(3k+1, 3k+2, 3(k+1)) indicate the same PPDU length.

Referring to FIG. 7(e), a universal SIG (U-SIG) field continues to exist in an EHT PPDU and a WLAN PPDU of a subsequent generation, and serves to classify a generation of a PPDU, which includes 11be. U-SIG is a 64 FFT-based OFDM 2 symbol and may transfer a total of 52 bits of information. In 52 bits, 43 bits excluding 9 bits for CRC/Tail are largely divided into a version independent (VI) field and a version dependent (VD) field.

A VI bit enables a current bit configuration to be maintained even later on, so that even if a PPDU of a subsequent generation is defined, current 11be terminals may obtain information on the PPDU via the VI fields of the PPDU. To this end, the VI field includes PHY version, UL/DL, BSS color, TXOP, and reserved fields. The PHY version field is 3 bits, and serves to sequentially classify 11be and subsequent generation wireless LAN standards into versions. 11be has a value of 000b. The UL/DL field identifies whether the PPDU is an uplink/downlink PPDU. BSS color indicates an identifier for each BSS defined in 11ax, and has a value of 6 bits or more. TXOP indicates transmit opportunity duration transmitted in a MAC header, wherein, by adding the TXOP to a PHY header, the PPDU may infer a length of the TXOP included therein without having to decode an MPDU, and the TXOP has a value of 7 bits or more.

The VD field is signaling information useful only for an 11be version of the PPDU, and may include a field commonly used in any PPDU format, such as PPDU format and BW, and a field defined differently for each PPDU format. The PPDU format is a classifier that classifies EHT single user (SU), EHT multiple user (MU), EHT trigger-based (TB), EHT extended range (ER) PPDU, etc. The BW field signals five basic PPDU BW options (BW, which is expressible in the form of an exponential power of 20*2, may be referred to as basic BW) of 20, 40, 80, 160 (80+80), and 320 (160+160) MHz and various remaining PPDU BWs configured via preamble puncturing. After being signaled at 320 MHz, signaling may be performed in a form in which some 80 MHz is punctured. A punctured and modified channel type may be signaled directly in the BW field, or may be signaled using the BW field with a field (e.g., a field within the EHT-SIG field) appearing after the BW field. If the BW field is configured to 3 bits, a total of 8 BW signaling may be performed, and therefore only up to 3 signaling may be performed in a puncturing mode. If the BW field is configured to 4 bits, a total of 16 BW signaling may be performed, and therefore up to 11 signaling may be performed in the puncturing mode.

A field located after the BW field varies depending on the type and format of the PPDU, an MU PPDU and an SU PPDU may be signaled in the same PPDU format, a field for classification between the MU PPDU and the SU PPDU may be located before an EHT-SIG field, and additional signaling may be performed for the same. Both the SU PPDU and the MU PPDU include the EHT-SIG field, but some fields that are not required in the SU PPDU may be compressed. Information on the field to which the compression has been applied may be omitted or may have a size smaller than a size of an original field included in the MU PPDU. For example, in a case of the SU PPDU, a common field of the EHT-SIG may be omitted or replaced, or the SU PPDU may have a different configuration in which a user specific field is replaced, reduced to one, or the like.

Alternatively, the SU PPDU may further include a compression field indicating whether compression is performed, and a part of field (e.g., RA fields, etc.) may be omitted according to a value of the compressed field.

If a part of the EHT-SIG field of the SU PPDU is compressed, information to be included in the compressed field may be signaled also in an uncompressed field (e.g., the common field, etc.). The MU PPDU corresponds to a PPDU format for concurrent reception by multiple users, and therefore the EHT-SIG field is required to be transmitted subsequently to the U-SIG field, and the amount of signaled information may vary. That is, a plurality of MU PPDUs are transmitted to a plurality of STAs, so that the respective STAs should recognize locations of RUs, at which the MU PPDUs are transmitted, the STAs to which the RUs have been allocated respectively, and whether the transmitted MU PPDUs have been transmitted to the STAs themselves. Therefore, an AP should transmit information described above, by including the same in the EHT-SIG field. To this end, information for efficient transmission of the EHT-SIG field is signaled in the U-SIG field, and this may correspond to an MCS that is a modulation method and/or the number of symbols in the EHT-SIG field. The EHT-SIG field may include information on a size and location of an RU allocated to each user.

In the case of the SU PPDU, a plurality of RUs may be allocated to an STA, and the plurality of RUs may be continuous or discontinuous. If the RUs allocated to the STA are discontinuous, the STA should recognize a punctured RU in the middle in order to efficiently receive the SU PPDU. Accordingly, the AP may transmit the SU PPDU including information (e.g., a puncturing pattern of the RUs, etc.) of punctured RUs among the RUs allocated to the STA. That is, in the case of the SU PPDU, a puncturing mode field, which includes information indicating, in a bitmap format, etc., a puncturing pattern and whether the puncturing mode is applied, may be included in the EHT-SIG field, and the puncturing mode field may signal a discontinuous channel type appearing within a bandwidth.

The signaled discontinuous channel type is limited, and indicates discontinuous channel information and BW of the SU PPDU in combination with a value of the BW field. For example, the SU PPDU is a PPDU transmitted only to a single terminal, so that the STA may recognize a bandwidth allocated to itself via the BW field included in the PPDU, and the SU PPDU may recognize a punctured resource in the allocated bandwidth via the puncturing mode field of the EHT-SIG field or the U-SIG field included in the PPDU. In this case, the terminal may receive the PPDU in resource units remaining after excluding a specific channel of the punctured resource unit. The plurality of RUs allocated to the STA may be configured by different frequency bands or tones.

Only a limited discontinuous channel type is signaled in order to reduce signaling overhead of the SU PPDU. Puncturing may be performed for each 20 MHz sub-channel, so that if puncturing is performed for BW having a large number of 20 MHz sub-channels, such as 80, 160, and 320 MHz, a discontinuous channel (if puncturing of only edge 20 MHz is considered to be discontinuous) type should be signaled in the case of 320 MHz by expressing whether each of 15 20 MHz sub-channels remaining after excluding a primary channel is used. As such, allocating bits to signal a discontinuous channel type of single user transmission may act as excessively large signaling overhead in consideration of a low transmission rate of a signaling part.

The present disclosure suggests a signaling technique of a discontinuous channel type of the SU PPDU and illustrates the discontinuous channel type determined according to the suggested technique. In addition, the present disclosure suggests a signaling technique of a puncturing type of each of a primary 160 MHz and a secondary 160 MHz in 320 MHz BW configuration of the SU PPDU.

In addition, an embodiment of the present disclosure suggests a technique which differs in the configuration of the PPDU indicating the preamble puncturing BW values according to the PPDU format signaled in the PPDU format field. If the length of the BW field is 4 bits, in case of the EHT SU PPDU or the TB PPDU, the EHT-SIG-A of 1 symbol may be additionally signaled after the U-SIG, or the EHT-SIG-A may be never signaled, so that by considering this, it is necessary to completely signal a maximum of 11 puncturing modes through only the BW field of the U-SIG. However, in case of the EHT MU PPDU, since the EHT-SIG-B is additionally signaled after the U-SIG, the maximum of 11 puncturing modes may be signaled by a method different from the SU PPDU. In case of the EHT ER PPDU, the BW field is configured as 1 bit to signal information on whether the PPDU uses 20 MHz or 10 MHz band.

FIG. 7(f) illustrates a configuration of a format-specific field of a VD field when the EHT MU PPDU is indicated in the PPDU format field of U-SIG. In the case of the MU PPDU, SIG-B, which is a signaling field for concurrent reception by multiple users, is essentially required, and SIG-B may be transmitted without separate SIG-A after U-SIG. To this end, information for decoding of SIG-B should be signaled in U-SIG. These fields include SIG-B MCS, SIG-B DCM, Number of SIG-B Symbols, SIG-B Compression, and Number of EHT-LTF Symbols.

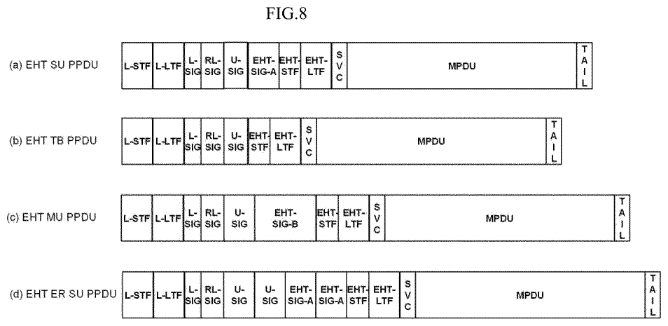

FIG. 8 illustrates an example of various extremely high throughput (EHT) physical protocol data unit (PPDU) formats and a method for indicating the same according to an embodiment of the present invention.

Referring to FIG. 8, a PPDU may include a preamble and a data part, and an EHT PPDU format, that is a PPDU type, may be classified according to a U-SIG field included in the preamble. Specifically, based on a PPDU format field included in the U-SIG field, whether the format of the PPDU is an EHT PPDU may be indicated.

FIG. 8(a) shows an example of an EHT SU PPDU format for a single STA. An EHT SU PPDU is a PPDU used for single user (SU) transmission between an AP and a single STA, and an EHT-SIG-A field for additional signaling may be located after the U-SIG field.

FIG. 8(b) shows an example of an EHT trigger-based PPDU format which corresponds to an EHT PPDU transmitted based on a trigger frame. An EHT Trigger-based PPDU is an EHT PPDU transmitted based on a trigger frame and is an uplink PPDU used for a response to the trigger frame. Unlike in the EHT SU PPDU, an EHT-SIG-A field is not located after a U-SIG field in the EHT PPDU.

FIG. 8(c) shows an example of an EHT MU PPDU format which corresponds to an EHT PPDU for multiple users. An EHT MU PPDU is a PPDU used to transmit the PPDU to one or more STAs. In the EHT MU PPDU format, an HE-SIG-B field may be located after a U-SIG field.

FIG. 8(d) shows an example of an EHT ER SU PPDU format used for single user transmission with an STA in an extended range. An EHT ER SU PPDU may be used for single user transmission with an STA of a wider range compared to the EHT SU PPDU described in FIG. 8(a), and a U-SIG field may be repeatedly located on a time axis.

The EHT MU PPDU described in FIG. 8(c) may be used by an AP to perform downlink transmission to a plurality of STAs. Here, the EHT MU PPDU may include scheduling information so that the plurality of STAs may concurrently receive the PPDU transmitted from the AP. The EHT MU PPDU may transfer, to the STAs, AID information of a transmitter and/or a receiver of the PPDU transmitted via a user specific field of EHT-SIG-B. Accordingly, the plurality of terminals having received the EHT MU PPDU may perform a spatial reuse operation based on the AID information of the user specific field included in a preamble of the received PPDU.

Specifically, a resource unit allocation (RA) field of the HE-SIG-B field included in the HE MU PPDU may include information on a configuration of a resource unit (e.g., a division form of the resource unit) in a specific bandwidth (e.g., 20 MHz, etc.) of a frequency axis. That is, the RA field may indicate configurations of resource units segmented in a bandwidth for transmission of the HE MU PPDU, in order for the STA to receive the PPDU. Information on the STA allocated (or designated) to each segmented resource unit may be included in the user specific field of EHT-SIG-B so as to be transmitted to the STA. That is, the user specific field may include one or more user fields corresponding to the respective segmented resource units.

For example, a user field corresponding to at least one resource unit used for data transmission among the plurality of segmented resource units may include an AID of a receiver or a transmitter, and a user field corresponding to the remaining resource unit(s) which is not used for data transmission may include a preconfigured null STA ID.

Two or more PPDUs illustrated in FIG. 8 may be indicated by a value indicating the same PPDU format. That is, two or more PPDUs may be indicated by the same PPDU format through the same value. For example, the EHT SU PPDU and the EHT MU PPDU may be indicated by the same value through the U-SIG PPDU format subfield. At this time, the EHT SU PPDU and the EHT MU PPDU may be divided by the number of the STAs receiving the PPDU. For example, the PPDU receiving one STA may be identified as the EHT SU PPDU, and when the number of the STAs is configured to receive two or more STAs, the PPDU may be identified as the EHT MU PPDU. In other words, two or more PPDU formats illustrated in FIG. 8 may be indicated through the same subfield value.

In addition, a part field among the fields illustrated in FIG. 8 or part information of the field may be omitted, and the case that the part field or the part information of the field is omitted may be defined as a compression mode or a compressed mode.

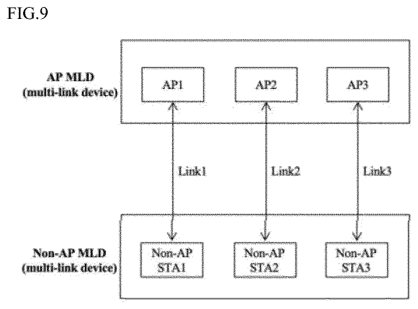

FIG. 9 is a view illustrating a multi-link device according to an embodiment of the present disclosure.

Referring to FIG. 9, a concept of a device to which one or more STAs are affiliated may be defined. According to an embodiment of the present disclosure, the devices to which more than one STA (i.e., two or more) are affiliated may be defined. At this time, the device may be a logical concept. Therefore, the devices to which one or more STAs or more than one STA having such a concept are affiliated may be referred to as a multi-link device (MLD), a multi-band device, or a multi-link logical entity (MLLE).

Otherwise, the devices of the concept may be referred to as a multi-link entity (MLE). In addition, the MLD may have one medium access control service access point (MAC SAP) until a logical link control (LLC), and the MLD may have one MAC data service.

It is possible that the STAs included in the MLD operate in one or more links or channels. That is, it is possible that the STAs included in the MLD operate in multiple channels which are different from each other. For example, it is possible that the STAs included in the MLD operate by using the channels of the different frequency bands of 2.4 GHz, 5 GHz, and 6 GHz. Accordingly, it is possible that the MLD obtains a benefit from the channel access, and increases the performance of the entire network. A conventional wireless LAN operates by the single link, but the MLD operation may obtain much more channel access opportunities by using the plurality of links or the STA may efficiently operate in the plurality of links in consideration of a situation of the channel.

In addition, in case that the STAs affiliated to the MLD are the APs, the MLD to which the APs are affiliated may be the AP MLD. However, in case that the STAs affiliated to the MLD are the non-AP STA, the MLDs to which the non-APs are affiliated may be the non-AP MLD.

Referring to FIG. 9, the MLD including the multiple STAs may exist, and the multiple STAs included in the MLD may operate in the multiple links. In FIG. 9, the MLD including an AP1, an AP2, and an AP3 which are the AP may be referred to as an AP MLD, and the MLD including a non-AP STA1, a non-AP STA2, and a non-AP STA3 which are the non-AP STA may be referred to as a non-AP MLD. The STAs included in the MLD may operate in a link 1, a link 2, a link 3, or a partial link of the link 1 to the link 3.

According to an embodiment of the present disclosure, a multi-link operation may include a multi-link configuration (multi-link setup) operation. The multi-link configuration may be an operation corresponding to association performed in a single link operation. In order to exchange the frame in the multi-link, the multi-link configuration may be performed in advance. The multi-link configuration may be performed by using a multi-link configuration element. The multi-link configuration element may include capability information related to the multi-link, and the capability information may include information regarding whether it is possible that the other STA included in the MLD transmits the frame to the other link while the STA included in the MLD receives the frame through one link. That is, the capability information may include information regarding whether the STAs (non-AP STA and/or AP (or AP STA)) transmit/receive the frames in different transmission directions at the same time, through the links included in the MLD. In addition, the capability information may further include information regarding a usable link or operating channel. The multi-link configuration may be configured through a negotiation between peer STAs, and the multi-link operation may be configured through one link.

According to an embodiment of the present disclosure, a mapping relationship between the links of the TID and the MLD may exist. For example, when the TID and the link are mapped, the TID may be transmitted through the mapped link. A mapping between the TID and the link may be performed through a transmission direction base (directional-based). For example, the mapping may be performed for each of both directions between the MLD1 and the MLD2. In addition, a default configuration may exist in the mapping between the TID and the link. For example, the mapping between the TID and link may be mapping all TIDs in any link, fundamentally.

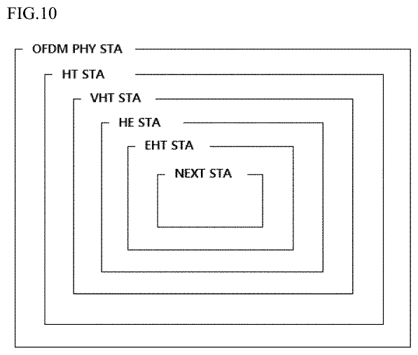

FIG. 10 illustrates a wireless LAN function according to an embodiment of the present disclosure.

Referring to FIG. 10, the wireless LAN of any standard may include a function of the wireless LAN of the other standard. In addition, the wireless LAN of any standard may be the wireless LAN of the other standard. Herein, the wireless LAN may mean the STA. In addition, the wireless LAN may mean the MLD including the STA. For example, a wireless LAN standard may include a previous generation standard function and include an additional function. For example, the HT STA may be the OFDM PHY STA. In addition, the HT STA may perform an additional function as well as the function of the OFDM PHY STA. For example, the VHT STA may be the HT STA. In addition, the VHT STA may perform the additional function as well as the function of the HT STA. For example, the HE STA may be the VHT STA. In addition, the HE STA may perform an additional function as well as the function of the VHT STA. In addition, the EHT STA may be the HE STA. In addition, the EHT STA may perform an additional function as well as the function of the HE STA. In addition, the standards after the EHT standard may exist. In the present disclosure, a standard after the EHT standard may be referred to as a NEXT standard, and the STA according to the NEXT standard may be referred to as the NEXT STA. The NEXT STA may be the EHT STA. In addition, the NEXT STA may perform an additional function as well as the function of the EHT STA.

FIG. 10 is a diagram illustrating a relationship between the STAs of each standard. Referring to FIG. 10, the EHT STA may be the HE STA, may be the VHT STA, may be the HT STA, and may be the OFDM PHY STA. In addition, the NEXT STA may be the EHT STA, may be the HE STA, may be the VHT STA, may be the HT STA, and may be the OFDM PHY STA.

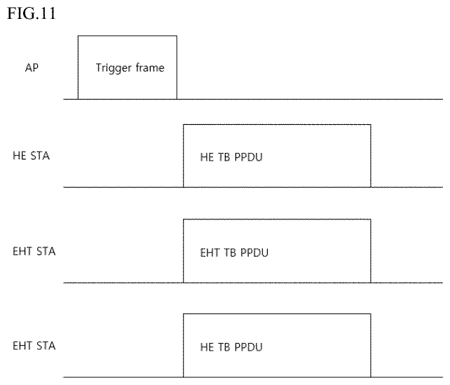

FIG. 11 illustrates an uplink (UL) multi user (MU) operation according to an embodiment of the present disclosure.

Referring to FIG. 11, the AP may indicate transmission of the PPDU to at least one STA through a specific frame (for example, triggering frame), and at least one STA may transmit the PPDU which has same or different format at the same time on the basis of a specific frame transmitted from the AP.

Specifically, as illustrated in FIG. 11, a frame which indicates (solicits) or triggers a multi-user (MU) transmission may be transmitted, and on the basis of the frame, transmission or the response to the frame may be performed by one or more STAs. At this time, when transmitting the response to the frame is performed by the one or more STAs, one or more STAs may perform the response simultaneously and immediately based on the frame and the response to the frame may start transmission at the end of the PPDU including the frame after the SIFS. For example, when the frame indicates an immediate response, one or more STAs may transmit the response to the frame immediately. The frame which indicates or triggers transmission to one or more STAs may be a frame including information which indicates or triggers the UL transmission to one or more STAs, in the MAC header or the trigger frame. At this time, the frame may include information (for example, TRS control subfield) which triggers or indicates the UL transmission only to one STA in the MAC header. In this case, the frame may include, a MAC header, information (e.g., TRS control subfield) triggering or indicating uplink transmission to only one STA.

For example, information which indicates or triggers the UL transmission included in the MAC header may be a triggered response scheduling (TRS) or a TRS control subfield included in a HT control field, a control subfield, or an A-control subfield.

The frame for indicating or triggering the UL transmission may be transmitted by the AP, and when the frame for indicating or triggering the UL transmission is the trigger frame, the response thereto may be transmitted through a trigger-based PPDU (TB PPDU). At this time, the TB PPDDU may include the NEXT TB PPDU defined in the next standard as well as the HE TB PPDU and the EHT TB PPDU as described above.

The HE TB PPDU may be configured by a preamble, data and a packet extension (PE), and the preamble may include the L-STF, the L-LTF, the L-SIG, the RL-SIG, the HE-SIG-A, the HE-STF, and the HE-LTF, sequentially.

The EHT TB PPDU and the NEXT TB PPDU may be configured by the preamble, the data and the PE, and the preamble of the EHT TB PPDU and the NEXT TB PPDU may include the L-STF, the L-LTF, the L-SIG, the RL-SIG, the U-SIG, the (EHT-/NEXT-)STF, and the (EHT-/NEXT-)LTF, sequentially.

The frame which indicates or triggers transmission of the PPDU to one or more STAs may include information necessary for transmitting the TB PPDU by one or more STAs. For example, when the type subfield included in the frame is “01” (B3, B2) and the subtype subfield is “0010” (B7, B6, B5, B4), the type subfield and the frame including the subtype subfield may be the trigger frame which is a control frame.

In case that the response of the TB PPDU is indicated or triggered to the multiple STAs, when the formats of the PPDU to which the multiple STAs respond are different from each other, the problem that it is difficult to receive the PPDU which is the response to which the AP indicating or triggering the response is transmitted from the multiple STAs may occur. The problem that it is difficult to receive the PPDU which is a response to which the AP indicating or triggering the response is transmitted from the multiple STAs may occur if information included in the preamble of the PPDU to which the multiple STAs respond are different from each other according to the format.

Accordingly, in case that the multiple STAs responds to the frame of the AP in order to solve the problem, the types of information included in the responding PPDU format and/or the preamble of the PPDU may be configured to be identical to each other. For example, in case that the multiple STAs transmits the HE TB PPDU in response to the frame of the AP, the AP may transmit information or an appointment about information included in the HE TB PPDU may be determined so that information included in the L-STF, the L-LTF, the L-SIG, the RL-SIG, and the HE-SIG-A are identical to each other, so as to enable the AP to successfully receive the preamble transmitted by the multiple STAs. However, if the HE TB PPDU, the EHT TB PPDU, and the NEXT TB PPDU are simultaneously transmitted through the overlapping subband, since the TB PPDU formats are different from each other, the problem that it is difficult to receive the same by the AP may occur.

According to an embodiment of the present disclosure, the HE STA may transmit the HE TB PPDU. In addition, the EHT STA may transmit the EHT TB PPDU or the HE TB PPDU. In addition, the NEXT STA may transmit the NEXT TB PPDU, the EHT TB PPDU, or the HE TB PPDU. This is because the STA of any standard may include a function of a previous standard, as illustrated in FIG. 10.

As illustrated in FIG. 11, in case that the AP transmits the frame for scheduling transmission of the TB PPDU to the HE STA and the EHT STA and indicates or triggers transmission of the TB PPDU through the frame, an accurate indication or protocol for the TB PPDU format may not exist. In this case, the HE STA may transmit the HE TB PPDU in response to the frame, and the EHT STA may respond by using the EHT TB PPDU or the HE TB PPDU. In this case, it is difficult to receive, by the AP, the TB PPDU transmitted by the STA, and even if the successful transmission is not performed since the AP fails to successfully receive the TB PPDU from the multiple STAs, the problem that the medium is occupied to reduce the transmission opportunity of the other STAs may occur.

Hereinafter, in the present disclosure, the indicating to the STA may mean the indicating the response from the STA, and the trigger and the indication may be used as same meaning.

In addition, the HE trigger frame, the EHT trigger frame, and the NEXT trigger frame may be the trigger frame defined from the HE, the EHT, and the NEXT standard, respectively. In addition, the HE TRS, the EHT TRS, and the NEXT TRS in the present disclosure may be the TRS defined from the HE, the EHT, and the NEXT standard, respectively.

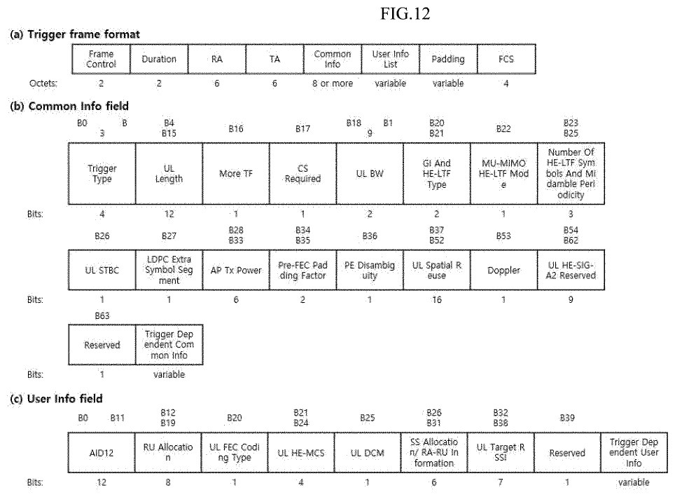

FIG. 12 illustrates a trigger frame format according to an embodiment of the present disclosure.

FIG. 12A illustrates a trigger frame format, and FIG. 12B and FIG. 12C illustrate a common information (info) field and a user information (info) field which are the fields included in the trigger frames, respectively.

Referring to FIG. 12A, the frame may include a frame control field, a duration field, and an address field as a trigger MAC header, and may include a common information field and a user information list field. The address field may include a resource allocation (RA) field and a transmission address (TA) field.

The common information field may include information commonly corresponding to all STAs which are indicated by the trigger frame. FIG. 12B illustrates an example of the common information field.

The user information list field may include 0 or more user information field, and the user information list field of the trigger frame, excluding a specific type of the trigger frame, may include 1 or more user information fields. FIG. 12C illustrates one example of the user information field.

The trigger frame may further include a padding field and a frame check sequence (FCS) field. The padding field may be used to extend the length of the frame to secure a time which the STA receiving the trigger frame requires to prepare the response to the trigger frame, and may be selectively included in the trigger frame.

Referring to FIG. 12B, the common information field may include a trigger type subfield. The trigger type subfield may be used for identifying the trigger frame variant. Otherwise, the type of the trigger frame may be indicated based on a value of the trigger frame subfield. In addition, a length and information included in a trigger dependent common info subfield and a trigger dependent user info subfield illustrated in FIG. 12 may be determined based on the trigger type subfield. For example, the trigger type subfield may be presented through B0 bit to B3 bit of the common information field.

The common information field may include an uplink (UL) length subfield. The UL length subfield may include information about the length of the TB PPDU which is the response to the trigger frame, and may include information about the length of the frame responding to the trigger frame. In addition, the UL length subfield may indicate the value to be included in the length subfield of the L-SIG of the TB PPDU responding to the trigger frame. Therefore, the STA which receives the trigger frame and responds by using the TB PPDU may configure the value of the length subfield included in the L-SIG of the TB PPDU on the basis of the value of the UL length subfield included in the received trigger frame. Specifically, the STA responding to the TB PPDU may configure the length subfield included in the L-SIG of the TB PPDU by the value of the UL length subfield included in the received trigger frame. For example, the STA may configure the length subfield included in the L-SIG of the TB PPDU and transmit the TB PPDU on the basis of the value of B4 to B15 bit of the common information field indicating the UL length subfield.

In addition, the common information field may further include an UL bandwidth (BW) subfield. The UL BW subfield may indicate the BW value included in a signaling field (for example, HE-SIG-A or U-SIG, etc.) of the TB PPDU responding to the trigger frame, and indicate a maximum BW of the TB PPDU transmitted in response to the trigger frame. Therefore, the STA may configure the BW value included in the signaling field of the TB PPDU on the basis of the value of the UL BW subfield included in the trigger frame.

In addition, the common information field may further include information to be included in a signaling field of the TB PPDU which is the response to the trigger frame. Therefore, the STA receives the trigger frame, and then configures information included in the TB PPDU on the basis of information included in the trigger frame.

Referring to FIG. 12C, the user information field may include an AID12 subfield. The AID12 subfield may be used for indicating a function of the user information field or an intended receiver of the user information field including the AID12 subfield. Therefore, the AID12 subfield may perform a role of indicating the function of the trigger frame or the intended receiver of the trigger frame including the AID12 subfield. For example, when the value of AID12 subfield is a preconfigured value, the user information field may indicate random access resource unit (RA-RU). That is, the preconfigured value of the AID12 subfield may indicate that the user information field indicates the RA-RU. Specifically, when the value of the AID12 subfield is “0”, the user information field may indicate the RA-RU for the associated STAs. For example, when the value of the AID12 subfield is “0”, the user information field may indicate the RA-RU for the associated STAs, and when the value of the AID12 subfield is “2045”, the user information field may indicate the RA-RU for unassociated STAs. The STA corresponding to the STA ID (for example, associated ID (AID)) indicated by the value of the AID12 subfield may indicate the response by using the trigger frame including the AID subfield or the user information field including the AID12 subfield. For example, the AID12 subfield may indicate 12LSBs of the AID or the AID. The STA corresponding to the value indicated by the AID12 subfield may transmit the TB PPDU in response to the received trigger frame. In this case, the value of the AID12 subfield may be a range of “1” to “2007” (including 1 and 2007), and when the AID12 subfield has a preconfigured value (for example, “2046”), the RU corresponding to the preconfigured value of the AID12 subfield may not be assigned to any STAs. In addition, when the AID subfield is a preconfigured value (for example, “4095”), the preconfigured value may indicate a start of padding of the trigger frame.

Information of the user information field including the AID12 subfield may be information corresponding to the STAs indicated by the AID12 subfield. For example, the resource unit (RU) allocation subfield may indicate a size, a location, and the like of the RU. At this time, a value of the RU allocation subfield of the user information field including the AID12 subfield may be information corresponding to the STA indicated by the AID12 subfield. That is, the RU indicated by the RU allocation subfield of the AID12 subfield may be the RU allocated to the STA indicated by the AID12 subfield.

In addition, the user information field may indicate a coding method (UL FEC coding type) for generating the TB PPDU transmitted in response to the trigger frame, a modulation method (UL HE-MCS, UL DCM), and a power (UL Target RSSI), and the like.

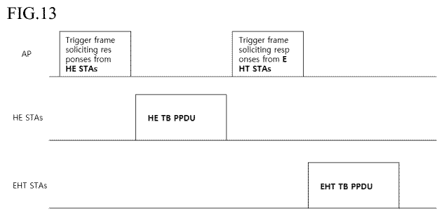

FIG. 13 illustrates an UL MU operation according to another embodiment of the present disclosure.

Referring to FIG. 13, when the AP indicates transmission of the PPDU through the trigger frame, the STAs transmit, as a response, PPDUs of different formats on the basis of the trigger frame. An embodiment illustrated in FIG. 13 may be a method for solving the problem illustrated in FIG. 10 and FIG. 11, and the contents described above may be omitted.

Specifically, the EHT STA may not transmit the HE TB PPDU and may not perform the HE UL MU operation. In addition, the EHT STA may respond to the TRS (for example, PPDU including the TRS control subfield) or a trigger frame by the EHT TB PPDU format.

The STA may transmit only the TB PPDU corresponding to the latest standard by which the STA is supportable, and may not transmit the TB PPDU corresponding to the previous standard. That is, the NEXT STA may transmit only the NEXT TB PPDU, and may not transmit the HE TB PPDU corresponding to the previous standard. In addition, the NEXT STA may perform the NEXT UL MU operation, but may not perform the HE UL MU operation. That is, the EHT STA may transmit only the EHT TB PPDU in response to the trigger frame of the AP, and may perform only the EHT UL MU operation.

Therefore, it is unnecessary that the STA responding to the trigger frame or the TRS selects any format which responds by the TB PPDU, and the method has an advantage that the STA responding to the trigger frame or the TRS can be simply implemented.

In addition, the STA which indicates the transmission of the TB PPDU by transmitting the trigger frame or the TRS may be scheduled so that the different TB PPDUs are not transmitted while overlapping each other. That is, the STA transmitting the trigger frame or the TRS may not indicate the HE STA, the EHT STA and/or the NEXT STA, together, by the STA responding to the trigger frame or the TRS. Otherwise, the STA responding to the trigger frame or the TSR may not indicate the HE STA, the EHT STA and/or the NEXT STA through one PPDU. Otherwise, the HE trigger frame (or TRS), the EHT trigger frame (or TRS), the NEXT trigger frame (or TRS) may not be included in one PPDU, or the HE STA, the EHT STA, and the NEXT STA may not be indicated by one trigger frame. Otherwise, the EHT STA and the NEXT STA may not be indicated by the HE trigger frame. However, there is an exception in case of indicating the associated PPDU (PPDU in which the multiple PPDU exists in a frequency domain division type). In the present disclosure, the HE STA may mean the HE STA, other than the EHT STA and the NEXT STA. In addition, the EHT STA may mean the EHT STA, other than the NEXT STA.

Referring to FIG. 13, the AP may transmit the trigger frame indicating only the HE STAs. In addition, since the STA receiving the trigger frame is the HE STA, the response may be performed by using the HE TB PPDU. In addition, the AP may transmit the trigger frame indicating only the EHT STAs. In addition, since the STA receiving the trigger frame which indicates only the EHT STAs is the EHT STA, the response may be performed by using the EHT TB PPDU.

That is, in an embodiment of FIG. 13, the TB PPDU format of the STA responding to the trigger frame or the TRS is limited, and accordingly the trigger frame or the TRS are scheduled, so that the problem described in FIG. 10 and FIG. 11 may be solved.

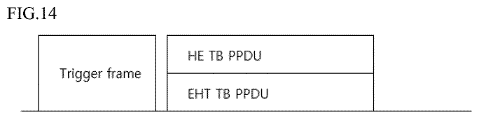

FIG. 14 illustrates an UL MU operation according to another embodiment of the present disclosure.

Referring to FIG. 14, an access point (AP) may transmit one trigger frame to indicate transmission of the PPDU of each different format to one or more non-AP STAs.

Specifically, a method described in FIG. 14 may be the method for solving the problem described in FIG. 10 and FIG. 11, and may be an exceptional case of the method described in FIG. 13. A method of FIG. 14 may be an exceptional case of the method of transmitting the trigger frame or the TRS which is the method described in FIG. 13. Hereinafter, since the contents described above may be identically applied to the method, the description thereof may be omitted.

In case of indicating the associated PPDU (aggregated PPDU), it is possible that the AP indicates transmission of the PPDU to all of the HE STA, the EHT STA and/or the NEXT STA. At this time, the HE TB PPDU, the EHT TB PPDU and/or the NEXT TB PPDU transmitted as the response may be scheduled so as not to be transmitted while overlapping each other in the frequency area. Otherwise, 20 MHz sub channels including the RUs which is a resource unit of the HE TB PPDU and 20 MHz sub channels including the RUs of the EHT TB PPDU may be allocated not to overlap each other

When the HE PPDU is included in the associated PPDU, the HE PPDU may exist in an area including the primary channel, but when the associated PPDU is the TB PPDU, the HE PPDU may exist in an area which does not include the primary channel.

Referring to FIG. 14, in response to one trigger frame, the HE TB PPDU and the EHT TB PPDU may be transmitted from the plurality of STAs. In addition, at this time, the HE TB PPDU and the EHT TB PPDU may be transmitted through the RUs which do not overlap each other. That is, transmission of the TB PPDU of the different formats may be indicated by the plurality of STAs through one trigger frame, and the RU for the transmission of the TB PPDU of the different formats may not overlap each other. Therefore, the plurality of STAs may transmit the PPDU of the different formats (for example, the HE TB PPDU and the EHT TB PPDU) by using the different RUs on the frequency axis, on the basis of the transmitted trigger frame.

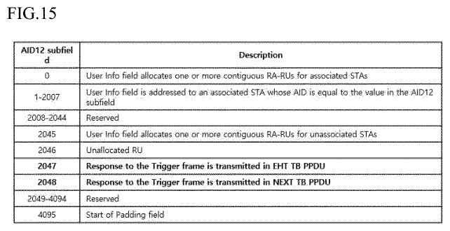

FIG. 15 illustrates a method for indicating a trigger-based PPDU format according to an embodiment of the present disclosure.

Referring to FIG. 15, one STA may selectively transmit the PPDU of the different formats by being indicated by the triggering frame indicating transmission of the PPDU.

Specifically, the EHT STA may selectively transmit the EHT TB PPDU as well as the legacy PPDU (for example, HE TB PPDU), and the NEXT STA may selectively transmit the HE TB PPDU, the EHT TB PPDU and/or the NEXT TB PPDU. In this case, the STAs to which various standards are applied, respectively, may be individually scheduled by one frame or one PPDU. In the wireless LAN, since common resource is used together with the STAs to which various standards are applied, the method may be an advantage. For example, the HE STA (HE STA other than EHT STA) and the EHT STA may respond by using the HE TB PPDU through one frame. That is, the non-AP STA may transmit the triggering frame to indicate transmission of the HE TB PPDU to the EHT STA as well as the HE STA.

In addition, information for selecting the TB PPDU format may be included in the PPDU including the trigger frame which is the triggering frame, the TRS, the trigger frame or the PPDU including the TRS control subfield. That is, information for selecting the format of the TB PPDU is included in the triggering frame to transmit the same to at least one non-AP STA by the AP STA, and the non-AP STA may select the format of the PPDU to respond based on information included in the transmitted triggering frame. Hereinafter, at least one non-AP STA may transmit the PPDU to the AP on the basis of the selected format.

Information about the format (TB PPDU format) of the PPDU which is the response to the triggering frame may exist in the MAC level, the trigger frame, which is one of the triggering frame, may be divided into the HE trigger frame, the EHT trigger frame, and the NEST trigger frame, and the response to each trigger frame may be divided from the HE TB PPDU, the EHT TB PPDU and the NEXT TB PPDU.

In addition, the dividing the trigger frame into the HE trigger frame, the EHT trigger frame, and the NEXT trigger frame may be the same meaning as the dividing the TB PPDU format which is the response to the trigger frame from the HE TB PPDU, the EHT TB PPDU, and the NEXT TB PPDU.

Whether the format of the trigger frame for dividing the format of the TB PPDU is the HE trigger frame, the EHT trigger frame, or the NEXT trigger frame may be identified based on a frame control field included in the MAC header. Specifically, the format of the trigger frame may be divided based on the type subfield, the subtype subfield and/or a control frame extension subfield. In addition, when the value of the type subfield, the subtype subfield and/or the control frame extension subfield is a preconfigured value, the trigger frame may be identified as the HE trigger frame, and when the value thereof is the other preconfigured value, the trigger frame may be identified as the EHT trigger frame. In addition, when the value of the type subfield, the subtype subfield and/or the control frame extension subfield is the other preconfigured value, the trigger frame may be identified as the NEXT trigger frame.

For example, when the type subfield is 01 (B3, B2) and the subtype subfield is 0010 (B7, B6, B5, B4), the frame format including the type subfield and the subtype subfield may be the HE trigger frame. In this case, the entries of the type subfield (2 bits), the subtype subfield (4 bits), and/or the control frame extension subfield (4 bits), to which the limited bit number is allocated, should be additionally used in the EHT standard and the NEXT sanded.

In addition, whether the format of the trigger frame is the HE trigger frame or the EHT trigger frame may be identified based on the common information field included in the trigger frame. That is, a format of the PPDU transmitted in response to the trigger frame may be determined based on the value of the specific subfield (the first subfield) included in the common information field. For example, the non-AP STA may select the HE TB PPDU or the EHT TB PPDU according to the value of the common information field and may transmit the same through the allocated RU. At this time, the specific subfield (the second subfield) of the user information field as well as the common information field may be additionally used for identifying the format of the PPDU.

That is, a variant for determining the format of the PPDU which is the response to the trigger frame may be determined based on the common information field of the trigger frame, and the format of the PPDU may be determined according to the determined variant. For example, when the variant for determining the format of the PPDU is determined as the HE variant by the common information field, the non-AP STA may respond by using the HE TB PPDU, and when the variant for determining the format of the PPDU is determined as the EHT variant by the common information field, the non-AP STA may respond by using the EHT TB PPDU.

At this time, the variant for determining the format of the PPDU may additionally use the user information field as well as the common information field.

For example, whether the trigger frame is the HE trigger frame, the EHT trigger frame, or the NEXT trigger frame may be determined based on the trigger type subfield. For example, when the trigger type subfield value is a preconfigured value, the trigger frame may be the HE trigger frame. In addition, when the trigger type subfield value is a preconfigured value, the trigger frame may be the EHT trigger frame. When the trigger type subfield value is a preconfigured value, the trigger frame may be the NEXT trigger frame.

For example, when the trigger type subfield value is 0 to 7, the trigger frame may be the HE trigger frame, and when the value thereof is not 0 to 7, the trigger frame may be the EHT trigger frame or the NEXT trigger frame. The trigger type subfield indicates various kinds of the trigger frame types, and at this time, the disadvantage that the limited trigger type subfield space should be used may exist.

According to another embodiment, whether the trigger frame is the HE trigger frame, the EHT trigger frame, or the NEXT trigger frame may be determined based on the UL length subfield of the trigger frame. For example, whether the trigger frame is the HE trigger frame, the EHT trigger frame, or the NEXT trigger frame may be determined based on mod (remainder) operation value of the UL length subfield value. That is, whether the format of the PPDU to be transmitted in response to the trigger frame is the HE PPDU or the EHT PPDU may be determined by using the value of the UL length subfield.

More particularly, whether the trigger frame is the HE trigger frame, the EHT trigger frame, or the NEXT trigger frame may be determined based on mod (remainder) 3 operation value (remainder when dividing the UL length subfield by 3) of the UL length subfield. For example, when the UL length subfield value mod 3 is not 0, the trigger frame may be the HE trigger frame. In addition, the UL length subfield value mod 3 is 1, the trigger frame may be the HE trigger frame. In addition, when the UL length subfield value mod 3 is 0, the trigger frame may not be the HE trigger frame. In addition, when the UL length subfield value mod 3 is 0, the trigger frame may be the EHT trigger frame or the NEXT trigger frame.

That is, when a value obtained by applying a mod 3 operation to a value of a UL length subfield of a trigger fame is not 0, a response to the trigger frame may be transmitted using a HE TB PPDU, and when a value obtained by applying a mod 3 operation to a value of a UL length subfield is 1, a response to the trigger frame may be transmitted using a HE TB PPDU.

In addition, when the UL length subfield value of the trigger frame mod 3 is 0, the format of the PPDU transmitted in response to the trigger frame may be the EHT TB PPDU.

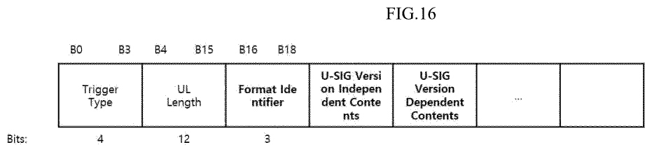

In addition, it is possible to divide the HE trigger frame, the EHT trigger frame, and the NEXT trigger frame by using the methods together with the additional trigger frame discrimination method. For example, it is possible to divide the HE trigger frame, the EHT trigger frame, and the NEXT trigger frame by using the discrimination method illustrated in FIG. 16 together.

According to an embodiment, whether the format of the trigger frame is the HE trigger frame, the EHT trigger frame, or the NEXT trigger frame may be determined based on the user information field (user info field) of the trigger frame.

That is, whether the format of the trigger frame is the HE trigger frame or the EHT trigger frame may be identified based on the user information field included in the trigger frame, similarly to the common information field as described above. That is, the format of the PPDU to be transmitted in response to the trigger frame may be determined based on the value of a specific field (the second subfield) included in the user information field. For example, the non-AP STA may select the HE TB PPDU or the EHT TB PPDU and transmit the same through the allocated RU according to the value of the user information field. At this time, a specific field (the first subfield) of the common information field as well as the user information field may be additionally used for identifying the format of the PPDU.

That is, the variant for determining the format of the PPDU which is the response to the trigger frame may be determined based on the user information field of the trigger frame, and the format of the PPDU may be determined according to the determined variant. For example, when the variant for determining the format of the PPDU is determined as the HE variant by the user information field, the non-AP STA may respond by using the HE TB PPDU, and when the variant for determining the format of the PPDU is determined as the EHT variant by the user information field, the non-AP STA may respond by using the EHT TB PPDU.

At this time, the variant for determining the format of the PPDU may additionally use the common information field as well as the user information field.

For example, whether the variant corresponds to the HE trigger frame, the EHT trigger frame, or the NEXT trigger frame may be determined based on the AID12 subfield. According to an embodiment, whether the variant corresponds to the HE trigger frame, the EHT trigger frame, or the NEXT trigger frame may be determined according to whether to include the AID12 subfield of the preconfigured value. Further, in this case, whether an STA indicated by a certain user information field is required to continuously identify an AID12 subfield existing after the certain user information field in order to determine the trigger frame format may be a problem. In order to solve this problem, a user information field including an AID12 subfield indicating the type of the trigger frame may be located at the front side of the user information list. In addition, in order to prevent an erroneous operation of an HE STA which does not understand such a signaling method, a user information field including an AID12 subfield indicating a type of a trigger frame may be located behind the user information field corresponding to the HE STA.

In addition, since information of the other subfield excluding the AID12 subfield included in the user information field is not necessary to the TB PPDU response, subfields of a user information field including an AID12 subfield indicating a type of a trigger frame is may be omitted. That is, the length of the user information field may differ based on the AID12 subfield. Referring to FIG. 15, the AID12 subfield may play a role of indicating the responding TB PPDU format. For example, when the AID12 subfield is a preconfigured value, the response to the trigger frame including the AID12 subfield configured by the preconfigured value may be the EHT TB PPDU. For example, when the AID12 subfield value is 2047, the response to the trigger frame including the AID12 subfield may be the EHT TB PPDU. In addition, when the AID12 subfield is a preconfigured value, the response to the trigger frame including the AID12 subfield configured by the preconfigured value may be the NEXT TB PPDU. For example, when the AID12 subfield value is 2048, the response to the trigger frame including the AID12 subfield may be the NEXT TB PPDU.

According to another embodiment, when a response is performed based on the user information field existing in a location preconfigured by the AID12 subfield of the preconfigured value, the response may be performed by the TB PPDU format corresponding to the preconfigured value. For example, when the response is performed based on the user information field existing after the AID12 subfield of the preconfigured value, the response may be performed by the TB PPDU format corresponding to the preconfigured value. When a plurality of values indicating the TB PPDU format exist and the response is performed based on the user information field exiting after both of a preconfigured value 1 and a preconfigured value 2, the response may be performed by the TB PPDU format according to the preconfigured priority among the TB PPDU formats corresponding to the preconfigured value 1 and the TB PPDU format corresponding to the preconfigured value 2. Referring to FIG. 15, when the response is performed based on the user information field existing after the AID12 subfield configured as 2047, the response may be performed by using the EHT TB PPDU. In addition, when the response is performed based on the user information field existing after the AID12 subfield configured as 2048, the response may be performed by using the NEXT TB PPDU. In addition, when the response is performed based on the user information field existing after both the AID12 subfield configured as 2047 and the AID12 subfield configured as 2048, the response may be performed by using the NEXT TB PPDU. In addition, when the response is performed based on the user information field existing before both the AID12 subfield configured as 2047 and the AID12 subfield configured as 2048, the response may be performed by using the HE TB PPDU.

In an embodiment, an example indicating the type of the trigger frame by the AID12 subfield is descried, but the present disclosure is not limited thereto and it is possible to indicate the type of the trigger frame through another subfield of the user information field.

According to an embodiment, the HE trigger frame, the EHT trigger frame, and the NEXT trigger frame may be divided based on the padding field of the trigger frame. For example, the HE trigger frame, the EHT trigger frame, and the NEXT trigger frame may be determined according to whether a preconfigured value indicating whether the padding field is the HE trigger frame, the EHT trigger frame, or the NEXT trigger frame is included.

According to an embodiment of the present disclosure, it is possible to divide the HE trigger frame, the EHT trigger frame, and the NEXT trigger frame by combining the discrimination method of the plurality of trigger frames illustrated in the present disclosure. In addition, the description related to the trigger frame may be not limited thereto, and may be applied to the TRS.

According to another embodiment of the present disclosure, the AP may be unable to indicate transmission of the EHT PPDU and the HE PPDU together through the triggering frame. That is, the EHT AP fails to transmit the trigger frame indicating the HE TB PPDU and the EHT TB PPDU together, and may indicate only one PPDU format.

FIG. 16 illustrates a trigger frame format for indicating a trigger-based PPDU format according to an embodiment of the present disclosure.

Referring to FIG. 16, the trigger frame may include information indicating the format of the PPDU to be transmitted in response to the trigger frame and the format of the trigger frame, and the length and the contents included in the trigger frame may vary according to the indicated PPDU format.

Specifically, the trigger frame may include information indicating the format of the trigger frame. That is, the trigger frame may include information indicating whether the trigger frame is the HE trigger frame, the EHT trigger frame, or the NEXT trigger frame. Therefore, information for determining the format of the PPDU indicated by the trigger frame may be included.

In addition, it is possible that the length and the contents of the trigger frame varies based on information indicating the format, and the trigger frame may include information indicating which one among the HE TB PPDU, the EHT TB PPDU, and the NEXT TB PPDU is transmitted in response to the trigger frame. For example, the information indicating the format of the trigger frame or the information indicating the TB PPDU format in response to the trigger frame as described above may be included in an identifier subfield.

Therefore, it is possible to determine the format of the trigger frame on the basis of the format identifier subfield. In addition, it is possible to determine the TB PPDU format which responds based on the format identifier subfield. That is, it is possible to respond by using the TB PPDU of the standard corresponding to the value indicated by the format identifier subfield. According to an embodiment, the format identifier subfield may be 3-bit. In addition, the format identifier subfield may exist after B16 of the common information field.

For example, the format identifier subfield may exist after the UL length subfield. In addition, the trigger frame illustrated in FIG. 12 may be a format understood by the HE STA, so that the format identifier subfield may exist in the trigger frame after the EHT standard. That is, when the trigger frame includes the format identifier subfield, the trigger frame may be the EHT trigger frame or the NEXT trigger frame. Otherwise, when the trigger frame includes the format identifier subfield, the TB PPDU responding to the trigger frame may be the EHT TB PPDU or the NEXT TB PPDU. In addition, in this case, the values indicated by the format identifier subfield may be included in a field after the EHT standard.

According to an embodiment, it is possible that the U-SIG field included in the TB PPDU may be based on the PPDU indicating the TB PPDU. According to an embodiment, it is possible that the U-SIG field included in the TB PPDU may be based on the trigger frame indicating the TB PPDU. More specifically, it is possible that the U-SIG field included in the TB PPDU may be based on the format identifier subfield included in the trigger frame indicating the TB PPDU.

For example, it is possible that the PHY version identifier of the U-SIG field included in the TB PPDU may be based on the format identifier subfield included in the trigger frame indicating the TB PPDU. The PHY version identifier may indicate the PHY version of the PPDU transmitted by the non-AP STA or the AP. For example, it means that when the value of the PHY version identifier is configured as “0”, the corresponding PPDU is the EHT PPDU in which the PHY version is the EHT.

The PHY version identifier may be used for identifying whether the format of the PPDU is the EHT PPDU and may be configured based on the format identifier included in the trigger frame. For example, the non-AP STA may configure the value of the PHY version field included in the PPDU which is the same as the value of the format identifier included in the trigger frame. Therefore, the non-AP STA may determine whether the format of the PPDU to be transmitted based on the value of the format identifier included in the trigger frame is the EHT TB PPDU.

For example, the PHT version identifier value of the U-SIG field included in the TB PPDU may be configured as the same value as the format identifier subfield included in the trigger frame indicating the TB PPDU. Otherwise, when the standard ranges indicated by the PHT version identifier subfield of the U-SIG field and the format identifier subfield of the trigger frame are different from each other, the PHY version identifier value of the U-SIG field included in the TB PPDU may be configured as the value of adding or subtracting the preconfigured value to or from the format identifier subfield value included in the trigger frame indicating the TB PPDU.

The PHY version identifier subfield of the U-SIG field may be the PHY version field as described above. In addition, the PHY version identifier subfield of the U-SIG field may play a role of indicating the format of the U-SIG field. In addition, the PHY version identifier subfield of the U-SIG field may play a role of indicating the PHY version of the PPDU including the U-SIG field.

Referring to FIG. 16, the trigger frame may include the format identifier subfield. In addition, a standard which the trigger frame employs or a TB PPDU format which is to be used for a response to the trigger frame may be determined based on the format identifier subfield.

In addition, it is possible that the trigger frame includes information included in the U-SIG field of the TB PPDU responding to the trigger frame. For example, the trigger frame may include information to be included in the version independent field and the version dependent field of the U-SIG field. Information to be included in the U-SIG field may include information to be included in the version independent field and the version dependent field.

Information to be included in the version independent field of the U-SIG field may be the U-SIG version independent contents. Information to be included in the version dependent field of the U-SIG field may be the U-SIG version dependent contents. In addition, the format identifier subfield described above may be one among the U-SIG version independent contents. According to an embodiment of the present disclosure, it is possible that the contents and the length to be included in the U-SIG field of the TB PPDU included in the trigger frame vary based on the format identifier subfield included in the trigger frame. For example, it is possible that the length and the contents of the U-SIG version dependent contents of the TB PPDU included in the trigger frame vary based on the format identifier subfield included in the trigger frame. For example, the U-SIG version independent contents may be a subfield having the length and the contents regardless of the format identifier subfield, and the U-SIG version dependent contents may be a subfield having the length and the contents based on the format identifier subfield. According to an embodiment, it is possible that information to be included in the U-SIG field may be included in the common information field of the trigger frame. In addition, the U-SIG version dependent contents included in the trigger frame may include the BW, and puncturing information, and the like.

Referring to FIG. 16, the trigger frame may include the U-SIG version independent contents and the U-SIG version dependent contents. In addition, it is possible that the length and the contents of the U-SIG version independent contents or the U-SIG version dependent contents vary based on the format identifier subfield.

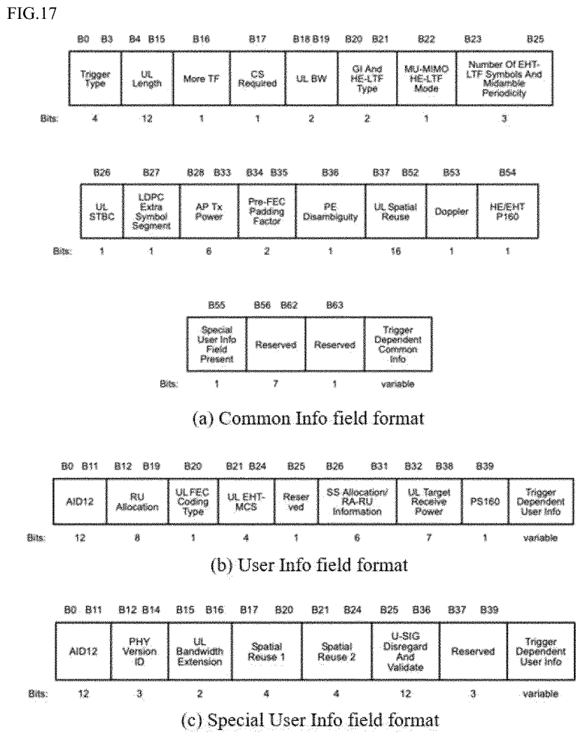

FIG. 17 illustrates a trigger frame format for indicating a trigger-based PPDU format according to another embodiment of the present disclosure.

Referring to FIG. 17, the STA may determine the format of the PPDU to be transmitted on the basis of the subfields included in the common information field and/or the user information field included in the triggering frame.

Specifically, part (a) of FIG. 17 illustrates an example of a common information field included in a trigger frame, and part (b) of FIG. 17 illustrates an example of a user information field. Part (c) of FIG. 17 illustrates an example of a specific user information field (special user information field).

The description of the fields which are the same as the fields described above among the fields illustrated in FIG. 17A to FIG. 17C may be omitted.

The common information field of FIG. 17A may be used for identifying the format of the PPDU indicated by the trigger frame as described above. For example, the common information field of the trigger frame may be used for identifying whether the format of the PPDU indicated by the trigger frame is the EHT TB PPDU or the HE TB PPDU.

Specifically, the HF/EHT P160 subfield (the first subfield) in the common information field illustrated in FIG. 17A may indicate the format of the PPDU transmitted from the primary channel of 160 MHz. For example, when the value of the HE/EHT P160 subfield is “1”, transmission of the HE TB PPDU is indicated from the primary channel of 160 MHz, and when the value thereof is “0”, transmission of the EHT TB PPDU is indicated from the primary channel of 160 MHz.

The user information field of FIG. 17B may be used for identifying the format of the PPDU indicated by the trigger frame as described above.

Specifically, PS160 subfield (the second subfield) in the user information field illustrated in FIG. 17B may indicate a location where the RU allocated by the RU allocation field of the user information field is located among the primary channel or the second channel of 160 MHz.

PS160 subfield may be used for indicating the format of the PPDU indicated by the trigger frame together with the HE/EHT P160 subfield of FIG. 17A. For example, in case that the value of the HE/EHT P160 subfield is configured as “1” and the transmission of the HE TB PPDU is indicated from the primary channel, when the value of the PS160 subfield is configured as “0”, since it indicates that the RU is allocated to the primary channel, the STA may transmit the response to the trigger frame by using the HE TB PPDU from the primary channel.

However, in case that the value of the HE/EHT P160 subfield is configured as “1” and the transmission of the HE TB PPDU is indicated from the primary channel, when the value of the PS160 subfield is configured as “1”, since it indicates that the RU is allocated to the secondary channel, the STA may transmit the PPDU from the secondary channel and at this time, the format of the PPDU is the EHT TB PPDU.

Hereinafter, the table 1 shows an example of the format of the PPDU according to the HE/EHT P160 subfield and the PS160 subfield.

[Table 1]

TABLE 1

| | | | Presence | | |
|---|---|---|---|---|---|
| | | | of | | |
| | | User | Special | | |
| Common | Common | Info | User | | TB |
| Info field | Info field | field | Info | User Info | PPDU |
| B54 | B55 | B39 | field | field variant | type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HB |

Referring to Table 1, B54 bit of the common information field indicates the value of the HE/EHT P160 subfield, and B39 bit indicates the value of PS160 subfield. The variant for determining the format of the PPDU according to the value of the HE/EHT P160 subfield and the value of the PS160 subfield is determined, and whether the type of the PPDU is the HE or the EHT is determined according to the determined variant.

The STA determines whether the format of the PPDU to be transmitted in response to the trigger frame is the EHT or the HE, by using the common information field and/or the user information field included in the trigger frame, generates the PPDU according to the determined format, and transmits the same to the AP.

FIG. 17C illustrates an example of the specific user information field including the PHY version identifier described above, and the PHY version identifier is used for identifying whether the PHT version is the EHT as described above. In addition, the PHT version identifier may be configured based on the format indicator of the trigger frame.

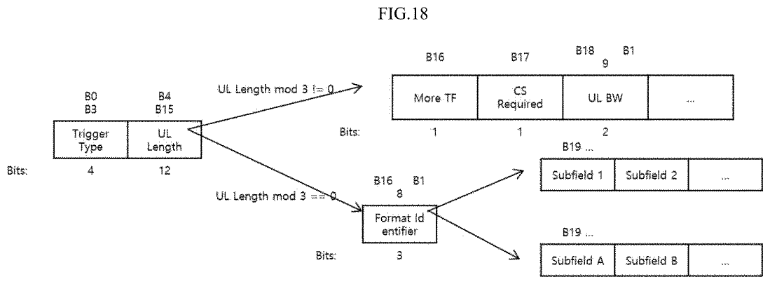

FIG. 18 illustrates a determination method of a trigger frame format according to an embodiment of the present disclosure.

FIG. 18 may be used by combining the embodiments described in FIG. 15 to FIG. 17 as described above, and the contents described above are omitted.

Specifically, as described in FIG. 16, the trigger frame may include the format indicator subfield. In addition, the trigger frame or the HE trigger frame described in FIG. 12 may not include the format indicator subfield. Therefore, a method for determining whether the trigger frame includes the format indicator subfield may be necessary. According to an embodiment, the trigger frame may include information indicating whether to include the format indicator subfield. For example, the common information field of the trigger frame may include information indicating whether to include the format indicator subfield. More specifically, the trigger type subfield of the trigger frame may include information indicating whether to include the format indicator subfield. For example, whether the format indicator subfield is included may be determined according to whether the trigger type subfield is the preconfigured value. For example, when the trigger type subfield has the value of 0 to 7, the format indicator subfield may not be included. In addition, when the trigger type subfield does not have the value of 0 to 7 or the trigger type subfield has the value of 8 to 15, the format indicator subfield may be included. In addition, in case that the trigger type subfield has the value of 0 to 7, a basic, a beamforming report poll (BFRP), a MU-BAR, a MU-RTS, a buffer status report poll (BSRP), a GCR MU-BAR, a bandwidth query report poll (BQRP), a NDP feedback report poll (NFRP) may be indicated. In this case, in case that the trigger type subfield has 8 to 15 value, the trigger frame type in case of the trigger type subfield having 0 to 7 value may be indicated, but may indicate that the trigger frame format does not include the format indicator subfield.

According to another embodiment, whether to include the format indicator subfield may be determined based on the UL length subfield of the trigger frame. For example, whether to include the format indicator subfield may be determined according to the trigger frame discrimination method based on the UL length subfield illustrated in FIG. 15. That is, whether to include the format indicator subfield may be determined based on the operation result of the UL length subfield value mod, more specifically, the result of the UL length subfield value mod 3.

For example, when the UL length subfield value mod 3 is not 0, the format indicator subfield may be not included, and when the mod 3 operation result thereof is 0, the format indicator subfield may be included, which may be connected to the previous embodiment in which the EHT trigger frame and the NEXT trigger frame includes the format indicator subfield, and the previous embodiment determining whether the trigger frame is the HE trigger frame on the basis of the result of the mod 3 operation of the UL length subfield value.

Referring to FIG. 18, whether the trigger frame is the HE trigger frame or whether the trigger frame includes the format indicator subfield may be determined based on the UL length subfield included in the trigger frame. For example, when the UL Length subfield value mod 3 is not 0, the trigger frame is the trigger frame (or HE trigger frame) having the common information field and the user information field described in FIG. 12, and determines not to include the format indicator subfield. In addition, when the response to the trigger frame is performed, the response may be performed by using the HE TB PPDU.

In addition, when the UL Length subfield value mod 3 is 0, it is determined that the trigger frame is the EHT trigger frame or the NEXT trigger frame and includes the format indicator subfield. In addition, remaining information (i.e., the common information field and the user information field) including the trigger frame may be determined based on the value indicated by the format indicator subfield. In addition, when the response to the trigger frame is performed, the response may be performed by using the TB PPDU of the standard indicated by the format indicator subfield. That is, when the format indicator subfield indicates the EHT standard, the response may be performed by using the EHT TB PPDU. In addition, when the format indicator subfield indicates the NEXT standard, the response may be performed by using the NEXT TB PPDU.

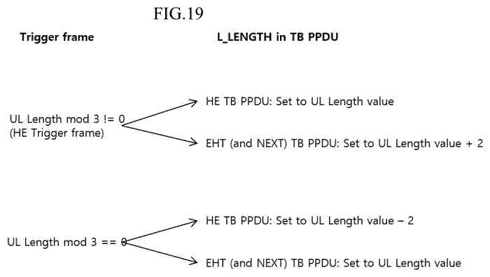

FIG. 19 illustrates a configuration method of a length field according to an embodiment of the present disclosure. The contents described in FIG. 15 to FIG. 18 in the embodiments of FIG. 19 may be omitted.

Referring to FIG. 19, the PPDU transmitted in response to the trigger frame may include the length fields having different values according to the format.

Specifically, the trigger frame may include the UL length subfield and the UL length subfield may indicate information regarding the length of the PPDU indicated by the trigger frame. For example, the UL length subfield may indicate information regarding the value of the length field included in the L-SIG field of the PPDU transmitted in response to the trigger frame. The length field included in the L-SIG field may be a length or duration information included in the legacy preamble. The length field included in the L-SIG field may be indicated as the L_LENGTH or the LENGTH, which is configured by the transmission parameter or the receipt parameter value.

According to an embodiment of the present disclosure, a method of configuring the length field included in the L-SIG field of the TB PPDU by using the UL length subfield included in the trigger frame may vary according to the format of the TB PPDU transmitted in response to the trigger frame. In addition, according to an embodiment of the present disclosure, a method of configuring the length field included in the L-SIG field of the TB PPDU by using the UL length subfield included in the trigger frame may vary according to the format of the trigger frame. In addition, according to an embodiment of the present disclosure, a method of configuring the length field included in the L-SIG field of the TB PPDU by using the UL length subfield included in the trigger frame may vary according to the value based on the value of the UL length field of the trigger frame.

As described above, the case that the UL length subfield value included in the trigger frame mod 3 which is a modular operation is not 0 exists, and the response by using the HE TB PPDU, the EHT TB PPDU or the NEXT TB PPDU is possible based on the basis of the trigger frame.

In case that the UL length subfield value included in the trigger frame mod 3 is not 0, when the HE TB PPDU is transmitted in response to the trigger frame, the length field of the L-SIG field included in the HE TB PPDU may be configured as the same value as the value of the UL length subfield of the trigger frame, which is for configuring the length subfield value included in the L-SIG field of the HE TB PPDU mod 3 not to be 0 (for example, 1).

In addition, the case that the UL length subfield value included in the trigger frame mod 3 is not 0, when the EHT TB PPDU or the NEXT TB PPDU is transmitted in response to the trigger frame, the length field of the L-SIG field included in the HE TB PPDU may be configured as the value which is a value of adding the preconfigured value to the value of the UL length subfield of the trigger frame. At this time, the preconfigured value may be 2 or −1, which is for configuring the length field value included in the L-SIG field of the HE TB PPDU mod 3 to be 0.

That is, when the format of the PPDU indicated by the trigger frame is the HE TB PPDU and the non-AP STA transmits the HE TB PPDU in response to the trigger frame, the value of the L_LENGTH parameter which is the value of the length field included in the L_SIG field of the TB PPDU may be configured as the value indicated by the UL length subfield included in the common information field of the trigger frame.

However, when the format of the PPDU indicated by the trigger frame is the EHT TB PPDU or the NEXT TB PPDU and the non-AP STA transmits the EHT TB PPDU or the NEXT TB PPDU in response to the trigger frame, the value of the L_LENGTH parameter which is the value of the length field included in the L-SIG field of the TB PPDU may be configured as a value of adding the preconfigured value (for example, 2 or −1) to the value of the transmission parameter L_LENGTH parameter which is the value indicated by the UL length subfield included in the common information field of the trigger frame.

At this time, the length which is the L_LENGTH value may be calculated by the equation 4 below.

[Equation 4]

| Common | Common | User | Presence of | User | TB |
|---|---|---|---|---|---|
| Info field | Info field | Info field | Special User | Info field | PPDU |
| B54 | B55 | B39 | Info field | variant | type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

As described above, the case that the UL length subfield value included in the trigger frame mod 3 is 0 may exist. In addition, as described above, the response by using the HE TB PPDU, the EHT TB PPDU, or the NEXT TB PPDU is possible based on the trigger frame.

When the UL length subfield value included in the trigger frame mod 3 is 0, in case that the response is performed by using the HE TB PPDU, it is possible to configure the length field included in the L-SIG field included in the HE TB PPDU as the value of adding the preconfigured value to the UL length subfield value. For example, the preconfigured value may be (−2), and this value may be a value used to obtain, as a result of a mod 3 operation of the length subfield value included in the L-SIG field of the HE TB PPDU, a value other than 0, for example, a value of 1. In another embodiment, the preconfigured value may be 1.

When the UL length subfield value included in the trigger frame mod 3 is 0, in case that the response is performed by using the EHT TB PPDU or the NEXT TB PPDU, it is possible to configure the length field included in the L-SIG field included in the EHT TB PPDU or the NEXT TB PPDU as the same value as the value of the UL length subfield, and this value may be a value used to obtain, as a result of a mod 3 operation of the length field included in the L-SIG field of the EHT TB PPDU or the NEXT TB PPDU, a value of 0.

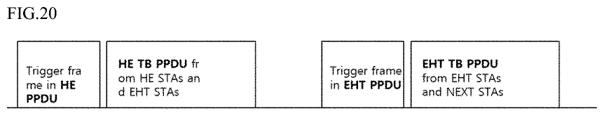

FIG. 20 illustrates an UL MU operation according to another embodiment of the present disclosure.

An embodiment of FIG. 20 may be a method for solving the problem described in FIG. 10 to FIG. 11. In addition, an embodiment of FIG. 20 may describe another method for dividing the trigger frame of the embodiments described in FIG. 15. In addition, the description described above may be omitted.

According to an embodiment of the present disclosure, it is possible to selectively transmit the HE TB PPDU and the EHT TB PPDU by the EHT STA. In addition, it is possible to selectively transmit the HE TB PPDU, the EHT TB PPDU, and the NEXT TB PPDU by the NEXT STA. In this case, there is an advantage to schedule the STAs of the multiple standards by one frame or one PPDU. The STAs of the multiple standards use the common resources together in the wireless LAN, and it may be an advantage. For example, it is possible that the HE STA (HE STA other than EHT) and the EHT STA respond by using the HE TB PPDU through one frame.

In addition, information for selecting the TB PPDU format may be included in the trigger frame, the PPDU including the TRS or the trigger frame, or the PPDU including the TRS.

According to an embodiment of the present disclosure, information about the responding TB PPDU format may exist in the PHY level. According to an embodiment of the present disclosure, the HE trigger frame, the EHT trigger frame, and the NEXT trigger frame may be divided. In addition, the response indicated by the HE trigger frame, the EHT trigger frame, and the NEXT trigger frame may respond by using the HE TB PPDU, the EHT TB PPDU, and the NEXT TB PPDU, respectively.

In addition, in the present disclosure, the dividing the HE trigger frame, the EHT trigger frame, or the NEXT trigger frame may be the same meaning as the dividing the TB PPDU format to respond to the trigger frame into the HE TB PPDU, the EHT TB PPDU, and the NEXT TB PPDU, respectively.

According to an embodiment of the present disclosure, the TB PPDU format responding to the trigger frame may be determined based on the PPDU format including the trigger frame. For example, it is possible to respond to the frame by the TB PPDU of the standard which is the same as the PPDU format including the trigger frame. Referring to the FIG. 19, when the trigger frame is transmitted through the HE PPDU, the TB PPDU responding to the trigger frame may be the HE TB PPDU. In this case, when the trigger frame indicates the EHT STA and the NEXT STA, the response may be performed by using the HE TB PPDU. When the trigger frame is transmitted through the EHT PPDU, the TB PPDU responding to the trigger frame may be the EHT TB PPDU. In this case, when the trigger frame indicates the NEXT STA, the response may be performed by using the EHT TB PPDU.

In addition, when responding to the trigger frame included in the EHT PPDU or the NEXT PPDU, the PHY version identifier included in the U-SIG field of the TB PPDU responding to the EHT PPDU or the NEXT PPDU may be configured as the same value as the PHY version identifier included in the U-SIG field of the EHT PPDU or the NEXT PPDU. In addition, the PHY version identifier included in the U-SIG field of the EHT PPDU or the NEXT PPDU is an RXVECTOR which is a receiving parameter and may be transmitted to the MAC from the PHY of the STA receiving the EHT PPDU or the NEXT PPDU. In addition, the PHY version identifier included in the U-SIG field of the TB PPDU responding to the EHT PPDU or the NEXT PPDU is a TXVECTOR and may be transmitted to the PHY from the MAC of the STA transmitting the TB PPDU. That is, the TXVEXTOR PHY version identifier of the STA responding to the TB PPDU may be configured as the value of an RXVECTOR PHY version identifier when receiving the PPDU including the trigger frame indicating the TB PPDU.

According to an embodiment, it is possible to use the MAC level discrimination method described in FIG. 15 together with the PHY level discrimination method described in FIG. 20. For example, when the trigger frame is transmitted to the non-HT (duplicate) PPDU, the MAC level discrimination method may be used. In addition, when the results of the MAC level discrimination method and the PHY level discrimination method (standard for the trigger frame or standard used for responding by the TB PPDU) are not identical to each other, a preconfigured priority may be used.

For example, when the results of the MAC level discrimination method and the PHY level discrimination method do not match, the discrimination method of the PHY level may be used. For example, when the EHT trigger frame is transmitted through the HE PPDU, the response can be performed by using the HE TB PPDU. Therefore, there is an advantage that the HE STA which does not decode the later standard and the PPDU of the later standard may decode the PPDU and may confirm the preamble, and the PPDU or the frame may be properly protected by receiving the frame included in the PPDU.

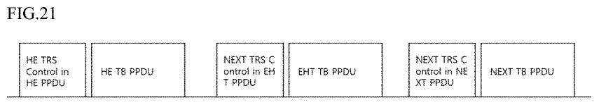

FIG. 21 illustrates an UL MU operation according to another embodiment of the present disclosure.

As described above, the TB PPDU may be indicated through the TRS as well as the trigger frame. In addition, the TRS may be included in the HT control field as described above. For example, it is possible that the HT control field includes the TRS when including an A-control field. It is possible that the TRS is transmitted by the TRS control subfield. The A-control field may be a type in which the control list fields are continuously connected. In addition, the control list field may include the TRS.

In addition, the receiver of the frame including the TRS (intended receiver) can respond to the TRS. For example, the STA corresponding to the RA included in the frame including the TRS can respond to the TRS. The TRS may include information about the length of the frame or the PPDU responding to the TRS (UL Data systems), the location and the size of RU used when responding to the TRS (RU Allocation), information about the power when responding to the TRS (AP Tx Power and UL Target RSSI), and information about a modulation method when responding to the TRS (UL HE-MCS).

An embodiment of FIG. 21 may be a method for solving the problem illustrated in FIG. 10 to FIG. 11. In addition, as described above, the embodiment for the trigger frame may be applied to the TRS. In addition, the contents described above may be omitted.

According to an embodiment of the present disclosure, it is possible that the TRS (each of EHT TRS and NEXT TRS) defined in the EHT standard or the NEXT standard exists in addition to the TRS (HE TRS) defined in the HE standard. Therefore, the TB PPDU responding to the TRS may be the HE TB PPDU, the EHT TB PPDU, or the NEXT TB PPDU according to whether the indicated TRS is the HE TRS, the EHT TRS, or the NEXT TRS. For example, it is possible to determine which standard defines the TRS through the control ID subfield of an A-control subfield. In the additional embodiment, the TRS may be divided into two TRSs, other than the HE TRS and the HE TRS.

Otherwise, which standard defines the TRS may be determined according to whether the HT control field is the HE variant, the EHT variant, or the NEXT variant. In addition, whether the HT control field is the HE variant, the EHT variant, or the NEXT variant may be determined according to the value of the preconfigured bit of the HT control field. For example, the case that B0, B1 of the HT control field is 1, 1 may be the HE variant. In addition, whether the HT control field is the HE variant, the EHT variant or the NEXT variant may be determined by using the additional bit (for example, B31) with B0, B1 of the HT control field.

According to an embodiment of the present disclosure, similarly to the trigger frame described in FIG. 20, it is possible to determine the TB PPDU format responding to the TRS based on the PPDU format including the TRS. That is, when the PPDU indicating the transmission of the PPDU includes the TRS control subfield, the format of the PPDU may be determined based on the format of the PPDU including the TRS control subfield. For example, when the format of the PPDU including the TRS control subfield is the HE PPDU, the format of the indicated PPDU may be the HE PPDU. However, when the format of the PPDU including the TRS control subfield is the EHT PPDU, the format of the indicated PPDU may be the EHT PPDU.

Referring to FIG. 21, when the TRS is transmitted through the HE PPDU, the TB PPDU responding to the TRS may be the HE TB PPDU. In addition, when the TRS is transmitted through the EHT PPDU, the TB PPDU responding to the TRS may be the EHT TB PPDU. In addition, when the TRS is transmitted through the NEXT PPDU, the TB PPDU responding to the TRS may be the NEXT TB PPDU.

According to an embodiment of the present disclosure, the subfield interpretation included in the TRS may vary based on the PPDU format including the TRS. For example, when the TRS is included in the HE PPDU, the UL HE-MCS subfield (or subfield regarding the MCS) included in the TRS may indicate the value corresponding to the HE MCS table. When the TRS is included in the EHT PPDU, the UL HE-MCS subfield (or the subfield regarding the MCS) included in the TRS may indicate the value corresponding to the EHT MCS table. When the TRS is included in the NEXT PPDU, the UL HE-MCS subfield (or subfield regarding the MCS) included in the TRS may indicate the value corresponding to the NEXT MCS table. In addition, the interpretation of the RU allocation subfield may vary based on the PPDU format including the TRS.

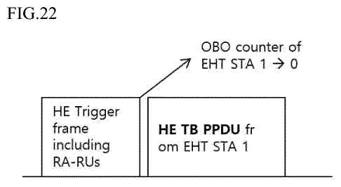

FIG. 22 illustrates an UL orthogonal frequency division multiple access (OFDMA)-based random access (UORA) operation according to an embodiment of the present disclosure.

According to an embodiment, the UORA operation may be an operation responding based on the RA-RU included in the trigger frame. For example, when an OBO counter configured by the STA is reduced based on the number of the RA-RU indicated by the trigger frame and the OBO counter is to be 0, the operation responding to the trigger frame through the RA-RU indicated by the trigger frame may be the UORA.

FIG. 22 may be an operation for solving the problem described in FIG. 10 and FIG. 11, and the contents described above may be omitted.

According to an embodiment of the present disclosure, it is possible that the EHT STA and the NEXT STA as well as the HE STA reduces the OBO counter for the RA-RU indicated by the HE trigger frame or the trigger frame included in the HE PPDU, and performs an UORA response. Therefore, in this case, the response may be performed by using the HE TB PPDU. Similarly, in case that the response to the RA-RU indicated by the trigger frame included in the EHT PPDU or the EHT trigger frame is performed, the response may be performed by using the EHT TB PPDU. In addition, when the response to the RA-RU indicated by the trigger frame included in the NEXT PPDU or the NEXT trigger frame is performed, the response may be performed by using the NEXT TB PPDU.

According to an embodiment of the present disclosure, when the TB PPDU response is performed for the trigger frame including the RA-RU, it is possible to respond through the TB PPDU corresponding to the oldest standard which can understand the trigger frame and the PPDU including the trigger frame.

Referring to FIG. 22, as to the HE trigger frame indicating the RA-RU, when the OBO counter value is 0, the EHT STA may respond by using the HE TB PPDU.

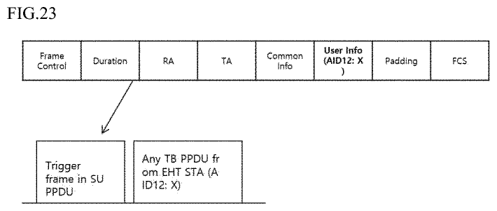

FIG. 23 illustrates an UL MU operation according to another embodiment of the present disclosure.

According to an embodiment, when an STA is a unique STA indicated by a trigger frame or a TRS, any TB PPDU may be used for a response. Alternatively, when the STA is a unique STA indicated a TRS or a trigger frame included in a PPDU including a trigger frame or a TRS, any TB PPDU may be used for a response. That is, in this case, the problems described in FIGS. 10 and 11 may not occur even though the embodiments described in FIGS. 13 to 22 are not applied.

According to an embodiment of the disclosure, whether the STA is a unique STA may be determined on the basis of the number of user information fields included in a trigger frame. For example, only when a condition that the number of user information fields included in a trigger frame is one is satisfied, the corresponding STA may be a unique STA for which TB PPDU transmission is indicated from an AP STA. That is, a frame indicating the TB PPDU transmission includes only one user information field rather than a specific user field, an STA corresponding to the corresponding user information field may be a unique STA indicating TB PPDU transmission through a frame from the AP STA.

In addition, when a condition that an RU received by an STA is a unique RU used by a PPDU including a trigger frame or a TRS is satisfied, the STA may be the indicated unique STA.

In addition, when a condition that an RA of a frame received by an STA is an individual address indicating the STA is satisfied, the STA may be a unique STA for which TB PPDU transmission is indicated from the AP STA.

In addition, when a condition that a PPDU received by an STA is a single user (SU) PPDU is satisfied, the STA may be a unique STA for which TB PPDU transmission is indicated from the AP STA. In this case, the SU PPDU may be a HE SU PPDU, a HE ER SU PPDU, a HE MU PPDU, or an EHT MU PPDU. In this case, the HE MU PPDU and the EHT MU PPDU may include one of a user information field and a terminal identifier (STA-ID).

According to an embodiment, the above-mentioned conditions are all satisfied, it may be determined that the STA is a unique STA for which TB PPDU transmission is indicated from the AP STA.

According to an embodiment, the trigger frame, the TRS, or the PPDU including the trigger frame or the TRS may include information indicating that the format of the TB PPDU can be any format.

Referring to FIG. 23, a trigger frame included in an SU PPDU may indicate an STA corresponding to AID12 value X. The trigger frame may include only one user information field. In addition, an RU including the trigger frame may be a unique RU used by the PPDU including the trigger frame. In this case, there may be no problem even when the format of a TB PPDU used for responding to the trigger frame is any format. For example, when the STA corresponding to AID12 value X is an EHT STA, a HE TB PPDU may be used for a response to the trigger frame, and an EHT TB PPDU may be also used for a response.

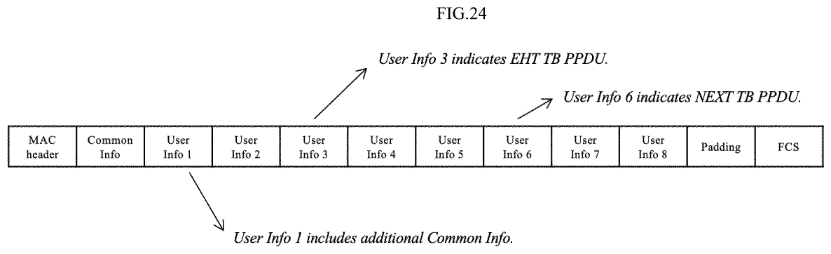

FIG. 24 illustrates a method for indicating a TB PPDU format according to an embodiment of the disclosure. FIG. 24 illustrates a method for indicating whether a TB PPDU format is a VHT, HE, EHT, or next-generation (e.g., NEXT, etc.) format, and is an additional description of the above-described embodiments, wherein the same contents as the above-described contents can be omitted. For example, the TB PPDU format may be indicated as a specific format on the basis of user information field of a trigger frame.

Referring to FIG. 24, an AP STA or a non-AP STA may indicate the format of a TB PPDU corresponding to a response to a frame, by using a user information field included in the frame. Specifically, the AP STA may configure, as a specific value, a value of an AID12 subfield included in a user format of a trigger frame, and may thus indicate the format of the TB PPDU corresponding to the response to the frame, as a specific format. For example, in a case where a value of the AID12 subfield is preconfigured, when TB PPDU transmission is triggered by a user information field included after the preconfigured value, the terminal may respond with the TB PPDU format indicated by the preconfigured AID subfield value. In addition, in this case, when there are multiple AID12 subfields, the TB PPDU may be transmitted according to the TB PPDU format indicated by an AID12 subfield positioned at a preconfigured position (e.g., the last position). That is, when the preconfigured value of the AID subfield is “1”, a response using TB PDDU format 1 may be indicated, and when the preconfigured value of the AID12 subfield is “2”, a response using TB PPDU format 2 may be indicated. In this case, when there is a user information field positioned subsequent to user information fields including the preconfigured values “1” and “2”, respectively, the format of the TB PPDU corresponding to a response to the frame may be determined by the user information field positioned at the last position. Alternatively, in a case where TB PPDU transmission is triggered by user information field X positioned later than the user information field including the preconfigured value “1”, when the user information field X precedes the user information field including the preconfigured value “2”, or when a user information field indicating a PPDU format is not followed by the user information field X, the TB PPDU format indicated by the preconfigured value “1” may be used as a response to the frame.

Alternatively, in a case of a response to a user information field not following the user information field indicating the PPDU format, a preconfigured PPDU format, for example, a HE TB PPDU format may be used for a response. Alternatively, in a case of a response to a user information field preceding all user information fields indicating the PPDU format, a preconfigured PPDU format, for example, a HE TB PPDU format may be used as a response.

As illustrated in FIG. 24, a trigger frame (or a specific frame indicating transmission of a TB PPDU, etc.) may include signaling indicating a TB PPDU format to indicate TB PPDU transmission. For example, the trigger frame may include a user information 3 field indicating performing responding with an EHT PPDU format, and a user information 6 field indicating performing responding with a NEXT TB PPDU. In this case, a value of an AID12 subfield included in the user information 3 field may be configured as a value indicating EHT TB PPDU transmission, and a value of an AID12 subfield value included in the user information 6 field may be configured as a value indicating NEXT TB PPDU transmission.

Alternatively, when TB PPDU transmission is triggered by a user information 4 field or a user information 5 field subsequent to the user information 3 field, TB PPDU transmission may be performed on the basis of a TB PPDU format (e.g., EHT TB PPDU, etc.) indicated by the user information 4 or the user information field. In addition, when TB PPDU transmission is triggered by a user information 6 field or a user information 7 field subsequent to the user information 6 field, TB PPDU transmission may be performed on the basis of a TB PPDU format (e.g., NEXT TB PPDU, etc.) indicated by the user information 7 or the user information 8 field.

In addition, when TB PPDU transmission is indicated by a user information field preceding a user information field indicating a TB PPDU format, a TB PPDU format may be determined on the basis of the user information field indicating the TB PPDU transmission. For example, in FIG. 23, when TB PPDU transmission is triggered by a user information 1 field or a user information 2 field, the format of a PPDU transmitted as a response to a frame may be a HE TB PPDU.

Alternatively, when there is a user information field indicating a HE TB PPDU format and TB PPDU transmission is triggered by a user information field subsequent to a user information field indicating the TB PPDU format, the format of a TB PPDU transmitted as a response to a frame may be a HE TB PPDU.

The user information 7 field and the user information 8 field in FIG. 24 are positioned after a user information field indicating an EHT TB PPDU and a user information field indicating a NEXT TB PPDU. In this case, since a user information 6 field indicating the NEXT TB PPDU is positioned after the user information 3 field indicating the EHT TB PPDU, the format of a TB PPDU, the transmission of which is triggered by the user information 7 field or the user information field 8 field, may be the NEXT TB PPDU.

In addition, when TB PPDU transmission is indicated by a user information 4 field or a user information 5 field, the user information 4 field or the user information field are positioned after the user information 3 field indicating the EHT TB PPDU, and positioned before the user information 6 field indicating the NEXT TB PPDU. Accordingly, the TB PPDU format indicated by the user information field or the user information 5 field may be the EHT TB PPDU.

According to an embodiment of the disclosure, the lengths of a common information field and a user information field in the EHT standard and the NEXT standard may be identical to the lengths of a common information field and a user information field of the HE standard, respectively. This may be applied to another embodiment of the disclosure, including a method for indicating a TB PPDU format on the basis of a common information field, in addition to the method, described in FIG. 23, for indicating a TB PPDU format on the basis of a user information field.

Such a method is used to prevent unintended TB PPDU transmission from being performed by a legacy terminal (e.g., an STA following the HE standard of the standard before the HE standard) which cannot perform PPDU decoding according to the EHT standard or the NEXT standard. For example, in a case where the length of the common information field or the user information field in the EHT standard and the NEXT standard is different from that in the HE standard, when a HE STA interprets a trigger frame according to the HE standard, it may be recognized that TB PPDU transmission of the HE STA is trigged by an AID12 subfield, etc. In this case, the HE STA may perform HE TB PPDU transmission, which is different from the intention of an STA having transmitted the trigger frame, and thus the HE TB PPDU may cause interference with another PPDU and the HE TB PPDU itself cannot be received by the STA having transmitted the trigger frame.

According to an embodiment, the lengths of the common information field and the user information field may be the same as shown in FIG. 12 or the like. For example, the common information field may be 64 bits (8 octets) except for a trigger-dependent common information subfield. In addition, the user information field may be 40 bits (5 octets) except for a user-dependent user information subfield. In addition, in a case of a basic trigger frame, there is no trigger-dependent common information subfield, and the length of a trigger-dependent user information subfield may be 8 bits (1 octet).

However, in this case, the length of a user information field subsequent to an AID12 subfield having a preconfigured value may be different from the length of a user information field in the HE standard. For example, the preconfigured value of the AID12 subfield may be 4095. That is, the preconfigured value of the AID12 subfield may be a value having all bits configured as 1. This value may be identical to a value indicating a start of padding of a trigger frame. Therefore, a HE STA may ignore user information fields subsequent to the AID12 subfield having the preconfigure value, and accordingly, the HE TB PPDU may not be unintendedly transmitted even though the lengths of the user information fields are different.

As another embodiment of the disclosure, when there are multiple user information fields or AID12 subfields indicating a TB PPDU format, the user information fields or the AID12 subfields may be included in a frame according to a configured order. For example, the user information fields or the AID12 subfields may be sequentially included in a frame according to a TB PPDU format indicated by each of the user information fields or the AID12 subfields.

That is, when a TB PPDU format indicated a user information field or an AID12 subfield is a legacy format, the corresponding user information field or AID12 subfield may precede other user information fields or AID12 subfields.

For example, when a TB PPDU format indicated by a user information field or an AID12 subfield is an EHT TB PPDU, the corresponding user information field or AID12 subfield may precede a user information field or an AID12 subfield indicating a NEXT TB PPDU. In addition, when a TB PPDU format indicated by a user information field or an AID12 subfield is a HE TB PPDU, the corresponding user information field or AID12 subfield may precede a user information field or an AID12 subfield indicating an EHT TB PPDU.

The user information field may indicate an additional common information field. As described above, a common information field may include information commonly corresponding to all STAs or multiple STAs receiving a frame. For example, when an AID12 subfield has a preconfigured value, a user information field including the AID12 subfield may include an additional common information field. This is because there is a limit to the size of information which can be included in a common information field included in the existing frame.

That is, as illustrated in FIG. 24, a user information 1 field may include additional common information. In this case, an AID12 subfield included in the user information 1 field may be configured to have a preconfigured value indicating that common information is included.

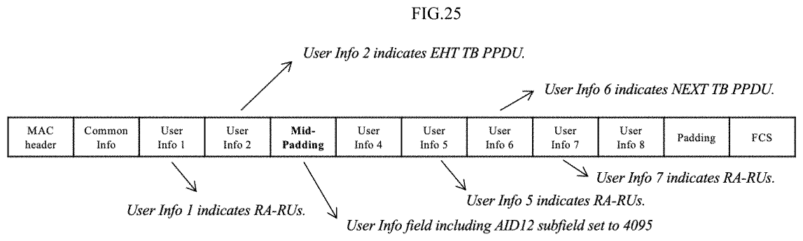

FIG. 25 illustrates another example of a trigger frame format according to an embodiment of the disclosure.

Referring to FIG. 25, when a TB PPDU is indicated, different AID12 subfield values are indicated according to respective formats, and thus a TB PPDU format can be indicated by using an AID12 subfield of a user information field. Specifically, FIG. 25 is an embodiment for solving the above-described problems, and the same contents as the above-described contents can be omitted.

Specifically, as described above, a specific value of the AID12 subfield or the user information field may indicate an RA-RU. However, when a method for indicating a TB PPDU format is designed to be identical to a method for indicating a TB PPDU to a legacy terminal, there may be a problem in that the user information field or the AID12 subfield value for indicating the TB PPDU for a next-generation terminal is differently interpreted and a response is made by the legacy terminal.

For example, the legacy terminal (e.g., HE STA) may interpret, as a value for indicating the RA-RU for indicating a UORA operation of a HE, a value of the AID12 subfield or the user information field for indicating transmission of an EHT TB PPDU, and the legacy terminal may respond by using the HE TB PPDU.

Accordingly, as described in FIG. 22, when the value of the AID12 subfield or the user field indicating the RA-RU is used, the STA may respond by using the HE TB PPDU. For example, in a case of an STA which can perform both EHT TB PPDU and HE TB PPDU transmissions, a HE TB PPDU may be transmitted as a response to a frame including the AID12 subfield or the user information field indicating the RA-RU.

In this case, the STA transmitting the trigger frame may use the AID12 subfield or the user information field indicating the RA-RU to indicate a response of the HE TB PPDU, as described in FIG. 24. Accordingly, when the value for indicating the RA-RU of the AID12 subfield or the user information field is used, an additional rule or implementation may not be required to indicate a PPDU format through the frame. That is, when the AID12 subfield or the user information field indicates the RA-RU, the STA may recognize, as the HE TB PPDU, a response to the frame.

That is, a specific value of the user information field included in the frame or the AID12 subfield included in the user information field may be used to indicate the RA-RUs of STAs supporting the HE, and in this case, the specific value for indicating the RA-RU may indicate that a response to the frame is a HE TB PPDU. Accordingly, the value of the user information field or the AID12 subfield included in the user information field for indicating an EHT TB PPDU or a NEXT TB PPDU, as a response to the frame, may be configured as a value remaining after excluding the specific value for indicating the UORA operation of the HE.

For example, an AP STA may transmit a frame for indicating (or triggering) TB PPDU transmission to one or more non-AP STAs, and in this case, a value of the user information field included in the frame or the AID12 subfield of the user information may be configured differently according to the format of the TB PPDU indicating transmission.

For example, when a value of the AID12 subfield indicates EHT TB PPDU transmission, the value may be configured as a value remaining after excluding a first specific value (e.g., “2045”) and/or a second specific value (e.g., “0”). In this case, when a specific condition is satisfied, the second specific value may be also used to indicate EHT TB PPDU transmission.

Accordingly, to indicate transmission of the HE TB PPDU rather than the EHT TB PPDU, the AID12 subfield may be configured as a first specific value (e.g., “2045”) or a second specific value (e.g., “0”). In this case, the first specific value may be used to indicate a response of the HE TB PPDU, and when a specific condition fails to be satisfied, the second specific value may be used to indicate transmission of the HE TB PPDU.

That is, the AP STA may configure, for the non-AP STAs, the value of the AID12 subfield as the first specific value, so as to transmit the frame including a HE variant user information field for indicating transmission of the HE TB PPDU. In this case, when a specific condition has failed to be satisfied, the second specific value may be used to indicate transmission of the HE TB PPDU.

When the value of the user information field or the AID12 subfield included in the user information field is configured as a first specific value (e.g., “2045”) or a second specific value (e.g., “0”) to indicate an RA-RU for a UORA operation of HE, an STA may transmit a HE TB PPDU as a response to a frame. However, when the value of the user information field or the AID12 subfield included in the user information field is configured as a value remaining after excluding the first specific value or the second specific value, the STA may transmit an EHT TB PPDU or a NEXT TB PPDU as a response to the frame.

The first specific value may be used to indicate the RA-RUs to unassociated STAs, and the second specific value may be used to indicate RA-RUs to STAs associated with the AP.

In this case, when a specific condition is satisfied, the second specific value may be used to indicate transmission of the EHT TB PPDU or the NEXT TB PPDU. For example, the specific condition may be one of: a case where all of the STAs associated with the AP are legacy STAs (for example, a case where all of the STAs associated with the AP may perform transmission of the EHT TB PPDU) or are EHT STAs rather than the HE and/or legacy STAs which cannot perform transmission of the HE TB PPDU (that is, a case STAs which cannot perform EHT TB PPDU transmission and which remain after excluding the legacy STAs which can perform HE TB PPDU transmission); a case where all of the associated legacy STAs (terminals which cannot perform EHT TB PPDU transmission) do not support the UORA operation; and a case where a frame indicating TB PPDU transmission is included in the EHT PPDU and transmitted. In this case, the case where all of the legacy STAs (terminals which cannot perform EHT TB PPDU transmission) do not support the UORA operation includes a case where the STA has transmitted, to the AP, a value of a capability subfield indicating that the UORA operation is not supported.

That is, the case where all of the legacy STAs (terminals which cannot perform EHT TB PPDU transmission) do not support the UORA operation may include a case where the capability subfield value transmitted to the AP by STAs is configured as a value indicating that the UORA operation is not supported or a case where STAs which do not support the UORA operation itself are associated.

In other words, among the conditions above, the case where all of the STAs associated with the AP are not legacy terminals (for example, the case where EHT TB PPDU is possible) may be also applied when the AP is associated with a single STA which can perform EHT TB PPDU transmission. That is, the STA associated with the AP exists only as an STA which can perform EHT TB PPDU transmission, and in this case, the second specific value corresponding to “0” may be thus used as the value of the AID12 subfield or the user information field. Accordingly, in this case, it may be determined that the specific condition is satisfied, and the second specific value may be used to indicate EHT TB PPDU or NEXT TB PPDU transmission.

In addition, a TB PPDU which can be indicated by the AP through the frame may indicate only one format of a TB PPDU. For example, the AP may indicate only a HE TB PPDU or an EHT TB PPDU (or a NEXT TB PPDU) through the frame, and may not indicate both the HE TB PPDU and the EHT TB PPDU. Accordingly, when the frame indicates the EHT TB PPDU, HE TB PPDU transmission cannot be indicated through the corresponding frame, and thus the value of the user information field or the AID12 subfield included in the user information field cannot be configured as “2045”.

In addition, an embodiment in which the HE TB PPDU is used as a response on the basis of the AID12 subfield or the user information field indicating the RA-RU may be limited to a case where the trigger frame includes a non-HE PPDU, a non-HT duplicate PPDU, a HE PPDU, a VHT PPDU, or an HT PPDU.

There may be a value of the AID12 subfield or the user information field indicating using the HE TB PPDU as a response and indicating the RA-RU. For example, when the value of the AID12 subfield is 0 or 2045, the value of the AID12 subfield may indicate the RA-RU for the UORA operation and also indicate that the format of a response to the frame is the HE TB PPDU.

In addition, there may be a value for the AID12 subfield or the user information field indicating using the EHT TB PPDU or the NEXT TB PPDU as a response and indicating the RA-RU. For example, a preconfigured value of the AID12 subfield indicating using the EHT TB PPDU or the NEXT TB PPDU as a response and indicating the RA-RU may be a value except for 0, 1 to 2007, 2045, 2046, and/or 4095.

That is, the value of the AID12 or user information field for indicating RA-RU allocation and EHT TB PPDU or NEXT TB PPDU transmission for the UORA operation of an STA (for example, an EHT STA supporting the EHT or a NEXT STA supporting the NEXT standard) which can perform EHT PPDU or NEXT PPDU transmission may be configured as a value except for the value of the AID12 subfield or the user information field for RA-RU allocation for the UORA operation of STAs which cannot perform the EHT TB PPDU or NEXT TB PPDU transmission.

For example, as described above, when the frame for triggering TB PPDU transmission indicates EHT TB PPDU transmission, the value of the AID12 subfield or the user information field may be configured as a value except for at least one specific value. That is, the value of the AID12 subfield or the user information field may be configured as a value except for at least one specific value for indicating RA-RUs of the STAs which cannot perform EHT TB PPDU transmission.

In this case, the at least one specific value may include a first specific value (e.g., “2045”) for indicating RA-RUs to STAs not associated with the AP, and a second specific value (e.g., “0”) for indicating RA-RUs to STAs associated with the AP may be included in the at least one specific value according to whether a specific condition is satisfied.

The specific condition is identical to that in the description above, and when the specific condition is satisfied, the second specific value may be configured as a value of the AID12 subfield or the user information field for indicating RA-RUs and EHT TB PPDU or NEXT TB PPDU transmission to STAs which can perform the EHT TB PPDU or NEXT TB PPDU transmission.

However, when the specific condition has failed to be satisfied, the second specific value cannot be as a value of the AID12 subfield or the user information field for indicating RA-RUs and EHT TB PPDU or NEXT TB PPDU transmission to STAs which can perform EHT TB PPDU or NEXT TB PPDU transmission, the value being included in the at least one specific value.

As described in FIG. 15, when the value of the AID12 subfield is 0, the value of the ADI12 subfield may be used to indicate one or more RA-RUs for associated STAs. In addition, AID12 subfield values 1 to 2007 may be used to indicate an associated STA having the corresponding AID, and AID12 subfield value 2045 may be used to indicate one or more RA-RUs for associated STAs. AID12 subfield value 2046 may be used to indicate an unallocated RU, and AID12 subfield value 4095 may be used to indicate a start of a padding field.

As illustrated in FIG. 24, a padding field of a trigger frame may be positioned in the middle of a user information field, and in this case, the padding field may be referred to as a mid-padding field. The mid-padding field may be a field different from the padding field described with reference to FIG. 12, and may be a type of a user information field. For example, when a AID12 subfield has a preconfigured value, a user information field may be a mid-padding field. Specifically, a user information field including an AID12 subfield having a preconfigured value may be included in the middle of a user information list field, and such a user information field including the AID12 subfield may be a mid-padding field.

Alternatively, the user information field including the AID12 subfield having a preconfigured value may be included at the position rather than the last position of the user information list field.

In this case, the preconfigured value may be identical to a value indicating that a padding field starts. For example, the preconfigured value may be 4095. Alternatively, the preconfigured value may be a value having all bits corresponding to 1. According to an embodiment of the disclosure, a TB PPDU format may be determined on the basis of a relative position between the mid-padding field and the user information field indicating the RU transmitted by the STA. For example, a TB PPDU format may be determined on the basis of a relative position between the mid-padding field and the user information field inditing the RA-RU transmitted by the STA. For example, in order to prevent the HE STA from recognizing the user information field after the mid-padding field, the mid-padding field may be included.

More specifically, to prevent the HE STA from recognizing the user information indicating the RA-RU after the mid-padding field, the mid-padding field may be included. When the mid-padding field is included, the HE STA may recognize values or the field after the mid-padding field as the padding field described with reference to FIG. 12. In addition, the length of the mid-padding field may be identical to that of the user information field. In an embodiment, a part remaining after excluding the AID12 subfield of the mid-padding field may be configured as a preconfigured value. In another embodiment, a part remaining after excluding the AID12 subfield of the mid-padding field may be configured as a random value.

In embodiments of the disclosure, responding to a user information field indicating a certain RA-RU may mean a case where an RU selected from among multiple RA-RUs indicated by a trigger frame including the user information field may be the certain RA-RU. For example, in the above-described UORA operation, when an OBO counter is 0, a process of selecting an RU to be transmitted from among one or more RA-RUs indicated by a trigger frame may be included.

In this case, an RU for the UORA operation among the one or more RA-RUs may be randomly selected. In the disclosure, responding to an RA-RU may include a case of responding based on a user information field indicating the RA-RU or selecting the RA-RU, a case where the OBO counter is 0 and the RA-RU is selected as an RU to be transmitted, etc.

According to an embodiment of the disclosure, when responding is performed on the basis of an RA-RU indicated by a user information field preceding a mid-padding field, or when responding is performed in an RA-RU indicated by a user information field preceding a mid-padding field, responding using a preconfigured PPDU format is possible. For example, the preconfigured PPDU format may be a HE TB PPDU format. In addition, a value of an AID12 subfield included in a user information field indicating an RA-RU may be 0 or 2045.

According to such an embodiment, when the HE STA responds to the RA-RU, the HE STA responds using a HE TB PPDU which is the only TB PPDU format transmittable by the HE STA. In addition, when the EHT STA and the NEXT STA which can perform transmission of multiple TB PPDU formats including the HE TB PPDU respond in an RA-RU, responding using the HE TB PPDU on the basis of the relative position between the mid-padding field and the user information field indicated by the RA-RU is possible.

Referring to FIG. 25, a trigger frame may include a mid-padding field. In addition, an RA-RU may be indicated by a user information 1 field. When an STA responds to an RA-RU indicated by the user information 1 field, the response may be transmitted using a HE TB PPDU format. This may be because the RA-RU in which the STA responds is indicated by the user information field preceding the mid-padding field.

In the disclosure, as the relative position between the mid-padding field and the user information field indicating the responding RA-RU, it is described that the user information field precedes the mid-padding field, but the disclosure is not limited thereto. A case where a HE TB PPDU format is used when the user information field exists after the mid-padding field may be defined, and the disclosure may be also applied to the case.

In addition, according to an embodiment of the disclosure, when responding is performed on the basis of an RA-RU indicated by a user information field existing after a mid-padding field, or when responding is performed in an RA-RU indicated by a user information field existing after a mid-padding field, a TB PPDU format is determined using the TB PPDU format indication or determination method described with reference to FIGS. 15 to 24 and transmitted. In a user information field indicating an RA-RU, a value of an AID12 subfield may be configured as 0 or 2045. For example, in a case where the TB PPDU format indication method described with reference to FIG. 24 is used, when the user information field indicating the transmitted RA-RU exists after the mid-padding field, a TB PPDU format transmitted through the UORA may be determined on the basis of a relative position between the user information field indicating the transmitted RA-RU and the user information field indicating the TB PPDU format.

Alternatively, when TB PPDU format indication signaling is included in a common information and a user information field indicating a transmitted RA-RU exists after a mid-padding field, a TB PPDU format may be selected on the basis of the TB PPDU format indication signaling.

As illustrated in FIG. 25, a trigger frame may include a mid-padding field. In this case, a user information 5 field may indicate an RA-RU, and a user information 7 field may also indicate an RA-RU. In addition, according to the embodiment described with reference to FIG. 24, a user information field indicating a TB PPDU format may be also included, and a user information 2 field may indicate an EHT TB PPDU format. In addition, a user information 6 field may indicate a NEXT TB PPDU format.

When an STA responds to an RA-RU indicated by the user information 5 field, the response may be transmitted using the EHT TB PPDU format indicated by the user information 2 field. This may be because an RA-RU in which the STA responds is indicated by the user information field existing after the mid-padding field, and the user information field indicating the RA-RU is positioned after the user information 2 field indicating the EHT TB PPDU format. In addition, this may be because the user information field 5 precedes the user information 6 field indicating another PPDU format.

Alternatively, when an STA responds to an RA-RU indicated by the user information 7 field, the STA may transmit the response by using a NEXT TB PPDU format indicated by the user information 6 field. This is because the RA-RU in which the STA responds is indicated by the user information field existing after the mid-padding field and the user information field indicating the RA-RU is positioned after the user information 6 field indicating the NEXT TB PPDU format. In addition, this is because the user information field indicating another PPDU format does not exist after the user information 7 field.

According to such an embodiment, the HE STA recognizes values existing after the mid-padding field, as a padding field, and may not recognize the user information field indicating the RA-RU. In addition, when the EHT STA and the NEXT STA which can perform transmission of multiple TB PPDU formats including the HE TB PPDU format respond in an RA-RU, responding using a format based on the TB PPDU format indication method on the basis of the relative position between the mid-padding field and the user information field indicating the RA-RU is possible.

In the disclosure, as the relative position between the mid-padding field and the user information field indicating the responding RA-RU, it is described that the user information field exists after the mid-padding field, but the disclosure is not limited thereto. A case where a format based on the TB PPDU format indication method, rather than a HE TB PPDU format, is used when the user information field precedes the mid-padding field may be defined, and the disclosure may be also applied to the case.

According to an embodiment of the disclosure, the mid-padding field may need to be distinguished from a padding field (the field preceding the FCS, described with reference to FIG. 25). This is because the EHT STA and the NEXT STA should not ignore information after the mid-padding field but may ignore information of the padding field. Accordingly, according to an embodiment of the disclosure, there may be signaling indicating whether there is a mid-padding field.

For example, the common information field may include signaling indicating whether a mid-padding field exists. For example, whether a mid-padding field exists may be indicated on the basis of a UL length field. More specifically, whether there is a mid-padding field may be indicated on the basis of a UL length field mod 3 value. Alternatively, referring to FIG. 12, whether there is a mid-padding field may be indicated on the basis of a UL HE-SIG-A2 Reserved subfield (B54 to B62) or Reserved subfield (B63) included in the common information field.

According to another embodiment, the user information field may include signaling indicating whether there is a mid-padding field. For example, whether there is a mid-padding field may be indicated on the basis of a bit included in the mid-padding field. For example, whether there is a mid-padding field may be indicated on the basis of a preconfigured bit except for an AID12 subfield included in the mid-padding field.

For example, the preconfigured bit may be a bit (a bit of an RU allocation subfield) after the AID12 subfield. This is because all bits of the padding bit in FIG. 12 may be configured as 1. According to another embodiment, whether there is a mid-padding field may be indicated by a user information field different from the mid-padding field. For example, a user information field indicating whether there is a mid-padding field may precede the mid-padding field. More specifically, a user information field indicating whether there is a mid-padding field may exist immediately before the mid-padding field.

In an embodiment, in a user information field indicating whether there is a mid-padding field, an AID12 subfield may be configured as a preconfigured value. Alternatively, in an embodiment, a user information field indicating whether there is a mid-padding field may be a user information field indicating a TB PPDU format, as described with reference to FIG. 23, etc. For example, whether there is a mid-padding field may be indicated by using a bit except for an AID12 subfield of the user information field indicating a TB PPDU format. Referring to FIG. 24, a user information 2 field preceding a mid-padding field may indicate whether there is the mid-padding field. In addition, the user information 2 field may be a user information field indicating the EHT TB PPDU format.

According to an embodiment, the STA may ignore user information fields after the user information field including the value of the AID12 subfield that the STA cannot recognize. Alternatively, the STA may ignore user information fields indicating RA-RUs after the user information field including the value of the AID12 subfield that the STA cannot recognize. This is for solving the above-described problem that TB PPDU formats transmitted from multiple STAs are mixed. Referring to FIG. 24, the EHT STA may not recognize the AID12 subfield of a user information 5 field indicating the NEXT TB PPDU. Accordingly, a user information 7 field existing after a user information 6 field and the RA-RU indicated by the user information 7 field may be ignored.

Alternatively, according to an embodiment, the range of values of a AID12 subfield indicating a TB PPDU format may be reserved. For example, when the EHT standard is defined, the available range may be defined by using NEXT standards. This embodiment is applicable to a case where the TB PPDU format is used as described with reference to FIG. 24.

According to an embodiment, user information fields indicating RA-RUs indicated after the AID12 subfield of the reserved range of values (i.e., values indicating a standard later than the standard supported by the STA) may be ignored. Referring to FIG. 24, the EHT STA may identify that the AID12 subfield of the user information 6 field indicating the NEXT TB PPDU may be a value for a standard in the future. Accordingly, a user information 7 field existing after the user information 6 field and the RA-RU indicated by the user information 7 field may be ignored.

In the disclosure, ignoring a user information field may mean that responding is not performed on the basis of the user information field. Alternatively, ignoring a user information field may mean that responding to an RU indicated by the user information field is not performed. Alternatively, ignoring a user information field may mean that an OBO counter is not reduced on the basis of the user information field.

According to an embodiment, the length of a user information field existing after a mid-padding field may be different from the user information field length defined in the HE standard.

According to an embodiment of the disclosure, when the TB PPDU format indication method described with reference to FIGS. 24 and 25 is used, a user information field indicating an RA-RU may exist only at the side indicating one TB PPDU format. That is, only one of the user information 1 field, the user information field, and the user information 7 field indicated in FIG. 24 may exist.

According to an embodiment, when the TB PPDU format indication method described with reference to FIGS. 24 and 25 is used, a user information field indicating an RA-RU may exist only at the side indicating multiple TB PPDU formats. That is, the user information 1 field, the user information 5 field, and the user information 7 field indicated in FIG. 24 may simultaneously exist.

In addition, the STA may reduce an OBO counter or select an RU to be transmitted, on the basis of only user information fields indicating RA-RUs corresponding to a supportable TB PPDU format. Alternatively, in a case where the STA has selected an RA-RU to be transmitted when the OBO counter is 0, responding may be performed according to a TB PPDU format to be used when the user information field indicating the RA-RU follows the method described with reference to FIGS. 23 and 24. That is, an RU to be transmitted may be selected from among the RA-RUs corresponding to the supportable format, and responding may be performed using a TB PPDU format corresponding to the selected RU. In another embodiment, regardless of whether support is possible or not, an RU to be transmitted may be selected from among RA-RUs, and responding may be performed using a TB PPDU format corresponding to the selected RU, or responding may not be performed when a TB PPDU format corresponding to the selected RU is not supported. In this case, the OBO counter may be reset.

According to an embodiment, one OBO counter may exist in an STA. In addition, the above-described embodiments are applicable when one OBO counter exists in an STA.

According to another embodiment, multiple OBO counters may exist in an STA. For example, separate OBO counters corresponding to respective standards supported by the STA may exist. In addition, an OBO counter of the corresponding standard may be reduced on the basis of an RA-RU corresponding to the TB PPDU format indication method described with reference to FIGS. 23 and 24. Referring to FIG. 24, an OBO counter corresponding to the HE standard may be reduced on the basis of User Info 1, an OBO counter corresponding to the EHT standard may be reduced on the basis of User Info 5, and an OBO counter corresponding to the NEXT standard may be reduced on the basis of User Info 7. In addition, when an OBO counter corresponding to a standard becomes 0, one of RA-RUs indicated on the basis of the standard may be selected and transmitted.

According to an embodiment of the disclosure, a TB PPDU may be transmitted as a response on the basis of standard information of a peripheral STA or TB PPDU formation information received from an AP. In addition, the TB PPDU format information or the standard information of the peripheral STA may be included in a management frame transmitted by the AP. The management frame may include one of an association response frame, a reassociation response frame, a beacon frame, and a probe response frame.

According to an embodiment of the disclosure, a TB PPDU format may be determined on the basis of observation of the STA. For example, when the STA has received a HE PPDU or a frame from a HE STA of the same BSS, a HE TB PPDU may be transmitted as a response. Alternatively, when the STA has failed to receive a HE PPDU or a frame from a HE STA of the same BSS, an EHT TB PPDU or a NEXT TB PPDU may be transmitted as a response.

According to an embodiment, a TRS control field may include a format identifier or a version identifier. In addition, a 20 MHz subchannel including an RU indicated by a HE variant TRS control subfield may not be indicated to transmit a response by using an EHT TB PPDU format or a NEXT TB PPDU format, upon the TB PPDU format indication method described with reference to FIGS. 15 to 25. Similarly, a 20 MHz subchannel including an RU indicated by an EHT variant TRS control field may not be indicated to transmit a response by using a HE TB PPDU format or a NEXT TB PPDU format, upon the TB PPDU format indication method described with reference to FIGS. 15 to 25.

A 20 MHz subchannel including an RU indicated by a NEXT variant TRS control field may not be indicated to transmit a response by using a HE TB PPDU format or an EHT TB PPDU format, upon the TB PPDU format indication method described with reference to FIGS. 15 to 25.

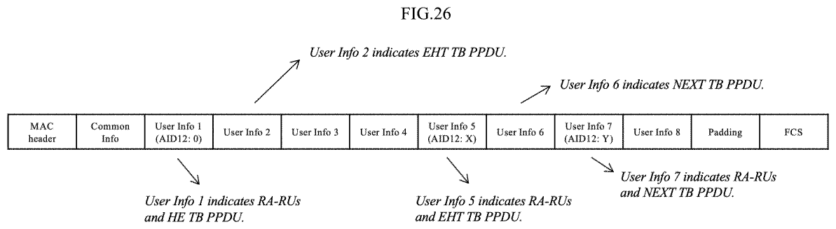

FIG. 26 illustrates a method for indicating a trigger frame and an RA-RU according to an embodiment of the disclosure.

Referring to FIG. 26, a TB PPDU format and an RA-RU may be indicated by using the value of the user information field included in the frame or the AID12 subfield included in the user information field, as described above. The same contents as the above-described contents can be omitted in FIG. 26.

Specifically, as described above, the user information field or the ADI12 subfield indicating a response PPDU format to the frame and the RA-RU may be included in the frame.

For example, as described above, when the AID12 subfield is 0 or 2045, an RA-RU may be included and transmission of a HE TB PPDU may be indicated as a response to the frame. In this case, the AID12 subfield value corresponding to 0 may indicate an RA-RU for STAs associated with the AP, and the AID12 subfield value corresponding to 2045 may indicate an RA-RU for STAs unassociated with the AP. In addition, there may be a user information field or an AID12 subfield indicating an RA-RU and indicating that a response PPDU format is an EHT TB PPDU. In addition, in this case, there may be two separate values including a value for indicating an RA-RU for the STA associated with the AP and a value for indicating an RA-RU for STAs unassociated with the AP.

Similarly, there may be a user information field or an AID12 subfield indicating an RA-RU and indicating that a response PPDU format is a NEXT TB PPDU. In addition, in this case, there may be two separate values including a value for indicating an RA-RU for the STA associated with the AP and a value for indicating an RA-RU for STAs unassociated with the AP.

According to another embodiment, when an AID12 subfield has a preconfigured value, an RA-RU may be indicated, and it may be indicated that a response PPDU format is an EHT TB PPDU or a NEXT TB PPDU (that is, it may be indicated that a response PPDU format is not a HE TB PPDU format). For example, the preconfigured value may be a value that is neither 0 nor 2045. In addition, the preconfigured value may be a value between 2008 and 2044, or may be a value between 2047 and 4094. In addition, in such a case, there may be no problem since the method described in the embodiment of FIG. 23 or other embodiments of the disclosure may be additionally used in addition to a method for selecting a PPDU format between the EHT TB PPDU and the NEXT TB PPDU.

Referring to FIG. 26, a trigger frame may include a user information field indicating an RA-RU and indicating that a response PPDU format is a HE TB PPDU. A value of an AID12 subfield of such a user information field may be 0 or 2045. In addition, the trigger frame may include a user information field indicating an RA-RU and indicating that a response PPDU format is an EHT TB PPDU. Referring to FIG. 26, a value of an AID12 subfield of such a user information field may be X. In addition, the trigger frame may include a user information field indicating an RA-RU and indicating that a response PPDU format is a NEXT TB PPDU. Referring to FIG. 25, a value of an AID12 subfield of such a user information may be Y. In addition, as described above, according to an embodiment, X and Y may have the same value.

According to an embodiment, a HE STA may reduce an OBO counter and select an RU for an RA-RU of a user information field having an AID12 subfield configured as 0 or 2045. In addition, the HE STA may not recognize a user information field having an AID12 subfield configured as X or Y and an RA-RU indicated by the user information field.

In addition, according to an embodiment, an EHT STA may reduce an OBO counter and select an RU for an RA-RU of a user information field having an AID12 subfield configured as 0, 2045, or X. In this case, The EHT STA may have more random access opportunities than the HE STA. In addition, in this case, when the EHT STA responds in the RA-RU indicated by the user information field having the AID12 subfield configured as 0 or 2045, the response may be transmitted through a HE TB PPDU. In addition, in this case, when the EHT STA responds in the RA-RU indicated by the user information field having the AID12 subfield configured as X, the response may be transmitted through an EHT TB PPDU.

In addition, according to an embodiment, an RA-RU candidate causing reduction of an OBO counter or determination of UORA transmission (making the OBO counter 0) may be different from an RA-RU candidate selected during UORA transmission.

In addition, according to another embodiment, for the RA-RU of the user information field having the AID12 subfield configured as 0, 2045, or X, the EHT STA may reduce an OBO counter and select an RU from among RA-RUs of the user information field having the AID12 subfield configured as X. In addition, in this case, when the EHT STA responds in the RA-RU indicated by the user information field having the AID12 subfield configured as X, the response may be transmitted through an EHT TB PPDU.

In addition, according to another embodiment, for the RA-RU of the user information field having the AID12 subfield configured as 0, 2045, X, or Y, the EHT STA may reduce an OBO counter and select an RA-RU of the user information field having the AID12 subfield configured as 0, 2045, or X. In such a case, the EHT STA may acquire more random access opportunities than the HET STA. In addition, the EHT STA reduces the OBO counter for the same RA-RUs as those of the NEXT STA, and thus the random access opportunities may be equally acquired. In addition, in this case, when the EHT STA responds in the RA-RU indicated by the user information field having the AID12 subfield configured as 0 or 2045, the response may be transmitted through a HE TB PPDU. In addition, in this case, when the EHT STA responds in the RA-RU indicated by the user information field having the AID12 subfield configured as X, the response may be transmitted through an EHT TB PPDU.

In addition, according to another embodiment, the EHT STA may reduce an OBO counter and select an RU for the RA-RU of the user information having the AID12 subfield configured as X. That is, the EHT STA may not reduce the OBO counter for the RA-RU of the user information field having the AID12 subfield configured as 0 or 2045.

However, when the EHT STA reduces the OBO counter for AID12 subfield X, to reduce the OBO counter on the basis of the RA-RU of the user information having the AID12 subfield value configured as “0” or “2045”, the OBO counter may be reset. Similarly, when the EHT STA reduces the OBO counter for the AID12 subfield configured as “0” or “2045, to reduce the OBO counter on the basis of the RA-RU of the user information field having the AID12 subfield value configured as “X”, the OBO counter may be reset.

In addition, the EHT STA may not select an RU for the RA-RU of the user information field having the AID12 subfield configured as 0 or 2045. In this case, losing the fairness due to more random access opportunities that the EHT STA takes compared to the HE STA can be prevented. In addition, in this case, when the EHT STA responds in the RA-RU indicated by the user information field having the AID12 subfield configured as X, the response may be transmitted through an EHT TB PPDU.

In addition, according to another embodiment, the ETH STA may have and manage multiple OBO counters. For example, the EHT STA may reduce OBO counter A and select an RU for the RA-RU of the user information field having the AID12 subfield configured as 0 or 2045. The EHT STA may reduce OBO counter B and select an RU for the RA-RA of the user information field having the AID12 subfield configured as X. In addition, the EHT STA may reduce OBO counter C and select an RU for the RA-RU of the user information field having the AID12 subfield configured as Y.

In such a case, the EHT STA may need to perform implementation for maintaining multiple OBO counters, but may have more random access opportunities than the HE STA. In addition, in this case, when the EHT STA responds in the RA-RU indicated by the user information field having the AID12 subfield configured as 0 or 2045, the response may be transmitted through a HE TB PPDU. In addition, in this case, when the EHT STA responds in the RA-RU indicated by the user information field having the AID12 subfield configured as X, the response may be transmitted through an EHT TB PPDU. In addition, in this case, when a NEXT STA responds in the RA-RU indicated by the user information field having the AID12 subfield configured as Y, the response may be transmitted through a NEXT TB PPDU.

In addition, the NEXT STA may perform the UORA by using the same method described for the EHT STA. That is, according to an embodiment, the NEXT STA may reduce an OBO counter and select an RU for the RA-RU of the user information field having the AID12 subfield configured as 0, 2045, X, or Y. In addition, transmission is performed through the UORA, the TB PPDU format may be based on the AID12 subfield indicating the responding RA-RU. For example, when the NEXT STA responds in the RA-RU indicated by the user information field having the AID12 subfield configured as 0 or 2045, a HE TB PPDU may be used, when the NEXT STA responds in the RA-RU indicated by the user information field having the AID12 subfield configured as X, an EHT TB PPDU may be used, and when the NEXT STA responds in the RA-RU indicated by the user information field having the AID12 subfield configured as Y, a NEXT TB PPDU may be used.

According to another embodiment, the NEXT STA may reduce an OBO counter and select an RU for the RA-RU of the user information field having the AID12 subfield configured as Y. In addition, when transmission is performed through the UORA, the response may be transmitted by using a NEXT TB PPDU format.

According to an embodiment, each of X and Y may have a value other than 0 or 2045, and in another embodiment, each of X and Y may have a value of 0 or 2045.

Referring to FIG. 26, the EHT STA may reduce an OBO counter on the basis of an RA-RU indicated by User Info 1 having AID12 configured as 0 and an RA-RU indicated by User Info 5 having AID12 configured as X, and may respond by selecting one of RA-RUs indicated by User Info 1 and User Info 5 when the OBO counter becomes 0.

In another embodiment, referring to FIG. 25, the EHT STA may reduce an OBO counter on the basis of an RA-RU indicated by User Info 5 having AID12 configured as X, and may respond by selecting one of RA-RUs indicated by User Info when the OBO counter becomes 0.

In embodiments of the disclosure, the case where the OBO counter becomes 0 may include a case where the number of RUs incited by the RA-RU is equal to or greater than the OBO counter. That is, the case may include a case where the OBO counter becomes 0 or lower when the OBO counter is reduced.

According to an embodiment of the disclosure, the embodiment described with reference to FIG. 26 may be used together the TB PPDU format determination method described in the disclosure such as the embodiment of FIG. 24 and the embodiments of FIGS. 15 to 20. In this case, two or more methods may indicate different PPDU format, and in this case, a preconfigured method among the two or more methods may be used. For example, there may be a case where both the embodiment described with reference to FIG. 24 and the embodiment described with reference to FIG. 25 are used.

In addition, referring to FIG. 26, an AID12 subfield value of a user information 1 field may be configured as 0 or 2045, and an AID12 subfield value of a user information 3 field may be configured as 0 or 2045. A user information 2 field may indicate an EHT TB PPDU format, and the user information 3 field may exist after the user information 2 field.

That is, when responding is performed on the basis of the user information 3 field, an EHT TB PPDU may be indicated on the basis of the user information 2 field, and a HE TB PPDU may be indicated on the basis of an AID12 subfield configured as 0 or 2045, included in the user information 3 field. In this case, according to an embodiment, the response may be transmitted using the HE TB PPDU. This is because it is expected that the HE STA responds using a HE TB PPDU on the basis of the user information 3 field since the HE STA can recognize the user information 3 field and an RA-RU indicated by the user information 3 field, but cannot recognize a PPDU format indicated by the user information 2 field.

That is, when UORA responding is performed on the basis of a user information field having an AID12 subfield configured as 0 or 2045, transmission using a HE TB PPDU may be possible despite of another TB PPDU format indication method.

In another embodiment, a user information field including AID12 subfield 0 or 2045 may exist at the position indicating the HE TB PPDU. For example, the user information field including AID12 subfield 0 or 2045 may exist at the preceding part of user information fields, or precede the user information field indicating the EHT TB PPDU and the user information field indicating the NEXT TB PPDU. Alternatively, when the mid-padding field including method described with reference to FIG. 25 is used, the user information field including AID12 subfield 0 or 2045 may precede the mid-padding field.

According to an embodiment, the AID12 subfield configured as 0 or 2045 may be included regardless of a standard to which a trigger frame belongs or a TB PPDU used for responding of the trigger frame. In addition, the AID12 subfield configured as a value indicating the RA-RU and indicating that responding is performed through an EHT TB PPDU may be included regardless of a standard to which a trigger frame belongs or a TB PPDU used for responding of the trigger frame. In addition, the AID12 subfield configured as a value indicating the RA-RU and indicating that responding is performed through a NEXT TB PPDU may be included regardless of a standard to which a trigger frame belongs or a TB PPDU used for responding of the trigger frame.

In another embodiment, the AID12 subfield configured as 0 or 2045 may be included only in a case of a trigger frame indicating a HE TB PPDU (e.g., a HE trigger frame, a HE variant trigger frame, a trigger frame indicating responding through a HE TB PPDU, or a trigger frame having a format identifier indicating HE).

Accordingly, the AID12 subfield configured as 0 or 2045 may not be included in a case of a trigger frame indicating an EHT TB PPDU or a NEXT TB PPDU (e.g., an EHT (or NEXT) trigger frame, an EHT (or NEXT) variant trigger frame, a trigger frame indicating responding through an EHT (or NEXT) trigger frame, or a trigger frame having a format identifier indicating EHT (or NEXT)).

The AID12 subfield configured as a value indicating the RA-RU and indicating that responding is performed through an EHT TB PPDU (or NEXT TB PPDU) may be included only in a case of a trigger frame indicating transmission of an EHT TB PPDU or a NEXT TB PPDU (e.g., an EHT (or NEXT) trigger frame, an EHT (or NEXT) variant trigger frame, a trigger frame indicating responding through an EHT (or NEXT) trigger frame, or a trigger frame having a format identifier indicating EHT (or NEXT)).

That is, the AID12 subfield configured as a value indicating the RA-RU and indicating that responding is performed through an EHT TB PPDU may not be included in a case of a trigger frame indicating transmission of a HE TB PPDU or a NEXT TB PPDU (e.g., a HE (or NEXT) trigger frame, a HE (or NEXT) variant trigger frame, a trigger frame indicating responding through a HE (or NEXT) TB PPDU, or a trigger frame having a format identifier indicating HE (or NEXT)).

The AID12 subfield configured as a value indicating the RA-RU and indicating that responding is performed through a NEXT TB PPDU may not be included in a case of a trigger frame indicating transmission of a HE TB PPDU (or EHT TB PPDU (e.g., a HE (or EHT) trigger frame, a HE (or EHT) variant trigger frame, a trigger frame indicating responding through a HE (or EHT) TB PPDU, or a trigger frame having a format identifier indicating HE (or EHT)).

For example, there may be a case where the embodiment described with reference to FIG. 25 is used together with the common information field-based determination method in the embodiments described with reference to FIGS. 15 to 18. In this case, when a common information field indicates an EHT TB PPDU or a NEXT TB PPDU (or when a trigger frame is EHT variant or NEXT variant), a user information field having AID12 subfield 0 or 2045 may not be included. Alternatively, a trigger frame indicates an EHT TB PPDU or a NEXT TB PPDU (or when a trigger frame is EHT variant or NEXT variant), a user information field having AID12 subfield 0 or 2045 may not be included.

According to another embodiment, when a trigger frame or a common information field indicates an EHT TB PPDU or a NEXT TB PPDU (or when a trigger frame is EHT variant or NEXT variant), a user information field having AID12 subfield 0 or 2045 may be included, and on the basis this, when responding is performed through UORA, a HE TB PPDU rather than the EHT TB PPDU or the NEXT TB PPDU may be used for responding.

In addition, when a trigger frame or a common information field indicates a NEXT TB PPDU (or when a trigger frame is NEXT variant), a user information field having an AID12 subfield configured as 0, 2045, or X may not be included. In another embodiment, when a trigger frame or a common information field indicates a NEXT TB PPDU (or when a trigger frame is NEXT variant), a user information field having an AID12 subfield configured as 0, 2045, or X may be included, and on the basis of this, when responding is performed through UORA, a TB PPDU format indicated by 0, 2045, or X, rather than the NEXT TB PPDU may be used for responding.

In addition, in a case where responding is performed for a user information field indicating an RA-RU and indicating an EHT TB PPDU, when the EHT TB PPDU is different from a PPDU format indicated by another PPDU format determination method, responding may be performed through a preconfigured method. According to an embodiment, regardless of another PPDU format determination method, responding may be performed through an EHT TB PPDU on the basis of a user information field indicating the RA-RU and indicating the EHT TB PPDU. According to another embodiment, when responding is performed on the basis of a user information field indicating the RA-RU and indicating the EHT TB PPDU, responding may be performed on the basis of another PPDU format determination method.

Alternatively, a trigger frame may be configured so that for a user information field indicating an RA-RU and indicating an EHT TB PPDU, an EHT TB PPDU is determined according to another PPDU format determination method. Referring to FIG. 25, a user information field in which an AID12 subfield indicating an RA-RU and indicating that responding is performed through an EHT TB PPDU is configured as X may exist after User Info 2 indicating responding through the EHT TB PPDU, and may precede User Info 6 indicating responding through a NEXT TB PPDU.

The same method as that in a case of responding for a user information field indicating an RA-RU and indicating an EHT TB PPDU is also applicable to a case where responding is performed for a user information field indicting an RA-RU and a NEXT TB PPDU.

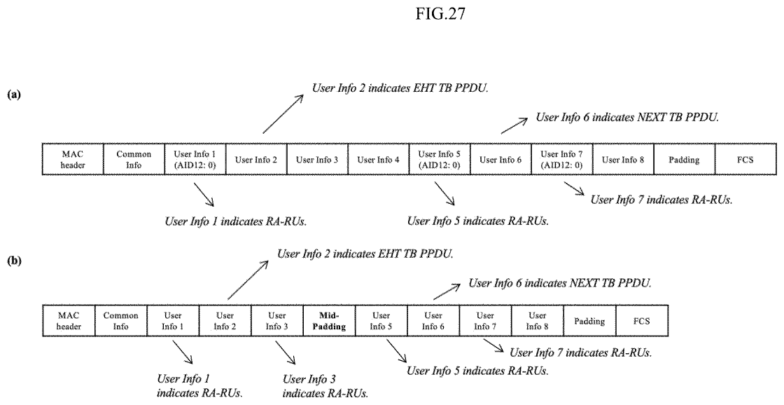

FIG. 27 illustrates another example of indicating a trigger frame format and an RA-RU according to an embodiment of the disclosure.

The embodiment described with reference to FIG. 27 may be an additional description and embodiment for the above-described problem and solution in FIG. 25, and the same contents as the above-described contents can be omitted. Hereinafter, a value of an AID12 subfield indicating an RA-RU may include 0 and 2045.

When the mid-padding field described in FIG. 24 may be included in the middle of a user information list field, it may mean that the mid-padding field may be included at the foremost position of the user information list field. Alternatively, it may mean that the position of the mid-padding field may be different from an existing padding field existing after a trigger frame, or another user information field may exist after the mid-padding field.

The mid-padding field may be a user information field including an AID12 subfield having a preconfigured value. For example, the length of the mid-padding field may be identical to that of the user information field.

According to an embodiment of the disclosure, the length of the mid-padding field may be different from that of the user information field. For example, the length of the mid-padding field may be shorter than that of the user information field. In addition, the mid-padding field may be a field configured as a preconfigured value. For example, the length of the mid-padding field may be identical to that of an AID12 subfield. That is, the mid-padding field may have 12 bits. In addition, the mid-padding field may be configured as a preconfigured value, and may be configured as, for example, 4095 (a value having all bits configured as 1, wherein the bit length is 12 bits).

When identifying AID12 subfield values included in one or more user information fields, an STA receiving a trigger frame may find the next AID12 subfield on the basis of the length of the user information field. In this case, when a mid-padding field is found, the next AID12 subfield may be found on the basis of the length of the mid-padding field.

For example, when the mid-padding field has the same length as the AID12 subfield, after finding the mid-padding field, the STA may identify that the mid-padding field is followed by the next AID12 subfield or the next user information field. In this case, overhead of including the mid-padding field in the trigger frame can be reduced, and the above-described TB PPDU format determination problem can be solved.

According to an embodiment of the disclosure, a trigger frame may not include a mid-padding field. In addition, the trigger frame may include a user information field indicating an RA-RU. As described in part (a) of FIG. 27, the trigger frame may include a user information 1 field, a user information 5 field, and a user information 7 field, which indicate RA-RUs.

In addition, the trigger frame illustrated in part (a) of FIG. 27 may not include a mid-padding field. Accordingly, even though the PPDU format determination methods in the above-described embodiments are used, a HE STA may recognize a user information 1 field, a user information 5 field, and a user information 7 field, which indicate RA-RUs.

Accordingly, according to an embodiment of the disclosure, when responding is performed through the UORA, regardless of other PPDU format determination methods, a HE TB PPDU may be used. For example, in a case where the trigger frame does not include the mid-padding field, when responding is performed through the UORA, a HE TB PPDU may be used. Referring to part (a) of FIG. 27 a PPDU format may be determined on the basis of a user information field including an AID12 subfield configured as a specific value. For example, responding through an EHT TB PPDU on the basis of a user information 2 field may be indicated, and responding through a NEXT TB PPDU on the basis of a user information 6 field may be indicated.

However, the HE STA may also recognize the user information field indicating the RA-RU included in this trigger frame. Accordingly, when responding to the RA-RU indicated by the trigger frame, regardless of the user information 2 field or the user information 6 field, the HE TB PPDU may be used.

In addition, as described above, even in a case where a TB PPDU format is determined on the basis of a common information field or a format identifier field, when responding to the RA-RU is performed, the HE TB PPDU may be used. Alternatively, in a case where the trigger frame is included in an EHT PPDU or a NEXT PPDU, or is included in a PPDU that the HE STA cannot read, when a TB PPDU format is determined on the basis of the common information field or the format identifier field and responding to the RA-RU is performed, the same TB PPDU format determination method may be used.

According to another embodiment, in a case where a TB PPDU format is determined on the basis of a common information field or a format identifier field, when the EHT or NEXT standard is indicated, the HE STA may fail to recognizes the same. In such a case, when responding is performed through the UORA, a TB PPDU format may be determined on the basis of the common information field or the format identifier field. For example, when a TB PPDU format is determined on the basis of a trigger type subfield, the HE STA may not respond on the basis of a trigger frame including a trigger type subfield which cannot be recognized.

In another embodiment, when the trigger frame does not include the mid-padding field, a user information field indicating an RA-RU may not be included.

In another embodiment, when responding through a TB PPDU in an unsupported standard is indicated on the basis of the above-described PPDU format determination method, an OBO counter for an RA-RU indicated by a user information field including such a trigger frame may not be reduced. In addition, the RA-RU may not be selected as an RU used for UORA responding. For example, a trigger frame includes a format identifier field and an ETH STA has identified that a common information field or a format identifier field indicates a NEXT TB PPDU, an OBO counter may not be reduced and an RU for UORA responding may not be selected on the basis an RA-RU indicated by a user information field included in the trigger frame.

In the disclosure, the user information field indicating the RA-RU may be a user information field having an AID12 subfield configured as 0 or 2045.

In the disclosure, an RU which can reduce an OBO counter may be referred to as an eligible RA-RU. In addition, an RU which can perform UORA responding may be referred to as an eligible RA-RU. In addition, an RU which can be selected when an RU for UORA responding is selected may be referred to as an eligible RA-RU. In addition, an RU which can reduce an OBO counter and which can perform UORA responding may be referred to as an eligible RA-RU. Alternatively, for the eligible RA-RU, the OBO counter may be reduced or the RU for UORA responding may be selected. In addition, a transmittable RA-RU may be referred to as an eligible RA-RU. In addition, when UORA responding or transmission is possible, it may include meaning of a TB PPDU format which is supported. For example, an RA-RU indicated to perform responding through a NEXT TB PPDU to an EHT STA may not be an eligible RA-RU.

According to an embodiment of the disclosure, a trigger frame may include a mid-padding field. Such an embodiment may include the same contents described in FIG. 24, or redundant contents may have been omitted. As described above, when responding to an RA-RU, a PPDU format may be determined on the basis of the position between the mid-padding field and the user information field indicating the responding RA-RU. Alternatively, whether the RA-RU is an eligible RU may be determined on the basis of the relative position between the mid-padding field and the user information field indicating the RA-RU.

In an embodiment, when UORA responding is performed on the basis of a user information field preceding a mid-padding field, a response may be performed by using a HE TB PPDU. In this case, when UORA responding is performed on the basis of the user information field preceding the mid-padding field, a response may be performed by using a HE TB PPDU, regardless of another TB PPDU format indication method. Referring to part (b) of FIG. 27, a trigger frame may include a mid-padding field. In addition, a user information 1 field, a user information 3 field, a user information 5 field, and a user information 7 field included in the trigger frame may indicate RA-RUs. In addition, the user information 1 field and the user information 3 field may precede the mid-padding field, and the user information 5 field and the user information 7 field may be subsequent to the mid-padding field.

When UORA responding is performed in an RA-RU indicated by the user information 1 field or the user information 3 field, a HE TB PPDU may be used as a response. In this case, even though a PPDU other than the HE TB PPDU is indicated by the above-described PPDU format determination method, an STA may respond by using the HE TB PPDU. For example, even though the PPDU format determination method described in FIG. 24 is used and an EHT TB PPDU is indicated by the user information 2 field preceding the user information 3 field, when UORA responding is performed in an RA-RU indicated by the user information 3 field, the HE TB PPDU may be used.

In another embodiment, a user information field indicating an EHT TB PPDU may exist after the mid-padding field. In addition, a user information field indicating a NEXT TB PPDU may exist after the mid-padding field.

In addition, in an embodiment, when UORA responding is performed on the basis of the user information field existing after the mid-padding field, a response may be transmitted on the basis of another PPDU format degermation method described above. For example, referring to part (b) of FIG. 27, the PPDU format determination method described with reference to FIG. 24 may be used. In this case, when UORA responding is performed in an RA-RU indicated by User Info 5 existing after the mid-padding field, a response may be transmitted by using an EHT TB PPDU indicated by a user information 2 field. In addition, when UORA responding is performed in an RA-RU indicated by a user information 7 field existing after the mid-padding field, an STA may respond by using a NEXT TB PPDU indicated by a user information 6 field.

According to an embodiment, a TB PPDU format determination method based on a user information field may be used. In addition, a TB PPDU format determination method based on a mid-padding field may be used. In addition, an RA-RU to which responding using a HE TB PPDU format is indicated may exist, and such an RA-RU may be referred to as a HE RA-RU.

An RA-RU to which responding using an EHT TB PPDU format is indicated may exist, and such an RA-RU may be referred to as an EHT RA-RU.

An RA-RU to which responding using a NEXT TB PPDU format is indicated may exist, and such an RA-RU may be referred to as a NEXT RA-RU.

Referring to part (b) of FIG. 27, an RA-RU indicated by a user information 1 field may be a HE RA-RU. This may be because a TB PPDU format for the user information 1 field is not indicated or is indicated as a HE TB PPDU. In addition, an RA-RU indicated by a user information 3 field may be a HE RA-RU. This may be because the user information 1 field precedes the mid-padding field. An RA-RU indicated by the user information 1 field may be an EHT RA-RU. This may be because for the user information 1 field, an EHT TB PPDU format is indicated by the user information 1 field.

In addition, an RA-RU indicated by a user information 7 field may be a NEXT RA-RU. This may be because for the user information 7 field, a NEXT TB PPDU format is indicated by a user information 6 field.

In another embodiment, a HE RA-RU may be an RA-RU to which AID12 subfield value 0 or 2045 is indicated. Alternatively, an EHT RA-RU may be an RA-RU to which an AID12 subfield value is indicated as a value indicating an RA-RU and indicating responding through an EHT TB PPDU. Alternatively, a NEXT RA-RU may be an RA-RU to which an AID12 subfield value is indicated as a value indicating an RA-RU and indicating responding through a NEXT TB PPDU.

According to an embodiment, an STA may reduce an OBO counter or select an RU for all RA-RUs in the past, current, and future standards. In this case, when an RA-RU in the future standard is selected as an RU to be transmitted, transmission may not be performed.

According to another embodiment, an STA may reduce an OBO counter or select an RU for all RA-RUs in the past and current standards. In addition, the STA may not reduce the OBO counter for the RA-RU in the future standard. The STA may not select an RU for the RA-RU in the future RA-RU.

According to another embodiment, an STA may reduce an OBO counter or select an RU for all RA-RUs in the current standard. In addition, the STA may not reduce the OBO counter for the RA-RUs in the past and future standards. The STA may not select an RU for the RA-RUs in the past and future standards.

According to another embodiment, an STA may reduce an OBO counter and select an RU for all RA-RUs in the current and future standards. In addition, the STA may not reduce the OBO counter for the RA-RU in the past standard. The STA may not select an RU for the RA-RU in the past standard.

In addition, for the standards for which OBO counter reduction is performed and standards for which RU selection is performed, the OBO counter reduction and RU selection may be performed by using different combinations. Examples of the combinations are as follows.

According to an embodiment, an EHT STA may reduce an OBO counter for a HE RA-RU, an EHT RA-RU, and a NEXT RA-RU. In addition, the EHT STA may select an RU for responding among the HE RA-RU, the EHT RA-RU, and the NEXT RA-RU. In this case, when the EHT STA selects the NEXT RA-RU, transmission may not be performed.

According to an embodiment, an EHT STA may reduce an OBO counter for a HE RA-RU, an EHT RA-RU, and a NEXT RA-RU. In addition, the EHT STA may select an RU for responding among the HE RA-RU, the EHT RA-RU, and the NEXT RA-RU.

According to an embodiment, an EHT STA may reduce an OBO counter for a HE RA-RU and an EHT RA-RU. In addition, the EHT STA may select an RU for responding among the HE RA-RU, the EHT RA-RU, and the NEXT RA-RU. In this case, when the EHT STA selects the NEXT RA-RU, transmission may not be performed.

According to an embodiment, an EHT STA may reduce an OBO counter for a HE RA-RU and an EHT RA-RU. In addition, the EHT STA may select an RU for responding among the HE RA-RU and the EHT RA-RU.

According to an embodiment, an EHT STA may reduce an OBO counter for an EHT RA-RU. In addition, the EHT STA may not reduce the OBO counter for a HE RA-RU and a NEXT RA-RU. In addition, the EHT STA may select an RU for responding among the EHT RA-RU. In addition, the EHT STA may not select an RU for responding among the HE RA-RU and the NEXT RA-RU.

According to an embodiment, an EHT STA may reduce an OBO counter for an EHT RA-RU and a NEXT RA-RU. In addition, the EHT STA may select an RU for responding among a HE RA-RU, an EHT RA-RU, and a NEXT RA-RU. In this case, when the EHT STA selects the NEXT RA-RU, transmission may not be performed.

According to an embodiment, an EHT STA may reduce an OBO counter for an EHT RA-RU and a NEXT RA-RU. In addition, the EHT STA may select an RU for responding among the HE RA-RU and the EHT RA-RU.

According to an embodiment, an EHT STA may reduce an OBO counter for an EHT RA-RU and a NEXT RA-RU. In addition, the EHT STA may select an RU for responding among the EHT RA-RU.

In addition, the above-described OBO counter reduction and RU selection based on the TB PPDU format may be also based on whether other transmission parameters are supported. Transmission parameters may be values indicated by a common information field or a corresponding user information field. For example, when determining whether an OBO counter can be reduced for an RA-RU in a standard, the determination may be based on whether other transmission parameters are supported, and the OBO counter may be reduced when the other transmission parameters can be supported.

According to an embodiment of the disclosure, an RA-RU may be determined as an eligible RA-RU on the basis of the following conditions. For example, when all of the following conditions are satisfied, an RA-RU may be determined as an eligible RA-RU.

Condition 1) All transmission parameters of a common information field are supported.

Condition 2) All transmission parameters of a user information field indicating the RA-RU are supported.

Condition 3) A TB PPDU format indicated by a user information field indicating a TB PPDU format for the user information field is supported.

Condition 3) may be replaced with the following condition.

Condition 3-1) A TB PPDU format indicated for the user information field is supported.

In addition, in this case, a TB PPDU format indication method may include the methods in the above-described embodiments, such as an indication method by a trigger frame, an indication method by a common information field, and an indication method by a user information field.

Condition 3) may be replaced with the following condition 3-2) or 3-3).

Condition 3-2) All transmission parameters indicated by another user information field including information on the user information field are supported.

Condition 3-3) All transmission parameters indicated by another user information field including common information field (information applicable to multiple STAs) of the user information field are supported.

Referring to part (b) of FIG. 27, an EHT STA may determine an eligible RA-RU on the basis of the trigger frame illustrated in part (b) of FIG. 27. In this case, an RA-RU indicated by a user information 1 field, a user information 3 field, or a user information 5 field may be determined as an eligible RA-RU. This may be because the EHT STA may transmit a HE TB PPDU and an EHT TB PPDU. In addition, an RA-RU indicated by a user information 7 field may not be determined as an eligible RA-RU. This may be because when responding to an RU indicated by the user information 7 field by a user information 6 field, a NEXT TB PPDU may need to be transmitted, and an EHT STA cannot transmit the NEXT TB PPDU.

According to an embodiment of the disclosure, a user information field may include of the length of a specific user information field or the number of specific user information fields subsequent to the user information field. For example, a user information field indicating a TB PPDU format may include the length of a user information field or the number of user information fields corresponding to a TB PPDU format. For example, an unsupported TB PPDU format is indicated, another user information field may be searched for on the basis of the number or length included in the user information field. This is because responding to the trigger frame using an unsupported TB PPDU format is not to be indicated.

According to an embodiment of the disclosure, there may be a preconfigured value indicating a start of a padding field. The preconfigured value may be a value other than 4095. Alternatively, the preconfigured value may be a value different from a value indicating a mid-padding field. For example, there may be a case where a padding field rather than a mid-padding field needs to indicated. Alternatively, the preconfigured value may be a value between 2008 and 2044, or a value between 2047 and 4094. In addition, the preconfigured value may be a value other than 1 to 2007, a value other than 0, a value other than 2045, a value other than 2046, and a value other than 4095.

According to an embodiment of the disclosure, there may be a determination method based on a UL length field included in a trigger frame. For example, there may be a determination method based on a value obtained by applying a mod operation to the UL length field. For example, there may be a determination method based on a value obtained by applying a mod 3 operation to the UL length field. There may be a determination method based on whether a value obtained by applying a mod 3 operation to the UL length field value is 0. In addition, the determination method may indicate a PPDU format. Alternatively, the determination method may indicate whether a specific field is present (or included). Alternatively, the determination method may indicate a method for interpreting a specific field. Alternatively, the determination method may indicate meaning of a value indicated by a specific field. Alternatively, the determination method may indicate the length of a specific field.

According to an embodiment of the disclosure, an A-MPDU may include multiple trigger frames. According to an embodiment, the multiple trigger frames may have different contents. In addition, the A-MPDU or a PPDU including the A-MPDU may include signaling indicating whether the contents of the multiple trigger frames are different from each other.

In addition, an STA may determine whether the contents of the multiple trigger frames are different from each other, on the basis of the type of a PPDU including the A-MPDU. For example, the contents included in multiple trigger frames including an EHT PPDU or a NEXT PPDU may be different from each other. In addition, this may be a case of supporting an aggregated PPDU (A-PPDU). The A-PPDU may correspond to a case where frequency division multiplexing is performed for multiple PPDUs. In addition, the multiple PPDUs may be PPDUs in different standards.

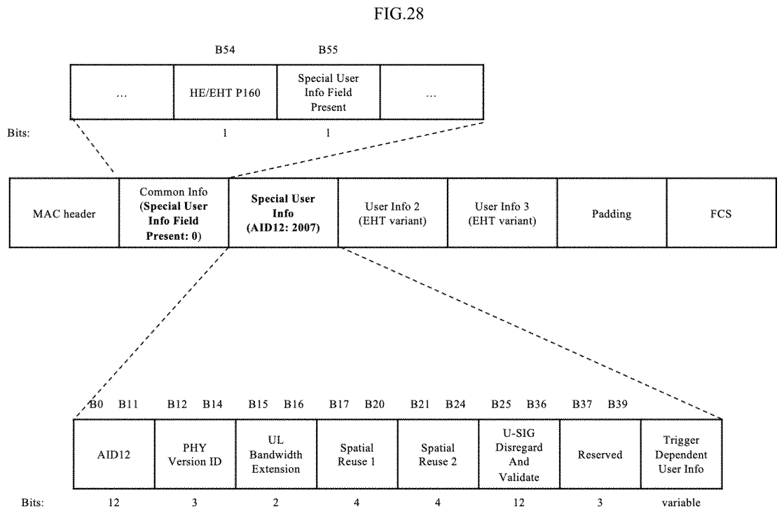

FIG. 28 illustrates another example of a method for indicating a TB PPDU format according to an embodiment of the disclosure.

As described above, a method for indicating a PPDU format used for responding to a triggering frame. For example, the PPDU format may mean a TB PPDU format. The embodiment of FIG. 28 may be a specific embodiment of the above-described TB PPDU format indication method. In addition, the contents described above may be omitted in this embodiment.

According to an embodiment of the disclosure, on the basis of a user information field included in a trigger frame, a PPDU format used for responding to the trigger frame may be determined. Alternatively, the PPDU format used for responding to a trigger frame may be indicated through a user information field included in the trigger frame. In the disclosure, the user information field for determining or indicating the PPDU format may be referred to as a specific user information field.

According to an embodiment, a specific user information field may be a user information field in which an AID12 subfield included in the specific user information field is configured as a preconfigured value. For example, the preconfigured value may be 2007. In addition, the preconfigured value may be a value not allocated by an AP, as an association ID (AID).

In addition, the specific user information field may have a format different from that of another user information field. That is, the specific user information field may include different subfields from another user information field. In addition, the specific user information field and another user information field may commonly include the AID12 subfield at the same position. For example, in the specific user information field and a user information field other than the specific user information field, the foremost 12 bits may correspond to the AID12 subfield. For example, in the specific user information field and a user information field other than the specific user information field, B0 to B11 may correspond to the AID12 subfield.

In addition, a trigger frame may include a subfield indicating whether a specific user information field is included. The subfield indicating whether the specific user information field is included may be referred to as a specific user information field present subfield. For example, the specific user information field present subfield may exist in a common information field. For example, bit B55 of the common information field may be the specific user information field present subfield. If the specific user information field present subfield is configured as 1, the trigger frame does not include the specific user information field.

In addition, if the specific user information field present subfield is configured as 0, the trigger frame may include the specific user information field. This may be because in the 802.11ax standard, B55 of the common information field is configured as a preconfigured value corresponding to 1.

An STA receiving the trigger frame may determine whether the specific user information field is included, on the basis of the specific user information field present subfield, and thus implementation of determining whether the specific user information field is included may be easier compared to a case where the specific user information field present subfield does not exist. In addition, when a trigger frame is received by an STA unassociated with the AP having transmitted the trigger frame, the STA may determine whether a user information field having an AID12 subfield configured as a preconfigured value indicating the specific user information field is the specific user information field or not (indicates 12 LSBs of the actual AID), on the basis of the specific user information field present field. For example, in a case where an RA-RU for the unassociated STA is indicated, when a trigger frame is received by an STA unassociated with the AP having transmitted the trigger frame, the STA may operate on the basis of the trigger frame. In addition, the STA may perform a spatial reuse operation on the basis of a TB PPDU or a trigger frame from an unassociated BSS.

In addition, when a trigger frame includes a specific user information field, the specific user information field may be positioned at the foremost position among user information fields. Alternatively, the specific user information field may be positioned immediately after a common information field. This may be for enabling easy parsing of a specific user information field by an STA receiving the trigger frame.

According to an embodiment of the disclosure, a PPDU format for responding to a trigger frame may be determined on the basis of whether the trigger frame includes a specific user information field. For example, when a trigger frame includes a specific user information field, a PPDU format for responding to the trigger frame may be an EHT TB PPDU. In addition, when a trigger frame does not include a specific user information field, a PPDU format for responding to the trigger frame may be a HE TB PPDU. In addition, as described above, there may be a specific user information field present subfield corresponding to signaling indicating whether a trigger frame includes a specific user information field. Accordingly, a PPDU format for responding to a trigger frame may be determined on the basis of the specific user information field present subfield. For example, when a specific user information field present field is configured as 0, a PPDU format for responding to a trigger frame may be an EHT TB PPDU. In addition, when a specific user information field present field is configured as 1, a PPDU format for responding to a trigger frame may be a HE TB PPDU.

In addition, when a trigger frame includes a specific user information field, a user information field included in the trigger frame may be an EHT variant user information field. In addition, a trigger frame does not include a specific user information field, the trigger frame cannot include the EHT variant user information field. When a trigger frame does not include a specific user information field, the trigger frame may include only a HE variant user information field.

An RU indication method may vary according whether a user information field is EHT variant or HE variant. For example, for a user information field, an interpretation method may vary according whether an RU allocation subfield included in the user information field is EHT variant or EHT variant. For example, in an RU allocation subfield included in an EHT variant user information field, encoding may be performed so that RUs supported by the EHT standard can be indicated. In addition, in an RU allocation subfield included in a HE variant user information field, encoding may be performed so that RUs supported by the HE standard can be indicated.

In addition, when interpreting an RU indicated on the basis of the EHT variant user information field, the interpretation may need to be based on two or more subfields. The two or more subfields may include an RU allocation subfield and a PS160 subfield. The RU allocation subfield may be positioned immediately after the AID12 subfield, as shown in FIG. 12. In addition, the RU allocation subfield may be 8 bits. The PS160 subfield may indicate a subchannel in which an RU indicated by an RU allocation subfield exists. Alternatively, the PS160 subfield may indicate a subchannel in which an RU indicated by a user information field exists. In this case, a unit for indicting a subchannel may be a 160 MHz subchannel. The PS160 subfield may indicate whether the indicated RU exists in a primary 160 MHz channel or a secondary 160 MHz channel. The PS160 subfield may exist immediately before a trigger dependent user information field. The PS160 subfield may be a B39 bit of the user information field. The PS160 subfield may be one bit.

In addition, when interpreting an RU indicated on the basis of a HE variant user information field, the interpretation may be based on one subfield. The one subfield may be an RU allocation subfield. That is, the position of an RU indicated by a HE variant user information field may be determined on the basis of only an RU allocation subfield included in the HE variant user information field.

Referring to FIG. 28, a trigger frame may include a specific user information field. Whether a user information field is a specific user information field may be determined on the basis of an AID12 subfield included in the user information field. For example, when an AID12 subfield included in a user information field is a preconfigured value, the user information field may be the specific user information field. Referring to FIG. 27, the preconfigured value may be 2007. In addition, referring to FIG. 28, the specific user information field may exist immediately after a common information field or at the foremost position among user information fields. In addition, there may be a specific user information field present subfield corresponding to signaling indicating whether a trigger frame includes a specific user information field. Referring to FIG. 27, the specific user information field present subfield may be included in the common information field. If the specific user information field present subfield is configured as 0, the trigger frame includes the specific user information field. As described in FIG. 27, when the trigger frame includes the specific user information field, a PPDU format as a response to the trigger frame may be an EHT TB PPDU.

In addition, according to an additional embodiment, a PPDU format as a response to a trigger frame may be determined on the basis of a subfield indicating a TB PPDU format and whether the trigger frame includes a specific user information field. In the disclosure, a subfield indicating the TB PPDU format may be referred to as a HE/EHT P160 subfield. According to a more specific embodiment, a HE/EHT P160 subfield may indicate a TB PPDU format for a preconfigure channel. For example, the HE/EHT P160 subfield may indicate a TB PPDU format for a primary 160 MHz channel (P160 channel). For example, when a value of the HE/EHT P160 subfield is 1, the value may indicate a response through a HE TB PPDU. In addition, when a value of the HE/EHT P160 subfield is 0, the value may indicate a response through an EHT TB PPDU. The HE/EHT P160 subfield may be one bit.

Referring to FIG. 28, the HE/EHT P160 subfield may be included in the common information field. More specifically, the HE/EHT P160 subfield may be included at the position of bit B55 of the common information field.

Accordingly, the following operations may be performed when a TB PPDU format is indicated or determined on the basis of a specific user information field and a HE/EHT P160 subfield. When the HE/EHT P160 subfield indicates an EHT TB PPDU, an EHT TB PPDU may be used to respond to a trigger frame. That is, when the HE/EHT P160 subfield indicates an EHT TB PPDU, an EHT TB PPDU may be used to respond to a trigger frame, regardless of the position of an allocated RU. In addition, when the HE/EHT P160 subfield indicates an EHT TB PPDU, a specific user information field may be always included. That is, a specific user information field present subfield may also indicate that the specific user information field is included.

If the HE/EHT P160 subfield indicates a HE TB PPDU, a TB PPDU format may be indicated or determined when responding to a trigger frame, on the basis of the position of an allocation RU. If the HE/EHT P160 subfield indicates a HE TB PPDU and an allocation RU is included in a preconfigured channel (e.g., P160 channel) indicated by the HE/EHT P160 subfield, a HE TB PPDU may be transmitted as a response. In addition, if the HE/EHT P160 subfield indicates a HE TB PPDU and an allocated RU is not included in a preconfigured channel (e.g., P160 channel) indicated by the HE/EHT P160 subfield (e.g., an allocation RU is included in a secondary 160 MHz channel (S160 channel)), an EHT TB PPDU may be transmitted as a response. In addition, whether an allocation RU is included in a preconfigure channel may be based on an RU allocation subfield and a PS160 subfield. More specifically, when the preconfigured channel is a P160 channel, whether an allocation RU is included in the preconfigured channel may be based on the PS160 subfield.

In addition, indicating or determining a TB PPDU on the basis of the position of an allocated RU and a HE/EHT P160 subfield may be limited to a case where a trigger frame includes a specific user information field. If a trigger frame includes a specific user information field, the trigger frame may include a HE/EHT P160 subfield and a PS160 subfield. If a trigger frame does not include a specific user information field, a HE TB PPDU may be always used to respond to the trigger frame. In addition, as described above, whether the specific user information field is included may be based on a specific user information field present subfield. Accordingly, when a trigger frame includes or does not include a specific user information field, it may mean that a specific user information field present subfield is configured to be included or is configured not to be included in the specific user information field.

A description in the disclosure that using an EHT TB PPDU is indicated and determined when responding to a trigger frame may be replaced with a description that using an EHT TB PPDU or a NEXT TB PPDU is indicated and determined. In addition, whether to use either the EHT TB PPDU or the NEXT TB PPDU may be determined on the basis of a format identifier subfield. That is, a TB PPDU format indicated by the format identifier subfield may be used. For example, when the format identifier subfield indicates EHT, an EHT TB PPDU may be used.

A specific user information field may include an AID12 subfield and information required when responding to and a trigger frame. The information required to respond to the trigger frame may include information included in a preamble of a PPDU used as a response to the trigger frame. For example, the information required when responding to the trigger frame may include information included in a U-SIG field of a PPDU used as a response to the trigger frame. FIG. 28 may include an example of information included in the U-SIG field. Referring to FIG. 28, the specific user information field may include AID12, PHY version ID, UL bandwidth extension, spatial reuse 1, spatial reuse 2, U-SIG disregard and validate, reserved, trigger dependent user information fields.

The above-mentioned fields may be positioned according to the mentioned order, and the number of bits of the respective fields may be 12, 3, 2, 4, 4, 12, 3, and variable, respectively. A PHY version ID field may be the above-described format identifier subfield, a PHY version identifier subfield, or a PHY version field. An STA responding to a trigger frame may configure a U-SIG field included in a responding PPDU on the basis of a specific user information field included in the trigger frame. For example, a value of a subfield included in a specific user information field may be copied to a subfield included in a responding U-SIG field. Subfields copied to the subfield included in the U-SIG field may be PHY version ID, spatial Reuse 1, spatial Reuse 2, U-SIG disregard and validate subfields.

Alternatively, a subfield included in a U-SIG field of a responding PPDU may be configured on the basis of a value of a subfield included in a specific user information field. Subfields for configuring the U-SIG field on the basis of the subfield included in the specific user information field may be UL bandwidth extension subfields. For example, a bandwidth (BW) subfield included in the U-SIG field of a responding PPDU may be configured on the basis of a UL BW subfield (see FIG. 12) included in the common information field and a UL bandwidth extension subfield included in the specific user information field.

In addition, the existence and the length of a trigger dependent user information field included in a specific user information field may be based on the type of a trigger frame. That is, the existence and the length of a trigger dependent user information field included in a specific user information field may be based on the type of variant to which the trigger frame corresponds. The type of the trigger frame may be indicated and determined by the trigger type subfield (see FIG. 12) included in the common information field.

As described above, even in a case where a responding PPDU format is indicated on the basis of the specific user information field, when an RA-RU is indicated by AID12 subfield field value 0 or 2045, there may be a problem that a HE STA fails to recognize a specific user information and transmits a response by using a HE TB PPDU even though the specific user information field is included in the trigger frame and responding using an EHT TB PPDU is indicated. Hereinafter, a method for solving this problem may be described, and this may be a more specific embodiment of the above-described contents.

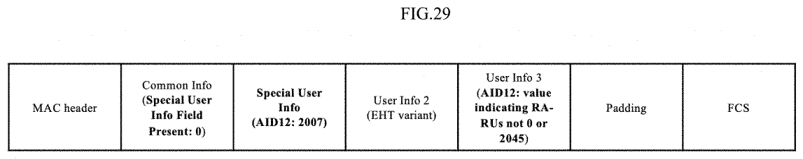

FIG. 29 illustrates an example of an uplink orthogonal frequency division multiple access (OFDMA)-based random access (UORA) operation and a method for indicating a TB PPDU format according to an embodiment of the disclosure.

An embodiment described with reference to FIG. 29 may be a more specific embodiment of the embodiments described with reference to FIGS. 24 to 27. The embodiment described with reference to FIG. 29 may be used together with the method described with reference to FIG. 28. The above-described content may have been omitted.

According to an embodiment of the disclosure, in a case where an AID12 subfield value indicating an RA-RU is 0 or 2045, it may indicate that a response is transmitted through a HE TB PPDU when transmission to the RA-RU is performed. In addition, according to an embodiment, there may be an AID12 subfield value other than 0 or 2045, which indicates an RA-RU. The AID12 subfield value other than 0 or 2045, which indicates the RA-RU, may be an AID12 subfield value indicating responding through the above-described EHT TB PPDU or NEXT TB PPDU and indicating the RA-RU. The AID12 subfield other than 0 or 2045, which indicates the RA-RU, may be configured for a user information field included in a trigger frame including a specific user information field. That is, the AID12 subfield value other than 0 or 2045, which indicates the RA-RU, may be used together with the TB PPDU format indication method based on a specific user information field.

The AID12 subfield value other than 0 or 2045, which indicates the RA-RU, may be a value among 2008 to 2044, or a value among 2047 to 4094. For example, the AID12 subfield value other than 0 or 2045, which indicates the RA-RU, may be 2047. For the AID12 subfield value other than 0 or 2045, which indicates the RA-RU, there may be different values including a value for an associated STA and a value for an unassociated STA. For example, the AID12 subfield value other than 0 or 2045, which indicates an RA-RU transmittable by the associated STA, may be 2047. For example, the AID12 subfield value other than 0 or 2045, which indicates an RA-RU transmittable by the unassociated STA, may be 2048.

According to an embodiment of the disclosure, when the AID12 subfield value is 0 or 2045, a user information field including the AID12 subfield may be HE variant User Info.

According to an embodiment of the disclosure, when the AID12 subfield value is an AID12 subfield value other than 0 or 2045, which indicates an RA-RU, a user information field including the AID12 subfield may be EHT variant User Info.

In addition, an STA (e.g., AP) transmitting a trigger frame may configure and generate a trigger frame as follows.

According to the method described in FIG. 28, and the like, the trigger frame may not include a user information field having an AID12 subfield configured as 0 or 2045 for a channel indicating responding through an EHT TB PPDU. For an S160 channel, a user information field having an AID12 subfield configured as 0 or 2045 may not be included. That is, a user information field having an AID12 subfield configured as 0 or 2045 may not indicate an RU included in the S160 channel. In addition, when a HE/EHT P160 subfield indicates EHT, a user information field having an AID12 subfield configured as 0 or 2045 may not be included. More specifically, when a HE/EHT P160 subfield indicates EHT, a user information field having an AID12 subfield configured as 0 or 2045 may be included for an RU of a P160 channel.

When an RA-RU is indicated for a channel indicating responding through an EHT TB PPDU, a user information field having an AID12 subfield configured as an AID12 subfield value other than 0 or 2045, which indicates an RA-RU, may be included. That is, when an RA-RU is indicated for an S160 channel, a user information field having an AID12 subfield configured as an AID12 subfield value other than 0 or 2045, which indicates an RA-RU, may be included. In addition, when an RA-RU is indicated for a P160 channel and a HE/EHT P160 subfield is indicated as EHT, a user information field having an AID12 subfield configured as an AID12 subfield value other than 0 or 2045, which indicates an RA-RU, may be included. In addition, a user information field having an AID12 subfield configured as an AID12 subfield value other than 0 or 2045, which indicates an RA-RU, may be included in a trigger frame.

According to the method described with reference to FIG. 28, and the like, a trigger frame may not include a user information field having an AID12 subfield configured as an AID12 subfield value other than 0 or 2045, which indicates an RA-RU, for a channel indicating responding through a HE TB PPDU. That is, when the HE/EHT P160 subfield indicates HE, a user information field having an AID12 subfield configured as an AID12 subfield value other than 0 or 2045, which indicates an RA-RU, may not be included for a P160 channel.

In addition, a user information field having an AID12 subfield configured as an AID12 subfield value other than 0 or 2045, which indicates an RA-RU, may not be included in a trigger frame not including a specific user information field. When an RA-RU is indicated for a channel indicating responding through a HE TB PPDU, a user information field having an AID12 subfield configured as 0 or 2045 may be included. When a HE/EHT P160 subfield indicates HE, a user information field having an AID12 subfield configured as 0 or 2045 may be included for a P160 channel.

In addition, an STA responding to a trigger frame may perform the following operations.

An STA responding to an RA-RU for a trigger frame may determine a TB PPDU format according to the method described with reference to FIG. 27, etc. That is, an STA responding to an RA-RU indicated by a trigger frame may determine a TB PPDU format on the basis of a specific user information field, a HE/EHT P160 subfield, and a PS160 subfield. In addition, when the STA responds to a user information field having an AID12 subfield configured as 0 or 2045, a HE TB PPDU may be used. When the STA responds to a user information field having an AID12 subfield configured as an AID12 subfield value other than 0 or 2045, which indicates an RA-RU, an EHT TB PPDU may be used.

More specifically, in a case where a trigger frame includes a specific user information field in which a PHY version ID field indicates EHT, when the STA response to a user information field having an AID12 subfield configured as an AID12 subfield value other than 0 or 2045, which indicates an RA-RU, an EHT TB PPDU may be used. More specifically, in a case where a trigger frame includes a specific user information field in which a PHY version ID field indicates a standard (value) other than EHT, when the STA responds to a user information field having an AID12 subfield configured as an AID12 subfield value other than 0 or 2045, which indicates an RA-RU, an EHT TB PPDU may not be used. Alternatively, in a case where a trigger frame includes a specific user information field in which a PHY version ID field indicates EHT, the STA may reduce an OBO counter or select an RA-RU to be transmitted, for a user information field having an AID12 subfield configured as an AID12 subfield value other than 0 or 2045, which indicates an RA-RU. In addition, in a case where a trigger frame includes a specific user information field in which a PHY version ID field indicates a standard (value) other than EHT, the STA may not reduce an OBO counter and may not select an RA-RU to be transmitted, for a user information field having an AID12 subfield configured as an AID12 subfield value other than 0 or 2045, which indicates an RA-RU. Alternatively, in a case where a trigger frame does not include a specific user information field in which a PHY version ID field indicates EHT, when the STA responds to a user information field having an AID12 subfield configured as an AID12 subfield value other than 0 or 2045, which indicates an RA-RU, an EHT TB PPDU may not be included. Alternatively, in a case where a trigger frame does not include a specific user information field in which a PHY version ID field indicates EHT, the STA may not reduce an OBO counter and may not select an RA-RU to be transmitted, for a user information field having an AID12 subfield configured as an AID12 subfield value other than 0 or 2045, which indicates an RA-RU.

According to an embodiment, an STA responding to a trigger frame may maintain one OBO counter. The STA may use the same OBO counter for 1) an RA-RU indicated by AID12 subfield value 0 or 2045, and 2) an RA-RU indicated by an AID12 subfield value other than 0 or 2045, which indicates an RA-RU. In addition, when the OBO counter becomes 0 or when the OBO counter is equal to or less than the number of eligible RA-RUs, the STA may select an RA to be used for UORA transmission from among 1) an RA-RU indicated by AID12 subfield value 0 or 2045, and 2) an RA-RU indicated by an AID12 subfield value other than 0 or 2045, which indicates an RA-RU.

In addition, a TB PPDU format corresponding to the selected RU may be selected according to the method described with reference to FIG. 27, etc. In addition, a TB PPDU format corresponding to the selected RU may be determined on the basis of an AID12 subfield value included in a user information field, which indicates the selected RU. When the selected RU is indicated by AID12 subfield 0 or 2045, a response may be transmitted using a HE TB PPDU format. When the selected RU is indicated by an AID12 subfield value other than 0 or 2045, which indicates an RA-RU, a response may be transmitted using an EHT TB PPDU format.

According to another embodiment, an EHT STA responding to a trigger frame may use an OBO counter for an RA-RU indicated by an AID12 subfield value other than 0 or 2045, which indicates an RA-RU. An OBO counter may not be used for an RA-RU indicated by AID12 subfield value 0 or 2045. In addition, when the OBO counter becomes 0 or when the OBO counter is equal to or less than the number of eligible RA-RUs, the STA may select an RU to be used for UORA transmission from among RA-RUs indicated by an AID12 subfield value other than 0 or 2045, which indicates an RA-RU. The STA may not include an RU to be used for UORA transmission among RA-RUs indicated by AID12 subfield value 0 or 2045.

According to another embodiment, an STA responding to a trigger frame may maintain multiple OBO counters. In addition, each of the multiple OBO counters may correspond to a TB PPDU of each standard. For example, the STA may maintain two OBO counters. The two OBO counter may correspond to 1) an RA-RU indicated by AID12 subfield value 0 or 2045, and 2) an RA-RU indicated by an AID12 subfield value other than 0 or 2045, which indicates an RA-RU, respectively. The STA may reduce the OBO counter for each RA-RU, and may select an RU to be transmitted from among RA-RUs corresponding to the OBO counter corresponding to a case where the OBO counter becomes 0 or a case where the OBO counter is equal to or less than the number of indicated RA-RUs. With respect to multiple OBO counters for the same trigger frame, when the OBO counter becomes 0 or when the OBO counter is equal to or less than the number of indicated RA-RUs, an RU to be transmitted may be selected from among RA-RUs corresponding to the multiple OBO counters.

The description in the above-described embodiments that the OBO counter becomes 0 may include a case where the OBO counter is equal to or less than the number of eligible RA-RUs even though the actual OBO counter is not reduced. In addition, when an UORA operation starts or after a PPDU is transmitted through the UORA operation, the OBO counter may be reset. In this case, the OBO counter may be reset through random selection from among integers equal to or greater than 0 in a configured range. The configured range may be determined on the basis of a UORA parameter set element. The configured range may be an orthogonal frequency division multiple access (OFDMA) contention window (OCW) range. Alternatively, the configured range may be an OCW.

A user information field having an AID12 subfield configured as an AID12 subfield value other than 0 or 2045, which indicates an RA-RU, may exist after a user information field having an AID12 subfield configured as 1 to 2007.

Referring to FIG. 29, a trigger frame may include a specific user information field. The specific user information field may be a user information field having an AID12 subfield configured as a preconfigured value corresponding 2007. The specific user information field may be position at the foremost position among user information fields.

Whether a specific user information field is included in a trigger frame may be indicated by a specific user information field present subfield included in a common information field. If a value of the specific user information field present subfield is 0, the value may indicate that the trigger frame includes the specific user information field.

If a value of the specific user information field present subfield is 1, the value may indicate that the trigger frame does not include the specific user information field. An STA responding to a trigger frame including a specific user information field may respond using an EHT TB PPDU. In addition, the trigger frame may include an RA-RU. If the trigger frame indicates an RA-RU to respond using an EHT TB PPDU, an AID12 subfield of a user information field (User Info 3) indicating the RA-RU may be configured as a preconfigured value. The preconfigured value may be configured as a value other than 0 and a value other than 2045. The preconfigure value may indicate to use an EHT TB PPDU when a user information field including the preconfigured value indicates an RA-RU and responding to the RA-RU is performed.

The STA may determine a TB PPDU format on the basis of an AID12 subfield value indicating an RA-RU selected when responding to the RA-RU. The STA may respond using a HE TB PPDU format when an AID12 subfield value indicating an RA-RU selected when responding in the RA-RU is 0 or 2045. The STA may respond using an EHT TB PPDU format when an AID12 subfield value indicating an RA-RU selected when responding in the RA-RU is neither 0 or 2045. In addition, to determine whether to respond using an EHT TB PPDU format, the determination may be based on a PHY version ID field included in a specific user information field. For example, when the PHY version ID field indicates EHT, responding using an EHT TB PPDU format in the RA-RU may be possible. When the PHY version ID field indicates a value other than EHT, responding using an EHT TB PPDU format in the RA-RU may be impossible.

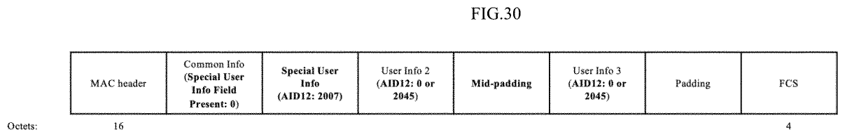

FIG. 30 illustrates another example of an uplink orthogonal frequency division multiple access (OFDMA)-based random access (UORA) operation and a method for indicating a TB PPDU format according to an embodiment of the disclosure.

An embodiment described with reference to FIG. 30 may be a more specific embodiment of the embodiments described with reference to FIGS. 24 to 27. The embodiment described with reference to FIG. 30 may be used together with the method described with reference to FIG. 28. The above-described content may have been omitted.

According to an embodiment of the disclosure, a trigger frame may include a user information field having an AID12 subfield configured as a preconfigured value. The preconfigured value may be 4095. In addition, a user information field having an AID12 subfield configured as a preconfigured value may be the above-described mid-padding field. In addition, the AID12 subfield may be a 12-bit field at the foremost position of the mid-padding field. That is, bits B0 to B11 of the mid-padding field may indicate the AID12 subfield.

The mid-padding field may have the same length as another user information field included in a trigger frame. Alternatively, the mid-padding field may have the same length as another user information field included in a trigger frame, except for a case where the trigger frame is an MU-BAR trigger frame. Alternatively, the mid-padding field may have the same length as a specific user information field included in a trigger frame. Alternatively, with respect to the mid-padding field, a trigger dependent user information field included in the mid-padding field may not exist except for a case where the trigger frame is an MU-BAR trigger frame.

Alternatively, the mid-padding field may be 40 bits except for a case where a trigger frame is an MU-BAR trigger frame. A trigger frame other than the MU-BAR trigger frame may include a basic trigger frame, a beamforming report poll (BFRP) trigger frame, an MU-RTS trigger frame, a buffer status report poll (BSRP) trigger frame, a GCR MU-BAR trigger frame, a bandwidth query report poll (BQRP) trigger frame, and an NDP feedback report poll (NFRP) trigger frame. Trigger type subfield values 0 to 7 included in the trigger frame may indicate the basic trigger frame, the beamforming report Poll (BFRP) trigger frame, the MU-BAR trigger frame, the MU-RTS trigger frame, the buffer status report poll (BSRP) trigger frame, the GCR MU-BAR trigger frame, the bandwidth query report poll (BQRP) trigger frame, and the NDP feedback report poll (NFRP) trigger frame, respectively.

Accordingly, the mid-padding field included in the GCR MU-BAR trigger frame may not include a trigger dependent user information field, and may be 40 bits. In addition, the mid-padding field may have the same length as a specific user information field. A specific user information field included in the GCR MU-BAR trigger frame may not include a trigger dependent user information field, and may be bits.

In addition, the length of a specific user information field included in the basic trigger frame or the BFRP trigger frame may be 1 octet. In addition, all subfields of the specific user information field included in the basic trigger frame or the BFRP trigger frame may be reserved. When the subfields are reserved, all bits may be configured as 0.

In addition, in a specific user information field included in the MU-BAR trigger frame, a trigger dependent user information field may be 4 octets. In addition, a BAR type subfield included in the trigger dependent user information field may indicate compressed BlockAckReq, and the remaining subfields may be reserved.

Alternatively, in a specific user information field included in the MU-BAR trigger frame, a trigger dependent user information field may be 6 octets. In addition, a BAR type subfield included in the trigger dependent user information field may indicate multi-TID BlockAckReq, a BAR control included in the trigger dependent user information field may indicate that the number of TIDs is one. The number of TIDs may be indicated by a TID_INFO subfield. Subfields remaining after excluding the TID_INFO subfield and the BAR type subfield included in the trigger dependent user information field may be reserved.

According to an embodiment of the disclosure, an STA may perform different operations on the basis of whether a user information field indicating an RA-RU included in a received trigger frame precedes or is subsequent to the mid-padding field.

For example, when a user information field indicating an RA-RU included in a received trigger frame precedes the mid-padding field, the STA may respond using a HE TB PPDU format when responding to the RA-RU. Alternatively, when a user information field indicating an RA-RU included in a received trigger frame precedes the mid-padding field, the user information field may be a HE variant user information field.

In addition, a user information field indicating an RA-RU included in a received trigger frame is subsequent to the mid-padding field, the STA may respond using an EHT TB PPDU format when responding to the RA-RU. Alternatively, for example, when a user information field indicating an RA-RU included in a received trigger frame is subsequent to the mid-padding field, the user information field may be an EHT variant user information field.

According to another embodiment, when a user information field indicating an RA-RU included in a received trigger frame precedes the mid-padding field, the STA may respond using a HE TB PPDU format when responding to the RA-RU. Alternatively, for example, when a user information field indicating an RA-RU included in a received trigger frame precedes the mid-padding field, the user information field may be a HE variant user information field. In addition, a user information field indicating an RA-RU included in a received trigger frame is subsequent to the mid-padding field, the STA may respond using a TB PPDU format determined on the basis of the method described with reference to FIG. 27, when responding to the RA-RU.

Alternatively, for example, when a user information field indicating an RA-RU included in a received trigger frame is subsequent to the mid-padding field, the STA may determine, according the method described with reference to FIG. 27, whether the user information field is a HE variant user information field or an EHT variant user information field. The method described with reference to FIG. 27 may mean a method based on whether there is a specific user information field, a specific user information field present subfield, a HE/EHT P160 subfield, a PS160 subfield, etc.

For example, in a case where a user information field indicating an RA-RU is subsequent to the mid-padding field, when a HE/EHT P160 subfield indicates HE and the user information field indicates an RU existing in a P160 channel (included in a P160 channel), the user information field may be a HE variant user information, and a HE TB PPDU may be used when responding to the user information field is performed.

In a case where a user information field indicating an RA-RU is subsequent to the mid-padding field, when a HE/EHT P160 subfield indicates HE and the user information field indicates an RU existing in an S160 channel, the user information field may be an EHT variant user information field, and an EHT TB PPDU may be used when responding to the user information field is performed. In a case where a user information field indicating an RA-RU is subsequent to the mid-padding field, when a HE/EHT P160 subfield indicates EHT, the user information field may be an EHT variant user information field, and an EHT TB PPDU may be used when responding to the user information field is performed.

In addition, in the embodiment above, a description that the user information field is an EHT variant user information field and an EHT TB PPDU may be used when responding to the user information field is performed may be extended to a case where the user information field is an EHT variant user information field or a NEXT variant user information field and an EHT TB PPDU or a NEXT TB PPDU may be used when responding to the user information field is performed. In this case, when a PHY version ID field included in a specific user information field indicates EHT, the user information field is an EHT variant user information field, and an EHT TB PPDU may be used when responding to the user information field is performed. In addition, in this case, when a PHY version ID field included in a specific user information field indicates NEXT, the user information field may be a NEXT variant user information field, and a NEXT TB PPDU may be used when responding to the user information field is performed.

In addition, an STA (e.g., AP) transmitting a trigger frame may configure and generate a trigger frame as follows.

According to an embodiment, to indicate responding to an RA-RU by using an EHT TB PPDU, a user information field indicating the RA-RU may be positioned after a mid-padding field. In addition, a user information field triggering a HE STA (including a dedicated and scheduled STA) rather than an EHT STA may precede the mid-padding field and may not be positioned after the mid-padding field. In addition, the user information field positioned after the mid-padding field may be a user information field triggering an EHT STA (including a dedicated and scheduled STA).

In addition, an STA responding to a trigger frame may perform the following operations.

According to an embodiment, an STA responding to a trigger frame may maintain one OBO counter. The STA may use the same OBO counter for 1) an RA-RU indicated by a user information field preceding the mid-padding field, and 2) an RA-RU indicating a user information field existing after the mid-padding field. In addition, when the OBO counter becomes 0 or when the OBO counter is equal to or less than the number of eligible RA-RUs, the STA may select an RU to be used for UORA transmission from among 1) an RA-RU indicated by a user information preceding the mid-padding field, and 2) an RA-RU indicated by a user information field existing after the mid-padding field. In addition, a TB PPDU format corresponding to the selected RU may be selected according to the method described in FIGS. 28, 30, etc.

Alternatively, a TB PPDU format corresponding to the selected RU may be determined on the basis of the position of a user information field indicating the selected RU. When a user information field indicating the selected RU precedes the mid-padding field, responding may be transmitted using a HE TB PPDU format. When a user information field indicating the selected RU exists after the mid-padding field, responding may be transmitted using an EHT TB PPDU format.

According to another embodiment, an EHT STA responding to a trigger frame may use an OBO counter for an RA-RU indicated by a user information field existing after the mid-padding field. The OBO counter may not be used for an RA-RU indicated by a user information field preceding the mid-padding field. In addition, when the OBO counter becomes 0 or when the OBO counter is equal to or less than the number of eligible RA-RUs, the STA may select an RU to be used for UORA transmission from among RA-RUs indicated by a user information field existing after the mid-padding field. An RU to be used for UORA transmission may not be selected from among RA-RUs indicated by a user information field preceding the mid-padding field.

According to another embodiment, an STA responding to a trigger frame may maintain multiple OBO counters. In addition, each of the multiple OBO counters may correspond to a TB PPDU of each standard. For example, the STA may maintain two OBO counters. The two OBO counter may correspond to 1) an RA-RU indicated by a user information field preceding the mid-padding field, and 2) an RA-RU indicated by a user information field existing after the mid-padding field, respectively. The STA may reduce the OBO counter for each RA-RU, and may select an RU to be transmitted from among RA-RUs corresponding to the OBO counter corresponding to a case where the OBO counter becomes 0 or a case where the OBO counter is equal to or less than the number of indicated RA-RUs.

With respect to multiple OBO counters for the same trigger frame, when the OBO counter becomes 0 or when the OBO counter is equal to or less than the number of indicated RA-RUs, an RU to be transmitted may be selected from among RA-RUs corresponding to the multiple OBO counters.

The description in the above-described embodiments that the OBO counter becomes 0 may include a case where the OBO counter is equal to or less than the number of eligible RA-RUs even though the actual OBO counter is not reduced. In addition, when an UORA operation starts or after a PPDU is transmitted through the UORA operation, the OBO counter may be reset. In this case, the OBO counter may be reset through random selection from among integers equal to or greater than 0 in a configured range. The configured range may be determined on the basis of a UORA parameter set element. The configured range may be an orthogonal frequency division multiple access (OFDMA) contention window (OCW) range. Alternatively, the configured range may be an OCW.

According to an embodiment of the disclosure, a method for distinguishing between a mid-padding field and a padding field. This is because in both the mid-padding field and the padding field, values of multiple bits in the front may be configured as the same value. For example, in both the mid-padding field and the padding field, a 12-bit value in the front may be configured as 1. The padding field may be a field before an FCS included in a trigger frame. Alternatively, the padding field may be the last field included in the trigger frame, except for the FCS. The FCS may be the last 4 octets included in the trigger frame,

According to an embodiment, all bits included in the padding field may be configured as 1. In addition, the padding field may be provided to give a time required for an STA receiving a trigger frame to prepare a response. In addition, the padding field may be at least 2 octets.

The mid-padding field may include a bit configured as a value other than 1. For example, at least one preconfigured bit among bits of the mid-padding field may be configured as a value other than 1. More specifically, at least one preconfigured bit among bits except for an AID12 subfield of the mid-padding field may be configured as a value other than 1. The at least one preconfigured bit may be the 13th bit from the front of the mid-padding field, or a bit having bit index B12. Accordingly, an STA receiving the mid-padding field may distinguish between the mid-padding field and the padding field on the basis of the at least one preconfigured bit value. In a case where all the first 12 bits (B0 to B11) of the AID12 subfield of User Info in the trigger frame received by the STA are configured as 1, when the next preconfigured bit after the 12 bits is 0, the received field may correspond to a mid-padding field. When the next preconfigured bit after the 12 bits is 1, the received field may corresponding to a padding field.

According to another embodiment, in a case where all bits at the position of the AID12 subfield are configured as 1, when it is assumed that there is user information field 1 including all bits configured as 1, a user information field immediately after user information field 1 may be user information field 2. When user information field 2 does not exist after user information field 1, user information field 1 may be a padding field. Alternatively, when user information field 2 exists after user information field 1 and an AID12 subfield value included in user information field 2 is 4095 (4095 when all bits are configured as 1), user information field 1 and user information field 2 may be padding fields. Alternatively, when user information field 2 exists after user information field 1 and an AID12 subfield value included in user information field 2 is 4095 (4095 when all bits are configured as 1), user information field 1 may be a mid-padding field.

According to an embodiment of the disclosure, a trigger frame may include multiple mid-padding fields. In the multiple mid-padding fields included in the trigger frame, all bits at the position of the AID12 subfield, i.e., the first 12 bits, may be configured as 1. In the multiple mid-padding fields included in the trigger frame, bits except for a bit at the position of the AID12 subfield may be configured as different values. For example, in one of the multiple mid-padding fields included in the trigger frame, the first bit except for a bit at the position of the AID12 subfield may be configured as 0. In another one of the multiple mid-padding fields included in the trigger frame, the second bit except for a bit at the position of the AID12 subfield may be configured as 0.

Referring to FIG. 30, a trigger frame may include a specific user information field. The specific user information field may be a user information field having an AID12 subfield configured as 2007 corresponding to a preconfigured value. The specific user information field may exist at the foremost position among user information fields. Whether the specific information field is included in the trigger frame may be indicated by a specific user information field present subfield included in a common information field. If a specific user information field present subfield value is 0, the value may indicate that the trigger frame includes the specific user information field. If a specific user information field present subfield value is 1, the value may indicate that the trigger frame does not include the specific user information field. An STA responding to the trigger frame including the specific user information field may respond using an EHT TB PPDU. In addition, the trigger frame may indicate an RA-RU. An AID12 subfield included in the user information field indicating the RA-RU may be configured as 0 or 2045. The trigger frame may include a mid-padding field. A TB PPDU format may be determined on the basis of the position of a user information field indicating the RA-RU included in the trigger frame. If a user information field indicating an RA-RU included in a trigger frame precedes a mid-padding field, a HE TB PPDU may be used when responding to the RA-RU is performed. If a user information field indicating an RA-RU included in a trigger frame exists after a mid-padding field, an EHT TB PPDU may be used when responding to the RA-RU is performed. In addition, to determine whether to perform responding using an EHT TB PPDU format, the determination may be base on a PHY version ID field included in a specific user information field. For example, when a PHY version ID field indicates EHT, responding in the RA-RU by using an EHT TB PPDU format may be possible. When a PHY version ID field indicates a value other than EHT, responding in the RA-RU by using an EHT TB PPDU format may not be possible.

According to an embodiment of the disclosure, the position of a user information field having an AID12 subfield configured as an AID-based value in the STA may be preconfigured. The user information field having an AID12 subfield configured as an AID-based value in the STA may trigger one STA.

In an embodiment, a user information field having an AID12 subfield configured as an AID-based value in the STA may all precede a mid-padding field. In this case, it may be advantageous in that an STA not using UORA does not need to distinguish between the mid-padding field and the padding field.

In another embodiment, a user information field triggering an STA other than 1) an EHT STA or 2) a HE STA, among user information fields each having an AID12 subfield configured as an AID-based value in the STA, may all exist after the mid-padding field. In this case, the STA may fail to recognize the mid-padding field, and a HE STA recognizing the padding field may not parse a user information field after the mid-padding field. Accordingly, the HE STA can save power.

According to an embodiment of the disclosure, a mid-padding field may be included in an NFRP trigger frame. The NFRP trigger frame may be a frame indicating the range of AIDs of STAs for responding of a user information field. For example, a user information field included in an NFRP trigger frame may indicate a starting AID. In addition, a user information field included in an NFRP trigger frame may indicate the number of available responding STAs. The number of available responding STAs may be based on a bandwidth (UL BW of a trigger frame) and a multiplexing flag (number of spatially multiplexed users subfield) included in the user information field. In addition, a response to the NFRP trigger frame may be an NDP. The NPD may be a PPDU including only a preamble of a PPDU. According to an embodiment, AID values may be randomly allocated by multiple STAs. Accordingly, when the NFRP trigger frame indicates the range of AIDs, standards supported by STAs having the range of AIDs may be different. Accordingly, for the NFRP trigger frame, it may be difficult to receive a response in the same standard. Accordingly, to spoof an STA supporting a certain standard for the NFRP trigger frame, a mid-padding field may be included. For example, to acquire an NDP response including an EHT PPDU for the NFRP trigger frame, a mid-padding field may be included. Accordingly, HE STAs may not respond by recognizing the mid-padding field as padding. Whether to respond using either an EHT PPDU or a NEXT PPDU may be determined according to the method described with reference to FIGS. 27 to 29. For example, when a user information field included in the NFRP trigger frame precedes a mid-padding field, an NDP corresponding to a HE PPDU may be used when responding to the user information field is performed. In addition, when a user information field included in the NFRP trigger frame exists after a mid-padding field, an NDP corresponding to an EHT PPDU or a NEXT PPDU may be used when responding to the user information field is performed. Determining whether to use either an EHT PPDU or a NEXT PPDU may be based a format identifier included in a trigger frame. More specifically, determining whether to use either an EHT PPDU or a NEXT PPDU may be based on a PHY version ID field included in a specific user information field.

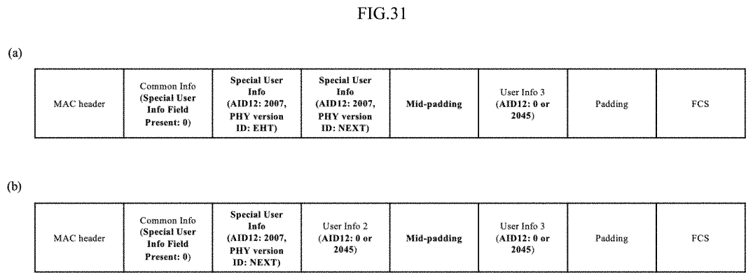

FIG. 31 illustrates a trigger frame configuration according to an embodiment of the disclosure.

According to an embodiment of the disclosure, a trigger frame may include multiple specific user information fields. A specific user information field may be the specific user information field described in the above-described embodiments. In addition, the embodiment described with reference to FIG. 31 may be used together with the embodiments described with reference to FIGS. 28 to 30.

According to an embodiment of the disclosure, for the multiple specific user information fields included in the trigger frame, PHY version ID fields included in the respective multiple specific user information fields may be configured as different values. A PHY version ID field included in one of the multiple specific user information fields included in the trigger frame may be configured as a value corresponding to EHT, and a PHY version ID field included in another specific user information field may be configured as a value corresponding to NEXT.

Referring to part (a) of FIG. 31, a user information field having a PHY version ID field configured as a value corresponding to EHT may exist immediately after a common information field.

When the trigger frame includes multiple specific user information fields, the multiple specific user information fields may exist in an order of a PHY version ID field value included in each of the specific user information fields. When the trigger frame includes multiple specific user information fields, the multiple specific user information fields may exist immediately after the common information field.

Referring to part (a) of FIG. 31, a specific user information field having a PHY version ID field configured as a value corresponding to NEXT may exist immediately after a user information field having a PHY version ID field configured as a value corresponding to EHT.

According to an embodiment of the disclosure, an STA may indicate an RA-RU according to the method described with reference to FIGS. 28 to 30, and receive a user information field indicating to perform responding using a EHT TB PPDU or a NEXT TB PPDU. An operation in this case is described below. A description made below that it is possible to respond to an RA-RU or it is impossible to respond to an RA-RU may mean that each RA-RU may be determined as an eligible RA-RU, or may not be determined as an eligible RA-RU. In addition, for an eligible RA-RU, an OBO counter may be reduced and an RU to be transmitted may be selected, and for an RU other than the eligible RA-RU, an OBO counter may not be reduced or an RU to be selected may not be selected.

According to an embodiment, a trigger frame received by an STA does not include a specific user information field at all, the STA may respond to an RA-RU by using a HE TB PPDU.

According to an embodiment, in a case where a trigger frame received by an STA includes a specific user information field, when a value indicated by a PHY version ID field included in the specific user information field corresponds to a standard supported by the STA, the STA may respond to an RA-RU by using a TB PPDU in the standard indicated by the value of the PHY version ID field. In a case where a trigger frame received by an STA includes a specific user information field, when a value indicated by a PHY version ID field included in the specific user information field corresponds to a standard not supported by the STA, the STA may not be able to respond to an RA-RU indicated by the trigger frame. That is, whether responding to an RA-RU is possible or impossible may be determined on the basis of a PHY version ID field included in a specific user information field positioned immediately after a common information field received by an STA. For example, in a case where a trigger frame received by an EHT STA includes a specific user information field, when a value indicated by a PHY version ID field included in the specific user information field is EHT, the EHT STA may respond to an RA-RU by using an EHT TB PPDU. In a case where a trigger frame received by an EHT STA includes a specific user information field, when a value indicated by a PHY version ID field included in the specific user information field is not EHT, the EHT STA may not be able to respond to an RA-RU indicated by the trigger frame.

Referring to part (b) of FIG. 31, a trigger frame may include a specific user information field. A PHY version ID field included in the specific user information field may indicate a NEXT standard. In addition, the trigger frame may include User Info 2 and User Info 3. In addition, User Info 2 may indicate an RA-RU to which responding is performed using a HE TB PPDU according to the method described with reference to FIGS. 28 to 30.

In addition, a user information 3 field may indicate an RA-RU to which responding is performed using an EHT TB PPDU or a NEXT TB PPDU according to the method described with reference to FIGS. 28 to 30. Accordingly, the EHT STA receiving the trigger frame may respond to a user information 2 field, and in this case a HE TB PPDU may be used.

In addition, the EHT STA receiving the trigger frame may not be able to respond to User Info 3. The reason why responding to the user information 3 field is impossible is that the standard indicated by a PHY version ID field included in the specific user information field included in the trigger frame is not supported by the EHT STA.

According to an embodiment, in a case where a trigger frame received by an STA includes multiple specific user information fields, when a value indicated at least one of PHY version ID fields included in the multiple specific user information fields corresponds to a standard supported by the STA, the STA may respond to an RA-RU by using a TB PPDU of the standard indicated by the indicated value. In a case where a trigger frame received by an STA includes multiple specific user information fields, when all values indicated by PHY version ID fields included in the multiple specific user information fields correspond to a standard not supported by the STA, the STA may not be able to respond to an RA-RU indicated by the trigger frame.

Alternatively, in a case where a trigger frame received by an STA includes multiple specific user information fields, when a value indicated by a PHY version ID field included in a specific user information field positioned immediately after a common information field corresponds to a standard supported by the STA, the STA may respond to an RA-RU by using a TB PPDU in the standard indicated by the indicated value. In a case where a trigger frame received by an STA includes multiple specific user information fields, when a value indicated by a PHY version ID field included in a specific user information field positioned immediately after a common information field is a standard not supported by the STA, the STA may not be able to respond to an RA-RU indicated by the trigger frame.

Referring to part (a) of FIG. 31, a user information 3 field included in a trigger frame may indicate an RA-RU to which responding is performed using an EHT TB PPDU or a NEXT TB PPDU according to the method described with reference to FIGS. 27 to 30. In addition, the trigger frame may include special user info in which a PHY version ID field is configured as EHT. A specific user information field having a PHY version ID field configured as EHT may exist immediately after a common information field.

In addition, the trigger frame may include a specific user information field having a PHY version ID field configured as NEXT. The specific user information field having a PHY version ID field configured as NEXT may exist after a specific user information field having a PHY version ID field configured as EHT. In this case, an EHT STA having received the trigger frame may respond to the user information 3 field since the trigger frame includes a specific user information field having a PHY version ID field configured as EHT.

According to an embodiment, in a case where a trigger frame received by an STA includes multiple specific user information fields, when a value indicated by at least one of PHY version ID fields included in the multiple specific user information fields corresponds to a standard not supported by the STA, the STA may respond to an RA-RU indicated by the trigger frame. In a case where a trigger frame received by an STA includes multiple specific user information fields, when all values indicated by PHY version ID fields included the multiple specific user information fields correspond to a standard supported by the STA, the STA may respond to an RA-RU indicated by the trigger frame.

According to another embodiment, a trigger frame including multiple specific user information fields may not include a user information field indicating an RA-RU. Accordingly, in this case, a user information field indicating an RA-RU may be included in a trigger frame only when the trigger frame does not include a specific user information field or includes only one specific user information field. In addition, in this case, whether an RA-RU is an RA-RU to which responding can be performed or not may be determined according to the above-described embodiment. That is, when a trigger frame is not included in the specific user information field, responding to the indicated RA-RU may be performed using a HE TB PPDU. In a case where a trigger frame includes only one specific user information field, when performing responding using a HE TB PPDU is indicated according to the method described with reference to FIGS. 28 to 30, responding to the indicated RA-RU may be performed using the HE TB PPDU.

In a case where a trigger frame includes only one specific user information field, when performing responding using an EHT TB PPDU or a NEXT TB PPDU is indicated according to the method described with reference to FIGS. 28 to 30, whether an indicated RU is an RA-RU to which responding can be performed or not may be determined on the basis of the PHY version ID field indicate by the specific user information field.

According to an embodiment, when a PHY version ID subfield included in a specific user information field included in a received trigger frame indicates an unsupported standard, an STA may ignore the contents after the specific user information field. Alternatively, all PHY version ID subfields included in multiple specific user information fields included in a received trigger frame indicate an unsupported standard, an STA may ignore other contents of the trigger frame. Accordingly, the STA can save power.

According to an embodiment of the disclosure, as described above, the specific user information field may be positioned immediately after the common information field, and exist at the foremost position among user information fields, but exceptionally, the mid-padding field may precede the specific user information field. That is, the mid-padding field may exist immediately after the common information field. In this case, the specific information field may not include a trigger dependent user information field, regardless of a trigger type. That is, the specific user information field may be 40 bits.

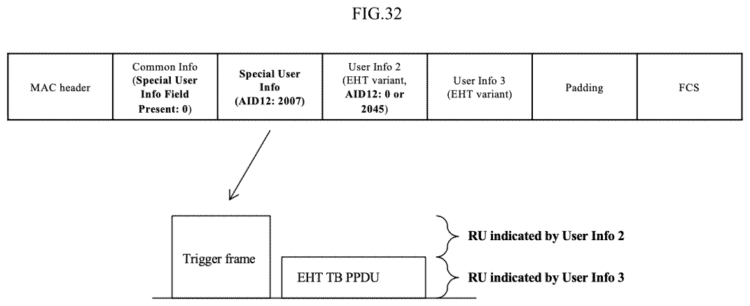

FIG. 32 illustrates a trigger frame configuration and a UORA operation according to an embodiment of the disclosure.

According to an embodiment of the disclosure, the variant type of a TB PPDU, indicated by a user information field, or a TB PPDU format used when responding to a trigger frame is performed may be indicated and determined on the basis of multiple subfields included in the trigger frame. In the disclosure, the above-described contents may have been omitted. In addition, this embodiment may describe the contents described with reference to FIG. 28, etc. in a different manner.

According to the embodiment described with reference to FIG. 28, when a HE/EHT P160 subfield indicates an EHT TB PPDU (that is, when a subfield value is configured as 0), responding may be performed using an EHT TB PPDU. In addition, when 1) a HE/EHT P160 subfield indicates a HE TB PPDU (that is, a subfield value is configured as 1), and 2) a PS160 subfield indicates P160 (that is, a subfield value is configured as 0), responding may be performed using a HE TB PPDU. In addition, when 1) a HE/EHT P160 subfield indicates a HE TB PPDU (that is, a subfield value is configured as 1), and 2) a PS160 subfield indicates S160 (that is, a subfield value is configured as 1), responding may be performed using an EHT TB PPDU.

In addition, the above case in which responding is performed using a HE TB PPDU may be identical to a case where a corresponding user information field is a HE variant user information field indicating transmission of a HE TB PPDU. In addition, the above case in which responding is performed using an EHT TB PPDU may be identical to a case where a corresponding user information field is an EHT variant user information field.

Alternatively, a HE TB PPDU, an EHT TB PPDU, and a NEXT TB PPDU may be used when responding is performed to a HE variant user information field, an EHT variant user information field, and a NEXT variant user information field, respectively.

To summarize an embodiment, when 1) a HE/EHT P160 subfield indicates a HE TB PPDU (that is, a subfield value is configured as 1), and 2) a PS160 subfield of a user information field indicates P160 (that is, a subfield value is configured as 0), the user information field may be a HE variant user information field. In other cases (that is, the HE/EHT P160 subfield and the PS160 subfield are 1) configured as 1 and 1, respectively, 2) configured as 0 and 1, respectively, or 3) configured as 0 and 0, respectively), the user information field may be an EHT variant user information field.

Referring to FIG. 28, a HF/EHT P160 subfield may be included in a common information field. More specifically, the HE/EHT P160 subfield may be included at the position of bit B54 of the common information field. In addition, referring to FIG. 28, a special user info present subfield may be included in the common information field. More specifically, the special user info present subfield may be included at the position of bit B55 of the common information field.

This embodiment may relate to the TB PPDU format indication method described with reference to FIG. 28. According to an embodiment of the disclosure, a user information field having an AID2 subfield configured as 0 or 2045 may not be configured as an EHT variant user information field. That is, a user information field having an AID12 subfield configured as 0 or 2045 may not be indicated to respond using an EHT TB PPDU. In addition, a user information field having an AID12 subfield configured as an AID12 subfield value other than 0 or 2045, which indicates an RA-RU, may not be configured as a HE variant user information field. That is, a user information field having an AID12 subfield configured as an AID12 subfield value other than 0 or 2045, which indicates an RA-RU, may not be configured to respond using a HE TB PPDU.

In addition, even though there is restriction on the above-described configuration and indication methods, there may be a responding method in preparation for a case where an STA (AP) transmitting a trigger frame does not properly implement the methods. According to an embodiment of the disclosure, when a user information field having an AID12 subfield configured as 0 or 2045 is configured as an EHT variant user information field in a trigger frame, the user information field may be ignored. Alternatively, an RU indicated by the user information field may not be determined as an eligible RA-RU. Alternatively, for an RA-RU corresponding to the user information field, an OBO counter may be reduced, but the RA-RU may not be used as an RA-RU selected for transmission or making the OBO counter 0.

In addition, according to an embodiment of the disclosure, when a user information field having an AID12 subfield configured as an AID12 subfield value other than 0 or 2045, which indicates an RA-RU, is configured as a HE variant user information field in a received trigger frame, the user information field may be ignored. Alternatively, an RU indicated by the user information field may not be determined as an eligible RA-RU. Alternatively, for an RA-RU corresponding to the user information field, an OBO counter may be reduced, but the RA-RU may not be used as an RA-RU selected for transmission or making the OBO counter 0.

An embodiment of the disclosure may relate to the TB PPDU format indication method described with reference to FIG. 30. According to an embodiment of the disclosure, when a user information field having an AID12 subfield configured as 0 or 2045 is configured as an EHT variant user information field, the user information field may not precede a mid-padding field. That is, when a user information field having an AID12 subfield configured as 0 or 2045 is configured as an EHT variant user information field, the user information field may not be positioned at the position which indicates that responding needs to be performed using a HE TB PPDU. In addition, when a user information field having an AID12 subfield configured as 0 or 2045 is configured as a HE variant user information field, the user information field may not be positioned after a mid-padding field. That is, when a user information field having an AID12 subfield configured as 0 or 2045 is configured as a HE variant user information field, the user information field may not be positioned at the position which indicates that responding needs to be performed using an EHT TB PPDU.

In addition, even though there is restriction on the above-described configuration and indication methods, there may be a responding method in preparation for a case where an STA (AP) transmitting a trigger frame does not properly implement the methods. According to an embodiment of the disclosure, when a user information field having an AID12 subfield configured as 0 or 2045 is configured as an EHT variant user information field in a trigger frame, there may be a case where the user information field precedes a mid-padding field. Alternatively, when a user information field having an AID12 subfield configured as 0 or 2045 is configured as a HE variant user information field in a trigger frame, there may be a case where the user information field is positioned after a mid-padding field. In this case, the user information field may be ignored. Alternatively, an RU indicated by the user information field may not be determined as an eligible RA-RU. Alternatively, for an RA-RU corresponding to the user information field, an OBO counter may be reduced, but the RA-RU may not be used as an RA-RU selected for transmission or making the OBO counter 0.

FIG. 32 illustrates a trigger frame and an EHT TB PPDU corresponding to a response to the trigger frame. Referring to FIG. 32, a trigger frame may include a common information field. In addition, the trigger frame may include one or more user information fields. Referring to FIG. 32, the one or more user information fields may include a specific user information field, a user information 2 field, and a user information 3 field. The common information field may include a specific user information field present subfield. In addition, a value of the specific user information field present subfield is configured as 0, and thus it may be indicated that the trigger frame includes the specific user information field. Referring to FIG. 32, both the user information 2 field and the user information 3 field may be EHT variant user information fields. A method for indicating that a user information field is an EHT variant user information field may follow the above-described embodiment.

In addition, when an AID12 subfield value is 0 or 2045, it may indicate an RA-RU to which responding needs to be performed using a HE TB PPDU. Referring to FIG. 32, the user information 2 field is configured as an EHT variant user information field, and an AID12 subfield included in the user information 2 field is configured as 0 or 2045. Accordingly, for a PPDU format to be used when responding to the user information 2 field, the user information 2 field indicates two types of PPDUs.

The type of variant of a user information field is indicated as EHT, and an AID12 subfield indicates HE. Accordingly, such configuration may not be allowed. However, when a trigger frame is configured as above and an STA (non-AP STA) has received the trigger frame having such configuration, the user information 2 field may be ignored. Alternatively, an RU indicated by the user information 2 field may not be determined as an eligible RA-RU. Alternatively, UORA responding may not be performed to an RU indicated by the user information 2 field. Alternatively, for an RU indicated by the user information 2 field, an OBO counter may not be reduced, or the RU may not be selected as an RU used for UORA responding. Accordingly, referring to FIG. 32, even though configuration which may cause a conflict in a TB PPDU format indicated by a trigger frame is made, a user information field in which the conflict occurs is ignored so that a PPDU is not transmitted to the RU indicated by the user information 2 field, whereby a UL MU operation can be successfully performed.

According to an embodiment of the disclosure, there may be an STA (or AP) having limited capabilities. The STA having limited capabilities may be an STA which implements only base features. Having limited capabilities may be indicated by a management information base (MIB) of dot11EHTBaseLineFeaturesImplementedOnly. For example, for an STA having limited capabilities, dot11EHTBaseLineFeaturesImplementedOnly may be configured as “true”.

According to an embodiment, an STA having limited capabilities may not solicit multiple TB PPDU formats by using one trigger frame. More specifically, an STA having limited capabilities may not solicit a HE TB PPDU and an EHT TB PPDU by using one trigger frame.

According to an embodiment, an STA (or AP) having limited capabilities may not indicate an RA-RU to which responding is performed using an EHT TB PPDU. Alternatively, an STA having limited capabilities may not be able to indicate an RA-RU to which responding is performed using an EHT TB PPDU. Accordingly, according to an embodiment of the disclosure, an STA having limited capabilities may not configure a user information field having an AID12 subfield configured as 0 or 2045, as an EHT variant user information field. In addition, an STA having limited capabilities may configure a user information field having an AID12 subfield configured as 0 or 2045, as a HE variant user information field only.

In addition, an STA having limited capabilities may not include a user information field having an AID12 subfield configured as 0 or 2045 in a trigger frame indicating an EHT TB PPDU. That is, the STA having limited capabilities may include the user information field having an AID12 subfield configured as 0 or 2045 only in a trigger frame indicating a HE TB PPDU.

A trigger frame indicating an EHT TB PPDU may be a trigger frame including at least one EHT variant user information field. Alternatively, a trigger frame including an EHT TB PPDU may be a trigger frame including a specific user information field. Alternatively, a trigger frame indicating an EHT TB PPDU may be a trigger frame indicating that a specific user information field present subfield is present. A trigger frame indicating a HE TB PPDU may be a trigger frame in which all included user information fields are HE variant user information fields. Alternatively, a trigger frame indicating a HE TB PPDU may be a trigger frame not including a specific user information field. Alternatively, a trigger frame indicating a HE TB PPDU may be a trigger frame indicating that a specific user information field present subfield is not present.

According to an embodiment, an STA having limited capabilities may not include, one PPDU, both 1) a TRS or a trigger frame indicating a HE TB PPDU, and 2) a TRS or a trigger frame indicating an EHT TB PPDU. Alternatively, an STA having limited capabilities may not include, in one A-MPDU, both 1) a TRS or a trigger frame indicating a HE TB PPDU, and 2) a TRS or a trigger frame indicating an EHT TB PPDU.

According to an embodiment of the disclosure, there may be capability signaling for transmission of capability information indicating an RA-RU to which responding is performed using an EHT TB PPDU or whether UORA is supported. Such signaling may exist independently from capability signaling indicating an RA-RU to which responding is performed using a HE TB PPDU or whether UORA is supported. The signaling indicating an RA-RU to which responding is performed using an EHT TB PPDU or whether UORA is supported may be included in an EHT capabilities element.

The capability signaling indicating an RA-RU to which responding is performed using a HE TB PPDU or whether UORA is supported may be included in a HE capabilities element. The EHT capabilities element or the HE capabilities element may be included in a beacon frame, a probe request frame, a probe response frame, an association request frame, an association response frame, a reassociation request frame, a reassociation response frame, etc. In addition, when an AP performs transmission, such signaling may indicate whether an RA-RU can be indicated and allocated. In addition, when a non-AP STA performs transmission, such signaling may indicate whether responding to an indicated or allocated RA-RU or UORA participation is possible.

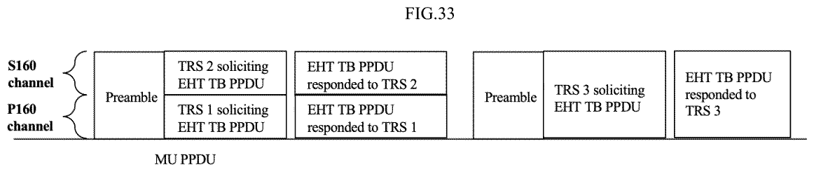

FIG. 33 illustrates a UL MU operation using a TRS according to an embodiment of the disclosure.

According to an embodiment, an RU allocated or indicated by a TRS may be determined on the basis of the position or bandwidth of an RU to which the TRS is transmitted.

For example, there may be a case where an RU to which a TRS is transmitted is equal to or less than a preconfigured bandwidth. In this case, the RU indicated by the TRS may be included within a subchannel of the preconfigured bandwidth including the RU to which the TRS is transmitted. For example, the preconfigured bandwidth may be 160 MHz. When the RU to which the TRS is transmitted is transmitted in a subchannel of a primary 160 MHz (P160) channel, the RU indicated by the TRS may be included within P160. In addition, when the RU to which the TRS is transmitted is transmitted in a subchannel of a secondary 160 MHz (S160) channel, the RU indicated by the TRS may be included within S160. Accordingly, when the TRS indicates the RU, a preconfigured bandwidth of a subchannel in which the RU is included, may not be indicated. That is, for example, the TRS may indicate the RU within 320 MHz, without signaling which functions as the PS160 subfield included in the trigger frame in the description above.

Referring to FIG. 33, a PPDU may include TRS 1 and TRS 2. TRS 1 and TRS 2 may be TRSs soliciting an EHT TB PPDU. TRS 1 may be transmitted within a P160 channel. In this case, an RU indicated by TRS 1 may be an RU within a P160 channel. Accordingly, an STA responding to TRS 1 may respond using the RU within the P160 channel. In addition, TRS 2 may be transmitted within an S160 channel. In this case, an RU indicated by TRS 2 may be an RU within an S160 channel. Accordingly, an STA responding to TRS 2 may respond using the RU within the S160 channel.

However, when a TRS is transmitted in an RU in a bandwidth greater than a preconfigured bandwidth (e.g., 160 MHz), ambiguity may occur in such a rule.

Accordingly, according to an embodiment, an RU indicating a TRS may not exceed the preconfigured bandwidth. In a specific example, an RU including a TRS may not exceed 160 MHz. In addition, if an RU including a TRS received by an STA exceeds the preconfigured bandwidth, the received TRS may be ignored and responding may not be performed.

According to another embodiment, an RU including a TRS may exceed the preconfigured bandwidth, and in this case, a rule for interpreting an allocated RU may be defined. According an embodiment, an RU including a TRS exceeds the preconfigured bandwidth, an allocated RU may be indicated as an RU positioned in an interval exceeding the preconfigured bandwidth. Alternatively, only when an RU including a TRS exceeds the preconfigured bandwidth, responding in an RU positioned in an interval exceeding the preconfigured bandwidth may be possible. Alternatively, when an RU including a TRS exceeds the preconfigured bandwidth, an allocated RU may exceed the preconfigured bandwidth. Alternatively, only when an RU including a TRS exceeds the preconfigured bandwidth, responding in an RU exceeding the preconfigured bandwidth may be possible.

More specifically, when an RU including a TRS exceeds 160 MHz, an RU across both a P160 subchannel and an S160 subchannel may be indicated. Alternatively, when an RU including a TRS exceeds 160 MHz, responding in an RU across a P160 subchannel and an S160 subchannel may be performed.

In addition, when an RU including a TRS exceeds a preconfigured bandwidth, only an RU exceeding the preconfigured bandwidth may be indicated. In addition, when an RU including a TRS is equal to or less than a preconfigured bandwidth, only an RU equal to or less than the preconfigured bandwidth may be indicated.

Alternatively, when an RU including a TRS exceeds a preconfigured bandwidth, the RU indicated by the TRS may be positioned in a subchannel of the preconfigured bandwidth at a preconfigured position. For example, the preconfigured bandwidth may be 160 MHz. When an RU including a TRS exceeds 160 MHz, the RU indicated by the TRS may be positioned in a P160 channel.

Alternatively, when an RU indicated by a TRS is greater than 160 MHz, a 160 MHz RU among the indicated RUs may be positioned in a 160 MHz channel including the RU to which the TRS is transmitted. That is, when the RU indicated by the TRS is greater than 160 MHz, two 996-tone RUs among the indicated RUs may be positioned in a 160 MHz channel including the RU to which the TRS is transmitted.

Referring to FIG. 33, TRS 3 may solicit an EHT TB PPDU. In addition, a bandwidth of a RU including TRS 3 may exceed 160 MHz. For example, the bandwidth of an RU including TRS 3 may be 320 MHz. In this case, an RU indicated by TRS 3 or an RU used for responding to TRS 3 may not exceed 160 MHz. Alternatively, an RU indicated by TRS 3 or an RU used for responding to TRS 3 may exist across a P160 channel and an S160 channel.

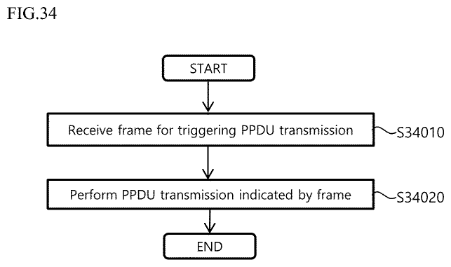

FIG. 34 is a flow chart illustrating an example of a PPDU transmission method according to an embodiment of the disclosure.

Referring to FIG. 34, a non-AP STA may transmit a specific format of a TB PPDU on the basis of a trigger frame indicating TB PPDU transmission from an AP STA.

Specifically, a non-AP STA may receive, from an AP STA, a frame indicating PPDU transmission to one or more terminals (S34010).

In this case, the frame may have the same format as the frame for indicating TB PPDU transmission, described with reference to FIGS. 13 to 33. For example, the frame may include a common information field and a user information field for each of the one or more terminals. In this case, the user information field may include an AID12 subfield indicating the usage of the user information field.

The AID12 subfield may be configured as different values according to a TB PPDU indicated as described with reference to FIGS. 13 to 33. For example, when the PPDU indicated to be transmitted by the frame, is an extremely high throughput (EHT) PPDU, a value of the AID12 subfield may be configured as one of multiple values, except for at least one specific value.

In this case, the at least one specific value may be used to allocate a resource for uplink orthogonal frequency division multiple access (OFDMA)-based random access (UORA) of at least one terminal supporting high efficiency (HE).

That is, a specific value of a user information field included in a frame or an AID12 subfield included in a user information field may be used to indicated RA-RUs of STAs supporting HE, and in this case, a specific value for indicating an RA-RU may indicate that a response to the frame is a HE TB PPDU. Accordingly, a value of a user information field or an AID12 subfield included in a user information field for indicating an EHT TB PPDU or a NEXT TB PPDU as a response to the frame may be configured as a value except for a specific value for indicating a UORA operation of HE.

For example, when the value of the user information field or the AID12 subfield included in the user information field is configured as a first specific value (e.g., “2045”) or a second specific value (e.g., “0”) is configured to indicate an RA-RU for a UORA operation of HE, an STA may transmit a HE TB PPDU as a response to the frame. However, when the value of the user information field or the AID12 subfield included in the user information field is configured as a value remaining after excluding the first specific value or the second specific value, the STA may transmit an EHT TB PPDU or a NEXT TB PPDU as a response to the frame.

The first specific value may be used to indicate an RA-RU to STAs unassociated with an AP, and the second specific value may be used to indicated an RA-RU to STAs associated with the AP.

In this case, when a specific condition is satisfied, the second specific value may be used to indicate transmission of the EHT TB PPDU or the NEXT TB PPDU. For example, the specific condition may be one of: a case where all of the STAs associated with the AP are legacy STAs (for example, a case where all of the STAs associated with the AP may perform transmission of the EHT TB PPDU) or are EHT STAs rather than the HE and/or legacy STAs which cannot perform transmission of the HE TB PPDU (that is, a case STAs which cannot perform EHT TB PPDU transmission and which remain after excluding the legacy STAs which can perform HE TB PPDU transmission); a case where all of the associated legacy STAs (terminals which cannot perform EHT TB PPDU transmission) do not support the UORA operation; and a case where a frame indicating TB PPDU transmission is included in the EHT PPDU and transmitted. In this case, the case where all of the legacy STAs (terminals which cannot perform EHT TB PPDU transmission) do not support the UORA operation includes a case where the STA has transmitted, to the AP, a value of a capability subfield indicating that the UORA operation is not supported.

That is, the case where all of the legacy STAs (terminals which cannot perform EHT TB PPDU transmission) do not support the UORA operation may include a case where the capability subfield value transmitted to the AP by STAs is configured as a value indicating that the UORA operation is not supported or a case where STAs which do not support the UORA operation itself are associated.

In other words, among the conditions above, the case where all of the STAs associated with the AP are not legacy terminals (for example, the case where EHT TB PPDU is possible) may be also applied when the AP is associated with a single STA which can perform EHT TB PPDU transmission. That is, the STA associated with the AP exists only as an STA which can perform EHT TB PPDU transmission, and in this case, the second specific value corresponding to “0” may be thus used as the value of the AID12 subfield or the user information field. Accordingly, in this case, it may be determined that the specific condition is satisfied, and the second specific value may be used to indicate EHT TB PPDU or NEXT TB PPDU transmission.

In addition, a TB PPDU which can be indicated by the AP through the frame may indicate only one format of a TB PPDU. For example, the AP may indicate only a HE TB PPDU or an EHT TB PPDU (or a NEXT TB PPDU) through the frame, and may not indicate both the HE TB PPDU and the EHT TB PPDU. Accordingly, when the frame indicates the EHT TB PPDU, HE TB PPDU transmission cannot be indicated through the corresponding frame, and thus the value of the user information field or the AID12 subfield included in the user information field cannot be configured as “2045”.

Thereafter, the non-AP STA may transmit the PPDU as a response to the frame on the basis of the AID12 subfield (S34020).

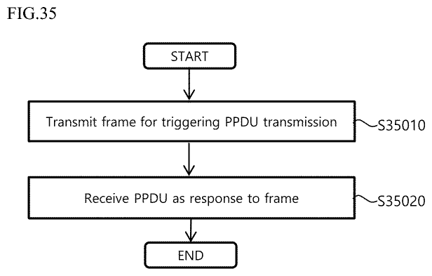

FIG. 35 is a flow chart illustrating an example of a frame transmission method for indicating PPDU transmission according to an embodiment of the disclosure.

Referring to FIG. 35, an AP STA may transmit a trigger frame indicating transmission of a specific TB PPDU to a non-AP STA, and receive a specific format of a TB PPDU from the non-AP STA on the basis of a frame.

Specifically, an AP STA may transmit a frame indicating PPDU transmission to one or more terminals (S35010).

In this case, the frame may have the same format as the frame for indicating TB PPDU transmission, described with reference to FIGS. 13 to 33. For example, the frame may include a common information field and a user information field for each of the one or more terminals. In this case, the user information field may include an AID12 subfield indicating the usage of the user information field.

The AID12 subfield may be configured as different values according to a TB PPDU indicated as described with reference to FIGS. 13 to 33. For example, when the PPDU indicated to be transmitted by the frame, is an extremely high throughput (EHT) PPDU, a value of the AID12 subfield may be configured as one of multiple values, except for at least one specific value.

In this case, the at least one specific value may be used to allocate a resource for uplink orthogonal frequency division multiple access (OFDMA)-based random access (UORA) of at least one terminal supporting high efficiency (HE).

That is, a specific value of a user information field included in a frame or an AID12 subfield included in a user information field may be used to indicated RA-RUs of STAs supporting HE, and in this case, a specific value for indicating an RA-RU may indicate that a response to the frame is a HE TB PPDU. Accordingly, a value of a user information field or an AID12 subfield included in a user information field for indicating an EHT TB PPDU or a NEXT TB PPDU as a response to the frame may be configured as a value except for a specific value for indicating a UORA operation of HE.

For example, when the value of the user information field or the AID12 subfield included in the user information field is configured as a first specific value (e.g., “2045”) or a second specific value (e.g., “0”) is configured to indicate an RA-RU for a UORA operation of HE, an STA may transmit a HE TB PPDU as a response to the frame. However, when the value of the user information field or the AID12 subfield included in the user information field is configured as a value remaining after excluding the first specific value or the second specific value, the STA may transmit an EHT TB PPDU or a NEXT TB PPDU as a response to the frame.

The first specific value may be used to indicate an RA-RU to STAs unassociated with an AP, and the second specific value may be used to indicated an RA-RU to STAs associated with the AP.

In this case, when a specific condition is satisfied, the second specific value may be used to indicate transmission of the EHT TB PPDU or the NEXT TB PPDU. For example, the specific condition may be one of: a case where all of the STAs associated with the AP are legacy STAs (for example, a case where all of the STAs associated with the AP may perform transmission of the EHT TB PPDU) or are EHT STAs rather than the HE and/or legacy STAs which cannot perform transmission of the HE TB PPDU (that is, a case STAs which cannot perform EHT TB PPDU transmission and which remain after excluding the legacy STAs which can perform HE TB PPDU transmission); a case where all of the associated legacy STAs (terminals which cannot perform EHT TB PPDU transmission) do not support the UORA operation; and a case where a frame indicating TB PPDU transmission is included in the EHT PPDU and transmitted. In this case, the case where all of the legacy STAs (terminals which cannot perform EHT TB PPDU transmission) do not support the UORA operation includes a case where the STA has transmitted, to the AP, a value of a capability subfield indicating that the UORA operation is not supported.

That is, the case where all of the legacy STAs (terminals which cannot perform EHT TB PPDU transmission) do not support the UORA operation may include a case where the capability subfield value transmitted to the AP by STAs is configured as a value indicating that the UORA operation is not supported or a case where STAs which do not support the UORA operation itself are associated.

In other words, among the conditions above, the case where all of the STAs associated with the AP are not legacy terminals (for example, the case where EHT TB PPDU is possible) may be also applied when the AP is associated with a single STA which can perform EHT TB PPDU transmission. That is, the STA associated with the AP exists only as an STA which can perform EHT TB PPDU transmission, and in this case, the second specific value corresponding to “0” may be thus used as the value of the AID12 subfield or the user information field. Accordingly, in this case, it may be determined that the specific condition is satisfied, and the second specific value may be used to indicate EHT TB PPDU or NEXT TB PPDU transmission.

In addition, a TB PPDU which can be indicated by the AP through the frame may indicate only one format of a TB PPDU. For example, the AP may indicate only a HE TB PPDU or an EHT TB PPDU (or a NEXT TB PPDU) through the frame, and may not indicate both the HE TB PPDU and the EHT TB PPDU. Accordingly, when the frame indicates the EHT TB PPDU, HE TB PPDU transmission cannot be indicated through the corresponding frame, and thus the value of the user information field or the AID12 subfield included in the user information field cannot be configured as “2045”.

Thereafter, the AP STA may receive, from at least one non-AP STA, a specific format of a TB PPDU as a response to the frame on the basis of the AID12 subfield (S35020).

The above-mentioned description of the disclosure is for illustrative purposes, and it will be understood that those who skilled in the art to which the disclosure belongs can easily modify the disclosure in other specific forms, without altering the technical ideas or essential characteristics of the disclosure. Therefore, the embodiments described above are illustrative and are not limited in all aspects. For example, each element described as a single entity may be distributed and implemented, and likewise, elements described as being distributed may also be implemented in a combined form.

The scope of the disclosure is defined by the appended claims rather than the above detailed description, and all changes or modifications derived from the meaning and range of the appended claims and equivalents thereof should be interpreted as being included within the scope of disclosure.

1. A terminal in a wireless communication system, the terminal comprising:
a communication module; and
a processor configured to control the communication module,
wherein the processor is configured to:
receive, from an access point (AP), a frame indicating transmission of a PPDU to one or more terminals,
wherein the frame includes a common information field and a user information field for each of the one or more terminals, and
wherein the user information field includes an AID12 subfield indicating usage of the user information field; and
transmit the PPDU on the basis of the AID12 subfield,
wherein a value of the AID12 subfield is configured as one of a plurality of values excluding at least one specific value when the PPDU indicated to be transmitted by the frame is an extremely high throughput (EHT) PPDU, and
wherein the at least one specific value is used to allocate a resource for uplink orthogonal frequency division multiple access (OFDMA)-based random access (UORA) of at least one terminal supporting high efficiency (HE).

2. The terminal of claim 1,
wherein the plurality of values are used to identify a user information field for each of terminals supporting extremely high throughput (EHT).

3. The terminal of claim 1,
wherein a first specific value among the at least one specific value is used for resource allocation for a UORA operation of terminals unassociated with the AP.

4. The terminal of claim 3,
wherein the first specific value is “2045”.

5. The terminal of claim 1,
wherein a second specific value is used for resource allocation for a UORA operation of terminals associated with the AP, and
wherein the second specific value is included in the at least one specific value when a specific condition fails to be satisfied, and is included in the multiple values when the specific condition is satisfied.

6. The terminal of claim 5,
wherein the specific condition corresponds to a case where all of the terminals associated with the AP are not terminals which cannot perform transmission of the EHT PPDU and can perform transmission of a PPDU of the HE.

7. The terminal of claim 5,
wherein the second specific value is “0”.

8. The terminal of claim 5,
wherein the specific condition corresponds to a case where the frame is included in the EHT PPDU and transmitted.

9. The terminal of claim 5,
wherein the specific condition corresponds to a case where among a plurality of terminals associated with the AP, all terminals which cannot perform transmission of the EHT PPDU and can perform transmission of a PPDU of the HE do not support the UORA operation.

10. A method for transmitting a frame by a terminal in a wireless communication system, the method comprising:
receiving, from an access point (AP), a frame indicating transmission of a PPDU to one or more terminals,
wherein the frame includes a common information field and a user information field for each of the one or more terminals, and
wherein the user information field includes an AID12 subfield indicating usage of the user information field; and
transmitting the PPDU on the basis of the AID12 subfield,
wherein a value of the AID12 subfield is configured as one of a plurality of values excluding at least one specific value when the PPDU indicated to be transmitted by the frame is an extremely high throughput (EHT) PPDU, and
wherein the at least one specific value is used for resource allocation for uplink orthogonal frequency division multiple access (OFDMA)-based random access (UORA) of at least one terminal supporting high efficiency (HE).

11. The method of claim 10,
wherein the plurality of values are used to identify a user information field for each of terminals supporting extremely high throughput (EHT).

12. The method of claim 10,
wherein a first specific value among the at least one specific value is used for resource allocation for a UORA operation of terminals unassociated with the AP.

13. The method of claim 12,
wherein the first specific value is “2045”.

14. The method of claim 10,
wherein a second specific value is used for resource allocation for a UORA operation of terminals associated with the AP, and
wherein the second specific value is included in the at least one specific value when a specific condition fails to be satisfied, and is included in the multiple values when the specific condition is satisfied.

15. The method of claim 14,
wherein the specific condition corresponds to a case where all of the terminals associated with the AP are not terminals which cannot perform transmission of the EHT PPDU and can perform transmission of a PPDU of the HE.

16. The method of claim 14,
wherein the second specific value is “0”.

17. The method of claim 14,
wherein the specific condition corresponds to a case where the frame is included in the EHT PPDU and transmitted.

18. The method of claim 14,
wherein the specific condition corresponds to a case where among a plurality of terminals associated with the AP, all terminals which cannot perform transmission of the EHT PPDU and can perform transmission of a PPDU of the HE do not support the UORA operation.
